(19) United States
(12) Patent Application Publication
(10) Pub. No.: US 2024/0249229 A1
(43) Pub. Date: Jul. 25, 2024

(54) SYSTEM AND METHOD TO CREATE BUSINESS PLANS

(71) Applicant: Rao Management Advisors LLC, West Windsor, NJ (US)

(72) Inventor: Prakash Rao, West Windsor, NJ (US)

(21) Appl. No.: 18/585,246

(22) Filed: Feb. 23, 2024

(51) Int. Cl. G06Q 10/0637

(52) U.S. Cl. CPC G06Q 10/0637

(57) ABSTRACT

A system is described. The system comprises: a memory; and a processor that is communicatively coupled to the memory storing a sequence of instructions that when executed causes the processor to: receive information related to one or more business propositions; create one or more business propositions based on the information received; analyze, using an artificial intelligence engine, the one or more business propositions and group the one or more business propositions for one or more categories; and create, using the artificial intelligence engine, one or more initiatives for the one or more categories.

### FIELD OF THE INVENTION

The present disclosure relates generally to business planning and more specifically to formulation, management, and monitoring of business planning from strategy to execution.

### BACKGROUND

Global financial institutions plod through their annual ritual for budget planning that begins with canvassing for initiatives from stakeholders spread across their lines of business in various geographies. Around this time many executives “find money” that would need to be spent by the end of the calendar year, if not for any reason, but to get, at the bare minimum “flat” budget allocations for the next calendar year. In the worst case, business leaders realize that they may come up short on their calendar year commitments, sometimes by orders of magnitude, thereby creating a “backlog” for the next calendar year.

Annual business plans typically consist of scope objectives for activities and tasks that may be organized in various ways, which represent projects, across lines of business. These plans are based on Activities, Resources and Allocated Capacity.

These activities do not reveal the correlation between results achieved at the end of the year vis-à-vis the original objectives. At the same time, people across the organization are busy and fully allocated across all the activities. Effort tracking takes lower priority, if not an afterthought, implying the need to estimate effort up front and monitor burn rate during the project. In the worst case, resource priority conflicts and over ambitious objectives may result in excessive overtime, burn-out, unmet expectations, wasted investments and missed opportunities.

“The development of feasible business plans is important for businesses of all sizes. Business plans allow businesses to effectively devise business strategies, set priorities, organize personnel, allocate resources, evaluate business performance, and perform a variety of other tasks to facilitate business management. Here, a “business plan” generally refers to a collection of data including a business strategy that characterizes a set of actions to be implemented, a budget that defines an allotment of resources for use in implementing the business strategy, and a set of constraints that define restrictions on implementation of the business strategy. In recent years, with the rapid progression of cross-industry digitalization and digital service-based enterprises, businesses are required to develop business plans with increasing speed and flexibility in order to remain responsive to the changing needs of customers.” [Source: United States Patent Application No. US20230011954A1, titled “Device, method, and system for business plan management”; Hatem ELSERAFY; Jayesh GUNTUPALLI; Shin TEZUKA; Yoji Ozawa; published Jan. 12, 2023].

Therefore, there is a long-felt need for a system and method that enables all stakeholders across an enterprise to effectively devise business strategies, set priorities, organize personnel, allocate resources, evaluate business performance, and perform a variety of other tasks to facilitate business management, using a uniform lexicon across departments, geographies, and markets.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In one or more embodiments described herein, systems, devices, computer-implemented methods, methods, apparatus and/or computer program products are presented that facilitate management of business propositions from strategy to execution.

In an aspect, a system is described. The system comprises: a memory; and a processor that is communicatively coupled to the memory storing a sequence of instructions that when executed causes the processor to: receive information related to one or more business propositions; create one or more business propositions based on the information received; analyze, using an artificial intelligence engine, the one or more business propositions and group the one or more business propositions for one or more categories; and create, using the artificial intelligence engine, one or more initiatives for the one or more categories.

In one embodiment, the processor is operable to implement the one or more initiatives on one or more target environments.

In one embodiment, the processor is operable to monitor at least one of tasks, activities, and events executed by the one or more initiatives into the one or more target environments.

In one embodiment, the processor is operable to determine an actual performance score based on monitoring at least one of the tasks, the activities, and the events executed by the one or more initiatives into the one or more target environments.

In one embodiment, the processor is operable to determine an expected performance score based on analyzing the one or more initiatives.

In one embodiment, the processor is operable to compare the actual performance score and an expected performance score.

In one embodiment, the processor is operable to determine a deficit score based on the comparison of the actual performance score and the expected performance score.

In one embodiment, the processor is operable to determine, using the artificial intelligence engine, one or more issues based on the comparison of the actual performance score and the expected performance score.

In one embodiment, the one or more issues comprise at least one of scope issues, priority issues, budget issues, and resource issues.

In one embodiment, the processor is operable to communicate feedback information back to the processor based on the issues.

In one embodiment, the feedback information comprises at least one of a resource strategy, a scope strategy, a priority strategy, and a budget strategy.

In one embodiment, the processor is operable to update at least one of the one or more business propositions and the one or more initiatives based on the feedback information.

In one embodiment, the processor is operable to update at least one of scope, budget, resource, and priority in at least one of the one or more business propositions and the one or more initiatives based on the feedback information.

In one embodiment, the processor is operable to generate a real-time report using at least one of historical trends, historical patterns, historical records, the analysis, the issues, the feedback information, and the update performed.

In one embodiment, the processor is operable to communicate with one or more external applications through an application programming interface (API) and exchange the information.

In one embodiment, the one or more issues comprise one of scope deficits, scope surplus, budget deficit, budget surplus, resource deficit, resource surplus, and priority issues.

In one embodiment, the processor is operable to enable one or more users to collaborate in real-time and analyze at least one of the one or more business propositions and the one or more initiatives, determine issues, and update at least one of the one or more business propositions and the one or more initiatives.

In one embodiment, the processor is operable to determine at least one of resources, budgets, priorities, and scopes, using one or more estimating models, for at least one of the one or more business propositions and the one or more initiatives.

In one embodiment, the processor is operable to at least one of manage execution of agendas, manage activities, manage events, manage tasks, trigger, and host online meetings, manage actions, take meeting notes, and record activities in a repository.

In one embodiment, the processor is operable to analyze the execution of tasks and activities and to take decisions in real-time.

In one embodiment, the processor is operable to interpret written text using the artificial intelligence engine through natural language processing.

In one embodiment, the processor is operable to convert written text to one or more commands in a machine readable format and to communicate the one or more commands to one or more agents.

In one embodiment, the one or more agents comprise one or more automated robots.

In one embodiment, the one or more agents execute one or more activities, one or more tasks, and one or more events at scheduled dates and times based on the one or more commands.

In one embodiment, the processor is operable to implement the one or more initiatives into one or more target environments through one or more agents.

In one embodiment, the processor is operable to receive the information from at least one of one or more users and one or more agents.

In an aspect, a method is described. The method comprises: receiving information related to one or more business propositions; creating one or more business propositions based on the information received; analyzing, using an artificial intelligence engine, the one or more business propositions and group the one or more business propositions for one or more categories; and creating, using the artificial intelligence engine, one or more initiatives for the one or more categories.

In one embodiment, the method further comprises: implementing the one or more initiatives into one or more target environments.

In one embodiment, the method further comprises: monitoring at least one of tasks, activities, and events executed by the one or more initiatives into the one or more target environments.

In one embodiment, the method further comprises: determining an actual performance score based on monitoring at least one of the tasks, the activities, and the events executed by the one or more initiatives into the one or more target environments.

In one embodiment, the method further comprises: determining an expected performance score based on analyzing the one or more initiatives.

In one embodiment, the method further comprises: comparing the actual performance score and an expected performance score.

In one embodiment, the method further comprises: determining a deficit score based on the comparison of the actual performance score and the expected performance score.

In one embodiment, the method further comprises: determining, using the artificial intelligence engine, one or more issues based on the comparison of the actual performance score and the expected performance score.

In one embodiment, the one or more issues comprise at least one of scope issues, priority issues, budget issues, and resource issues.

In one embodiment, the method further comprises: communicating feedback information back to a processor based on the issues.

In one embodiment, the feedback information comprises at least one of a resource strategy, a scope strategy, a priority strategy, and a budget strategy.

In one embodiment, the method further comprises: updating at least one of the one or more business propositions and the one or more initiatives based on the feedback information.

In one embodiment, the method further comprises: updating at least one of scope, budget, resource, and priority in at least one of the one or more business propositions and the one or more initiatives based on the feedback information.

In one embodiment, the method further comprises: generating a real-time report using at least one of historical trends, historical patterns, historical records, the analysis, the issues, the feedback information, and the update performed.

In one embodiment, the method further comprises: communicating with one or more external applications through an application programming interface (API) and exchanging the information.

In one embodiment, the one or more issues comprise one of scope deficits, scope surplus, budget deficit, budget surplus, resource deficit, resource surplus, and priority issues.

In one embodiment, the method further comprises: enabling one or more users to collaborate in real-time to analyze at least one of the one or more business propositions and the one or more initiatives, determine issues, and update at least one of the one or more business propositions and the one or more initiatives.

In one embodiment, the method further comprises: determining at least one of resources, budgets, priorities, and scopes, using one or more estimating models, for at least one of the one or more business propositions and the one or more initiatives.

In one embodiment, the method further comprises: performing at least one of manage execution of agendas, manage activities, manage events, manage tasks, trigger, and host online meetings, manage actions, take meeting notes, and record activities in a repository.

In one embodiment, the method further comprises: analyzing the execution of tasks and activities and taking decisions in real-time.

In one embodiment, the method further comprises: interpreting written text using the artificial intelligence engine through natural language processing.

In one embodiment, the method further comprises: converting written text to one or more commands in a machine readable format and communicating the one or more commands to one or more agents.

In one embodiment, the one or more agents comprise one or more automated robots.

In one embodiment, the one or more agents execute one or more activities, one or more tasks, and one or more events at scheduled dates and times based on the one or more commands.

In one embodiment, the method further comprises: implementing the one or more initiatives into one or more target environments through one or more agents.

In one embodiment, the method further comprises: receiving the information from at least one of one or more users and one or more agents.

In an aspect, a non-transitory computer readable storage medium is described. The non-transitory computer readable storage medium comprising a sequence of instructions, which when executed by a processor causes: receiving information related to one or more business propositions; creating one or more business propositions based on the information received; analyzing, using an artificial intelligence engine, the one or more business propositions and group the one or more business propositions for one or more categories; and creating, using the artificial intelligence engine, one or more initiatives for the one or more categories.

In one embodiment, the non-transitory computer readable storage medium, further causes: implementing the one or more initiatives into one or more target environments.

In one embodiment, the non-transitory computer readable storage medium, further causes: monitoring at least one of tasks, activities, and events executed by the one or more initiatives into the one or more target environments.

In one embodiment, the non-transitory computer readable storage medium, further causes: determining an actual performance score based on monitoring at least one of the tasks, the activities, and the events executed by the one or more initiatives into the one or more target environments.

In one embodiment, the non-transitory computer readable storage medium, further causes: determining an expected performance score based on analyzing the one or more initiatives.

In one embodiment, the non-transitory computer readable storage medium, further causes: comparing the actual performance score and an expected performance score.

In one embodiment, the non-transitory computer readable storage medium, further causes: determining a deficit score based on the comparison of the actual performance score and the expected performance score.

In one embodiment, the non-transitory computer readable storage medium, further causes: determining, using the artificial intelligence engine, one or more issues based on the comparison of the actual performance score and the expected performance score.

In one embodiment, the one or more issues comprise at least one of scope issues, priority issues, budget issues, and resource issues.

In one embodiment, the non-transitory computer readable storage medium, further causes: communicating feedback information back to a processor based on the issues.

In one embodiment, the feedback information comprises at least one of a resource strategy, a scope strategy, a priority strategy, and a budget strategy.

In one embodiment, the non-transitory computer readable storage medium, further causes: updating at least one of the one or more business propositions and the one or more initiatives based on the feedback information.

In one embodiment, the non-transitory computer readable storage medium, further causes: updating at least one of scope, budget, resource, and priority in at least one of the one or more business propositions and the one or more initiatives based on the feedback information.

In one embodiment, the non-transitory computer readable storage medium, further causes: generating a real-time report using at least one of historical trends, historical patterns, historical records, the analysis, the issues, the feedback information, and the update performed.

In one embodiment, the non-transitory computer readable storage medium, further causes: communicating with one or more external applications through an application programming interface (API) and exchanging the information.

In one embodiment, the one or more issues comprise one of scope deficits, scope surplus, budget deficit, budget surplus, resource deficit, resource surplus, and priority issues.

In one embodiment, the non-transitory computer readable storage medium, further causes: enabling one or more users to collaborate in real-time to analyze at least one of the one or more business propositions and the one or more initiatives, determine issues, and update at least one of the one or more business propositions and the one or more initiatives.

In one embodiment, the non-transitory computer readable storage medium, further causes: determining at least one of resources, budgets, priorities, and scopes, using one or more estimating models, for at least one of the one or more business propositions and the one or more initiatives.

In one embodiment, the non-transitory computer readable storage medium, further causes: performing at least one of manage execution of agendas, manage activities, manage events, manage tasks, trigger, and host online meetings, manage actions, take meeting notes, and record activities in a repository.

In one embodiment, the non-transitory computer readable storage medium, further causes: analyzing the execution of tasks and activities and taking decisions in real-time.

In one embodiment, the non-transitory computer readable storage medium, further causes: interpreting written text using the artificial intelligence engine through natural language processing.

In one embodiment, the non-transitory computer readable storage medium, further causes: converting written text to one or more commands in a machine readable format and communicating the one or more commands to one or more agents.

In one embodiment, the one or more agents comprise one or more automated robots.

In one embodiment, the one or more agents execute one or more activities, one or more tasks, and one or more events at scheduled dates and times based on the one or more commands.

In one embodiment, the non-transitory computer readable storage medium, further causes: implementing the one or more initiatives into one or more target environments through one or more agents.

In one embodiment, the non-transitory computer readable storage medium, further causes: receiving the information from at least one of one or more users and one or more agents.

The methods and systems disclosed herein may be implemented in any means for achieving various aspects and may be executed in a form of a non-transitory machine-readable medium embodying a set of instructions that, when executed by a machine, causes the machine to perform any of the operations disclosed herein. Other features will be apparent from the accompanying drawings and from the detailed description that follows.

### BRIEF DESCRIPTION OF THE FIGURES

These and other aspects of the present disclosure will now be described in more detail, with reference to the appended drawings showing exemplary embodiments, in which:

FIG. 1 illustrates a system according to one or more embodiments.

FIG. 2 illustrates a method, according to one or more embodiments.

FIG. 3 illustrates a non-transitory computer readable storage medium, according to one or more embodiments.

FIG. 4 illustrates a user interface view, rendering business propositions and initiatives, according to one or more embodiments.

FIG. 5 illustrates business propositions, according to one or more embodiments.

FIG. 6 illustrates grouping of business propositions and creating initiatives, according to one or more embodiments.

FIG. 7 illustrates a user interface view, rendering initiatives, according to one or more embodiments.

FIG. 8 illustrates an initiative funding request (IFR) inbox, according to one or more embodiments.

FIG. 9 illustrates priorities for initiatives, according to one or more embodiments.

FIG. 10 illustrates a user interface view for Run The Business (RTB) resource allocation, according to one or more embodiments.

FIG. 11a and FIG. 11b illustrate a Resource, Effort, Cost (REC) analytics dashboard, according to one or more embodiments.

FIG. 12 illustrates a budget decision framework, according to one or more embodiments.

FIG. 13 illustrates a business plan rendered on a dashboard upon finalizing the initiative funding requests, according to one or more embodiments.

FIG. 14a and FIG. 14b illustrate a structure and classification of components of the business planning method and workflow, according to one or more embodiments.

FIG. 14c illustrates testing phases, according to one or more embodiments.

FIG. 15a, FIG. 15b and FIG. 15c illustrate business plan configurations, according to one or more embodiments.

FIG. 16 illustrates a process approval workflow, according to one or more embodiments.

FIG. 17a -17e illustrates executive planning sessions, according to one or more embodiments.

FIG. 18 illustrates triangulation of effort estimates and full time equivalent (FTE) estimates across estimating models and versions, according to one or more embodiments.

FIG. 19 illustrates a functional architecture, according to one or more embodiments.

FIG. 20 illustrates a program management framework, according to one or more embodiments.

FIG. 21 illustrates a connection between planning and execution, according to one or more embodiments.

FIG. 22a, FIG. 22b, and FIG. 22c illustrate a deployment architecture, according to one or more embodiments.

FIG. 23a and FIG. 23b illustrate model outputs, according to one or more embodiments.

FIG. 24 illustrates reference tables, according to one or more embodiments.

FIG. 25a and FIG. 25b illustrate client onboarding, according to one or more embodiments.

FIG. 26 illustrates a user interface view rendering business proposition (BP) intake form, according to one or more embodiments.

FIG. 27a illustrates a user interface view rendering business proposition aggregate form, according to one or more embodiments.

FIG. 27b illustrates a business proposition aggregate template, according to one or more embodiments.

FIG. 28 illustrates a user interface view rendering executive planning session (EPS) round 1 pitch, according to one or more embodiments.

FIG. 29 illustrates a user interface view rendering Run the Business, according to one or more embodiments.

FIG. 30a and FIG. 30b illustrate a user interface view rendering initiative funding request template, according to one or more embodiments.

FIG. 31 illustrates a budget decision framework, according to one or more embodiments.

FIG. 32a shows a block diagram of the cyber security module in view of the system and server.

FIG. 32b shows an embodiment of the cyber security module.

FIG. 32c shows another embodiment of the cyber security module.

FIG. 33a shows a structure of the neural network/machine learning model with a feedback loop.

FIG. 33b shows a structure of the neural network/machine learning model with reinforcement learning.

Other features of the present embodiments will be apparent from the accompanying drawings and from the detailed description that follows.

### DETAILED DESCRIPTION

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs.

Unless defined otherwise, all technical and scientific terms used herein have the same meaning as commonly understood by one with ordinary skill in the art.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No clement act, or instruction used herein is critical or essential unless explicitly described as such. Furthermore, the term “set” includes items (e.g., related items, unrelated items, a combination of related items and unrelated items, etc.) and may be interchangeable with “one or more”. Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc. in question is or is not removable.

As used herein, the term “or” means an inclusive “or” rather than an exclusive “or.” That is, unless specified otherwise, or clear from context. “X employs A or B” means any of the natural inclusive permutations. That is, if X employs A; X employs B; or X employs both A and B, then “X employs A or B” is satisfied under any of the foregoing instances.

As used herein, two or more elements or modules are “integral” or “integrated” if they operate functionally together. Two or more elements are “non-integral” if each element can operate functionally independently.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Digital electronic circuitry, or in computer software, firmware, or hardware, including the structures disclosed in this specification and their structural equivalents, or in combinations of one or more of them may realize the implementations and all of the functional operations described in this specification. Implementations may be as one or more computer program products, i.e., one or more modules of computer program instructions encoded on a computer readable storage medium for execution by, or to control the operation of, data processing apparatus. The computer readable storage medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of a digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc. may embed a computer. Computer readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship to each other.

Embodiments may comprise or utilize a special purpose or general purpose computer including computer hardware. Embodiments within the scope of the present invention may also include physical and other computer readable media for carrying or storing computer-executable instructions and/or data structures. Such computer readable media can be any media accessible by a general purpose or special purpose computer system. Computer readable media that store computer-executable instructions are physical storage media. Computer readable media that carry computer-executable instructions are transmission media. Thus, by way of example and not limitation, embodiments of the invention can comprise at least two distinct kinds of computer readable media: physical computer readable storage media and transmission computer readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer readable media includes combinations of the above, that enable the transport of electronic data between computer systems and/or modules and/or other electronic devices. Further, upon reaching various computer system components, program code in the form of computer-executable instructions or data structures can be transferred automatically from transmission computer readable media to physical computer readable storage media (or vice versa). For example, computer-executable instructions or data structures received over a network or data link can be buffered in RAM within a Network Interface Module (NIC), and then eventually transferred to computer system RAM and/or to less volatile computer readable physical storage media at a computer system. Thus, computer system components that also (or even primarily) utilize transmission media may include computer readable physical storage media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer readable media such as computer memory may practice the methods. In particular, one or more processors execute computer-executable instructions, stored in the computer memory, to perform various functions such as the acts recited in the embodiments.

Those skilled in the art will appreciate that the invention may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (cither by hardwired data links, wireless data links, or by a combination of hardwired and wireless data links) through a network, both perform tasks may also practice the invention. In a distributed system environment, program modules may be located in both local and remote memory storage devices.

The following terms and phrases, unless otherwise indicated, shall have the following meanings.

As used herein, the term “scope” also refers to features and functions of a product, or the scope of work needed to finish a project. Scope involves getting information required to start a project, including the features the product needs to meet the objectives of its stakeholders. It may also refer to the range of activities that are necessary for a commercial venture to operate successfully. The term “scope” may also refer to an area in which a company operates and its specific products or services. It may also refer to the extent of the area or subject matter that something deals with or to which it is relevant.

As used herein, the term “strategy” refers to a plan that is created for a business to achieve its goals. The goals may be short term goals and long-term goals. The term “strategy” also refers to actions and decisions created for an organization that are to be executed to achieve the goals. The strategy defines the guiding principles for many organizational decisions, such as hiring new employees, or developing new products. The strategy also further outlines the plan of action to achieve the vision and set objectives of an organization and guides the decision-making processes to improve the company's financial stability in a competing market.

As used herein, the term “business proposition” (BP) refers to contents that acknowledge business need, customer pain points, business constraints, business outcomes, and presents solutions with information, connecting product/service and target customers. Business propositions may comprise information in appropriate fields.

As used herein, the term “initiative” refers to an organized format of plurality of business propositions grouped under a common name. The business propositions may be grouped as an initiative based on sponsorship interests, resource requirements, budget, technology, capacity, etc.

As used herein, the term “target environment” refers to an environment having a plurality of resources on which the model is implemented. The resources may be a plurality of people and computing resources.

As used herein, the term “task” refers to a piece of work that has to be done.

As used herein, the term “activity” refers to an action item to be executed to achieve a particular aim.

As used herein, the term “event” refers to a planned or unplanned occurrence, situation, or incident that has significance or meaning.

As used herein, the term “actual performance score” refers to a service level actually achieved, over a given period, for a service provided by the service provider.

As used herein, the term “expected performance score” refers to an anticipated or expected service level to be achieved, over a given period, for a service provided by the service provider.

As used herein, the term “deficit score” refers to a value estimated by which a resource, for e.g. people, money, falls short of what is required.

As used herein, the term “feedback” refers to information from the output of a system that is used as input back into the system as part of a chain of cause and effect. It may also refer to prior action or behavior from an individual, communicated to another individual (or a group) who can use that information to adjust and improve current and future actions and behaviors.

As used herein, the term “budget” refers to a spending plan based on revenue and expenses.

As used herein, the term “resource” refers to something (people, physical materials, digital products, computing resources, electronic items, virtual items, money etc.) that can be used for providing a service or running an organization and making profits or benefits.

As used herein, the term “resource allocation” refers to an activity that involves distributing available resources, such as finances, personnel, time, equipment, and materials, among various activities or projects within an organization to achieve specific objectives. Effective resource allocation is crucial for optimizing productivity, meeting goals, and ensuring efficient use of limited resources.

As used herein, the term “estimating model” refers to an algorithm which produces an estimate for some value. Estimating models are used to calculate estimated effort for tasks or work breakdown elements. There are two parts of an estimating model: an estimation formula and one or more estimation factors that are used by the estimating formula. Estimating models are tools used to predict or forecast certain outcomes based on available data and mathematical algorithms. There are various types of estimating models used in different fields, such as statistics, finance, engineering, and machine learning.

As used herein, the term “agent” refers to a program or entity designed to act autonomously within a specific environment or system. These agents are often created to perform tasks, make decisions, or interact with other agents or users, simulating a level of intelligence or autonomy.

As used herein, the term “program management framework” refers to a structured approach for planning, executing, and overseeing a set of related projects and activities to achieve specific strategic goals within an organization. The program management framework is designed to ensure alignment between these projects and the overall objectives of the program.

As used herein, the term “Application Programming Interface (API)” refers to a set of rules, protocols, and tools that allows different software applications to communicate and interact with each other.

As used herein, the term “artificial intelligence (AI) engine” refers to the core component or system that drives AI capabilities within applications. AI engines can process vast amounts of data, making them capable of handling complex tasks and generating insights from large datasets.

As used herein, the term “Machine learning” refers to algorithms that give a computer the ability to learn without being explicitly programmed, including algorithms that learn from and make predictions about data. Machine learning techniques include, but are not limited to, support vector machine, artificial neural network (ANN) (also referred to herein as a “neural net”), deep learning neural network, logistic regression, discriminant analysis, random forest, linear regression, rules-based machine learning, Naive Bayes, nearest neighbor, decision tree, decision tree learning, and hidden Markov, etc. For the purposes of clarity, algorithms such as linear regression or logistic regression can also be used as part of a machine learning process. However, it is understood that using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. The ANN may be featured with a feedback loop to adjust the system output dynamically as it learns from the new data as it becomes available. In machine learning, backpropagation and feedback loops are used to train the AI/ML model improving the model's accuracy and performance over time.

As used herein, the term “vision alignment” refers to ensuring that the goals, objectives, and actions of individuals, teams, or organizations are in harmony with the overarching vision or mission. It involves aligning the efforts and direction of all stakeholders toward achieving a common purpose.

As used herein, the term “program execution phase” is a critical stage within program management where the planned initiatives, projects, and activities are put into action to achieve the defined objectives. The program execution phase involves the implementation of strategies, plans, and processes outlined during the planning phase of the program.

As used herein, the term “L1 estimate” may refer to as “Level 1 estimate”. The L1 estimate refers to the output of an algorithm customized or modeled for estimating the effort for a business proposition. The level 1 estimates may be used for round 1 of the client's Initiative rationalization step in the BPLC. The precision of an L1 estimate is in terms of orders of magnitude.

As used herein, the term “L2 estimate” may be referred to as “Level 2 estimate.” The L2 estimate refers to the output of an algorithm customized or modeled for estimating initiative effort and is based on functional components. The L2 estimates may be adapted for IFR approval. The precision of L2 estimate is based on conceptual design for the initiative solution.

As used herein, the term “L3 estimate” may be referred to as “Level 3 estimate.” The L3 estimate refers to the output of an algorithm customized or modeled for Bottom-up estimates for end-to-end solution components. The L3 estimates may be adapted for estimation of end to end solutions based on confirmed (post IFR approval) Scope, Resources and Timing. The L3 estimate uses baseline as precision to perform program planning, progress monitoring, reporting, etc.

As used herein, the term “planning paradigm” refers to the fundamental framework or approach used to conceptualize, design, and execute plans or strategies within a particular field, discipline, or context. The planning paradigm represents the overarching principles, methodologies, and perspectives that guide the planning process.

As used herein, the term “taxonomy” refers to a systematic classification system used to organize and categorize entities, concepts, or objects based on shared characteristics, relationships, or attributes. It aims to create a hierarchical structure that helps in understanding, organizing, and identifying relationships among various elements within a specific domain.

As used herein, the term “Cryptographic protocol” is also known as security protocol or encryption protocol. It is an abstract or concrete protocol that performs a security-related function and applies cryptographic methods often as sequences of cryptographic primitives. A protocol describes usage of the algorithms. A sufficiently detailed protocol includes details about data structures and representations, to implement multiple, interoperable versions of a program. Cryptographic protocols are widely used for secure application-level data transport. A cryptographic protocol usually incorporates at least some of these aspects: key agreement or establishment, entity authentication, symmetric encryption, and message authentication, secured application-level data transport, non-repudiation methods, secret sharing methods, and secure multi-party computation. Hashing algorithms may be used to verify the integrity of data. Secure Socket Layer (SSL) and Transport Layer Security (TLS), the successor to SSL, are cryptographic protocols that may be used by networking switches to secure data communications over a network.

Secure application-level data transport widely uses cryptographic protocols. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation.

Networking switches use cryptographic protocols, like Secure Socket Layer (SSL) and Transport Layer Security (TLS), the successor to SSL, to secure data communications over a wireless network.

As used herein, the term “Unauthorized access” is when someone gains access to a website, program, server, service, or other system using someone else's account or other methods. For example, if someone kept guessing a password or username for an account that was not theirs until they gained access, it is considered unauthorized access.

As used herein, the term “Dashboard” is a type of interface that visualizes particular Key Performance Indicators (KPIs) for a specific goal or process. It is based on data visualization and infographics.

As used herein, a “Database” is a collection of organized information so that it can be easily accessed, managed, and updated. Computer databases typically contain aggregations of data records or files.

As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

The terms “non-transitory computer readable storage medium” and “computer readable storage medium” include a single medium or multiple media such as a centralized or distributed database, and/or associated caches and servers that store one or more sets of instructions. Further, the terms “non-transitory computer readable storage medium” and “computer readable storage medium” include any tangible medium that is capable of storing, encoding, or carrying a set of instructions for execution by a processor that, for example, when executed, cause a system to perform any one or more of the methods or operations disclosed herein. As used herein, the term “computer readable storage medium” is expressly defined to include any type of computer readable storage device and/or storage disk and to exclude propagating signals.

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in an RS-232 serial transmission. A software handshake sends codes such as “synchronize” (SYN) and “acknowledge” (ACK) in a TCP/IP transmission.

The term “cyber security” as used herein refers to application of technologies, processes, and controls to protect systems, networks, programs, devices, and data from cyber-attacks.

The term “cyber security module” as used herein refers to a module comprising application of technologies, processes, and controls to protect systems, networks, programs, devices and data from cyber-attacks and threats. It aims to reduce the risk of cyber-attacks and protect against the unauthorized exploitation of systems, networks, and technologies. It includes, but is not limited to, critical infrastructure security, application security, network security, cloud security, Internet of Things (IoT) security.

The term “encrypt” used herein refers to securing digital data using one or more mathematical techniques, along with a password or “key” used to decrypt the information. It refers to converting information or data into a code, especially to prevent unauthorized access. It may also refer to concealing information or data by converting it into a code. It may also be referred to as cipher, code, encipher, encode. A simple example is representing alphabets with numbers—say, ‘A’ is ‘01’, ‘B’ is ‘02’, and so on. For example, a message like “HELLO” will be encrypted as “0805121215,” and this value will be transmitted over the network to the recipient(s).

The term “decrypt” used herein refers to the process of converting an encrypted message back to its original format. It is generally a reverse process of encryption. It decodes the encrypted information so that only an authorized user can decrypt the data because decryption requires a secret key or password. This term could be used to describe a method of unencrypting the data manually or unencrypting the data using the proper codes or keys.

The term “cyber security threat” used herein refers to any possible malicious attack that seeks to unlawfully access data, disrupt digital operations, or damage information. A malicious act includes but is not limited to damaging data, stealing data, or disrupting digital life in general. Cyber threats include, but are not limited to, malware, spyware, phishing attacks, ransomware, zero-day exploits, trojans, advanced persistent threats, wiper attacks, data manipulation, data destruction, rogue software, malvertising, unpatched software, computer viruses, man-in-the-middle attacks, data breaches, Denial of Service (DOS) attacks, and other attack vectors.

The term “hash value” used herein can be thought of as fingerprints for files. The contents of a file are processed through a cryptographic algorithm, and a unique numerical value, the hash value, is produced that identifies the contents of the file. If the contents are modified in any way, the value of the hash will also change significantly. Example algorithms used to produce hash values: the Message Digest-5 (MD5) algorithm and Secure Hash Algorithm-1 (SHA1).

The term “alarm” as used herein refers to a trigger when a component in a system or the system fails or does not perform as expected. The system may enter an alarm state when a certain event occurs. An alarm indication signal is a visual signal to indicate the alarm state. For example, when a cyber security threat is detected, a system administrator may be alerted via sound alarm, a message, a glowing LED, a pop-up window, etc. Alarm indication signal may be reported downstream from a detecting device, to prevent adverse situations or cascading effects.

The term “in communication with” as used herein, refers to any coupling, connection, or interaction using electrical signals to exchange information or data, using any system, hardware, software, protocol, or format, regardless of whether the exchange occurs wirelessly or over a wired connection.

As used herein, the term “cryptographic protocol” is also known as security protocol or encryption protocol. It is an abstract or concrete protocol that performs a security-related function and applies cryptographic methods often as sequences of cryptographic primitives. A protocol describes how the algorithms should be used. A sufficiently detailed protocol includes details about data structures and representations, at which point it can be used to implement multiple, interoperable versions of a program. Cryptographic protocols are widely used for secure application-level data transport. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation. Hashing algorithms may be used to verify the integrity of data. Secure Socket Layer (SSL) and Transport Layer Security (TLS), the successor to SSL, are cryptographic protocols that may be used by networking switches to secure data communications over a network.

As used herein, the term “network” may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

As used herein, the term “component” broadly construes hardware, firmware, and/or a combination of hardware, firmware, and software.

The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. For example, the computer readable storage medium can be, but is not limited to, an electronic storage device, a magnetic storage device, an optical storage device, an electromagnetic storage device, a superconducting storage device, and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, does not construe transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein are downloadable to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA), and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. Each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter described herein is in the general context of computer-executable instructions of a computer program product that runs on a computer and/or computers, those skilled in the art will recognize that the one or more embodiments herein also can be implemented in combination with one or more other program modules. Program modules include routines, programs, components, data structures, and/or the like that perform particular tasks and/or implement particular abstract data types. Moreover, other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like can practice the herein described computer-implemented methods. Distributed computing environments, in which remote processing devices linked through a communications network perform tasks, can also practice the illustrated aspects. However, stand-alone computers can practice one or more, if not all, aspects of the one or more embodiments described herein. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

As it is employed in the subject specification, the term “processor” can refer to any computing processing unit and/or device comprising, but not limited to, single-core processors; single-processors with software multi-thread execution capability; multi-core processors; multi-core processors with software multi-thread execution capability; multi-core processors with hardware multi-thread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A combination of computing processing units can implement a processor.

Herein, terms such as “store,” “storage,” “data store,” data storage,” “database,” and any other information storage component relevant to operation and functionality of a component refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random access memory (RAM) (e.g., ferroelectric RAM (FeRAM). Volatile memory can include RAM, which can function as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synch link DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein include, without being limited to including, these and/or any other suitable types of memory.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

In an embodiment, the system is configured to perform business planning. The system comprises business planning taxonomy, protocols, models, algorithms, and software platform. In short, the system is configured to provide one on-line platform to enable all stakeholders across an enterprise to develop robust business plans using a uniform lexicon across departments, geographies, and markets. The system described herein enables users and organizations to plan for major investments in business, operations, and technology initiatives every year. The system is a cloud-native platform that enables collaboration by senior executives across geographies, lines of business, departments, and functions, using real-time decision-making methods and tools. The system enables businesses to scale more efficiently. The system also enables optimal deployment of specialized expertise, while allowing for flexible adjustments and course corrections of business propositions and initiatives. The system is configured to monitor and analyze available budgets and opportunities to deploy scarce resources to strategic initiatives. The system comprises a natural language processing engine that interprets the one or more contents and captures the salient information about the one or more business propositions.

The system comprises a processor and memory. The memory stores instructions that when executed by the processor causes execution of the intended functions. The processor renders a user interface that enables the user to interact and/or communicate with the system. The processor renders the user interface that enables the users to perform intended functions (such as creating business propositions (BP), creating initiatives, collaborate, discuss, deploy BPs and initiatives into target environment, monitor execution of BPs, update BP and/or initiatives concurrently, control agents, etc.). The processor enables the users (executives, senior executives of organizations) to engage in constructive dialog to rationalize initiatives and create a portfolio of funded programs through the user interface. The processor enables the users (e.g., sponsors) to model and negotiate funding priorities in real-time, based on business objectives and their ability to deliver. The processor enables the users to manage session agendas, meeting notes, actions, and decisions in real-time, directly on the platform through the user interface rendered. The processor using estimating models analyzes the BPs and initiatives to rethink how resources are allocated to support the existing roster of clients. The processor through the advanced estimating models enables initiative sponsors to adjust scope and priorities, even before funding is requested. The processor through the advanced estimating models may also adjust scope and priorities automatically, even before funding is requested. The processor generates and real-time reports and renders to the user via user interface onto the dashboard for analysis and to address expertise gaps, and resource allocations. The system is configured to seamlessly exchange information with existing applications, including HR, finance, issue management and Sales pipeline management systems.

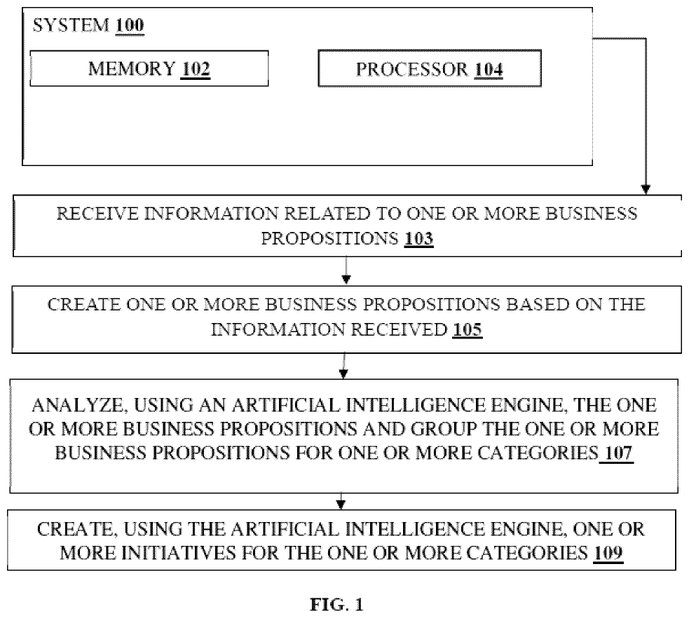

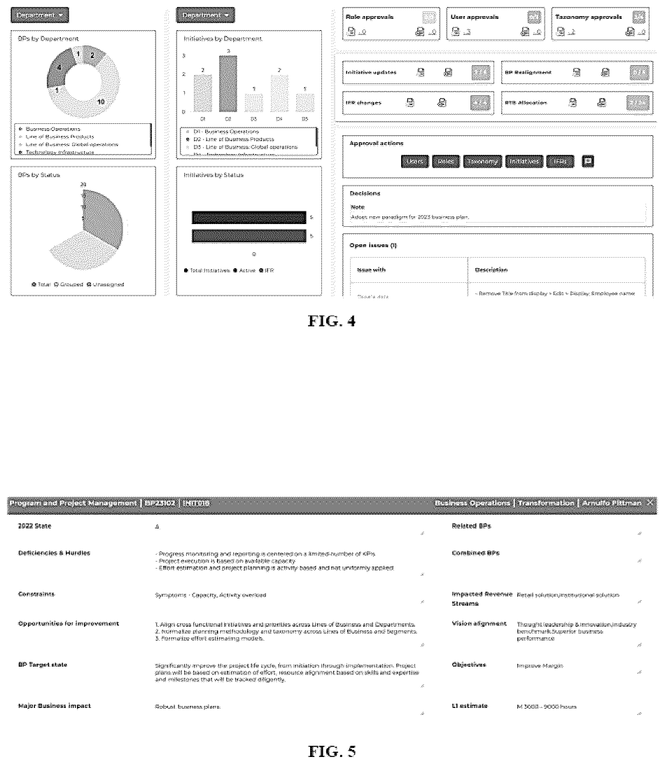

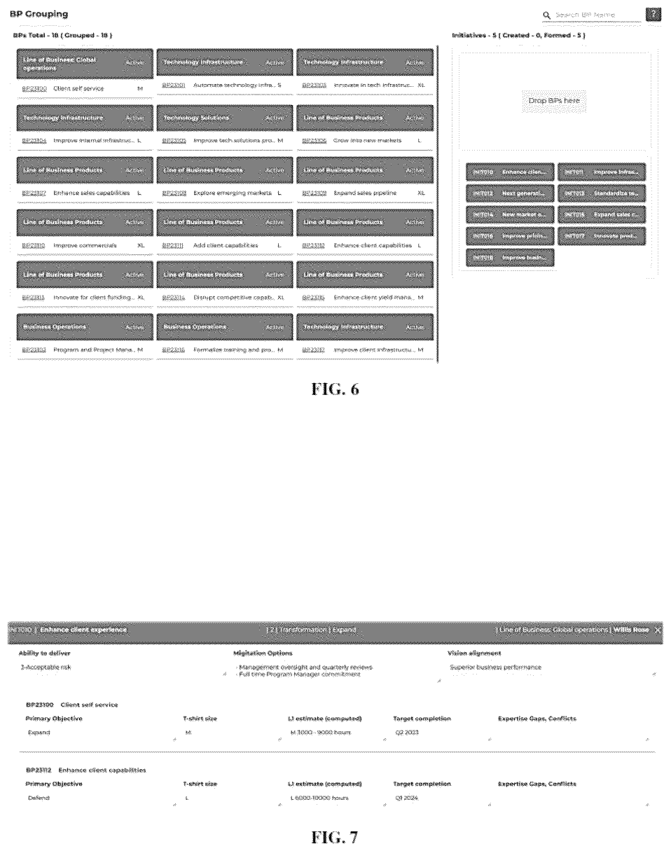

FIG. 1 illustrates a system according to one or more embodiments. The system 100 comprises: a memory 102; and a processor 104 that is communicatively coupled to the memory 102 storing a sequence of instructions that when executed causes the processor 104 to: receive information related to one or more business propositions (at step 103); create one or more business propositions based on the information received (at step 105); analyze, using an artificial intelligence engine, the one or more business propositions and group the one or more business propositions for one or more categories (at step 107); and create, using the artificial intelligence engine, one or more initiatives for the one or more categories (at step 109). The processor 104 receives the information from users. In an embodiment, the user may be stakeholders, sponsors, and/or personnels/officials from enterprises. The information comprises at least one of resource information, budget information, and scope information. The information may comprise at least previous state, deficiencies and hurdles, constraints, opportunities for improvement, business propositions (BP) target state, major business impact, vision alignment, objectives, etc. as shown in FIG. 5. In one embodiment, the processor 104 is operable to receive the information from at least one of one or more users and one or more agents. The business propositions comprise project plans, assumptions, and effort estimates, etc.

The processor 104 creates the one or more business propositions based on the information received by executing the following technical steps. The processor 104 analyzes the information received and extracts one or more contents that are related and/or relevant to the business. The contents comprise at least one of keywords, terms, and/or statements from the information received. The keywords, terms, and/or statements may be the contents that impact the business execution and/or outcome. The contents may be more specifically related to scope, budget, and resources. The scope refers to the area in which a company operates and its specific products or services. The scope also refers to the range of activities that are necessary for a commercial venture (e.g., business, organization, enterprise, etc.) to operate successfully. For example, a restaurant's scope of business may include activities such as food preparation, customer service, marketing, and inventory management. For another example, a construction company's scope of business may include activities such as project management, site preparation, building construction, raw materials collection, and equipment maintenance. The processor 104 may, in association with an artificial intelligence engine, perform natural language processing to interpret the information and extract the one or more contents appropriate to create the one or more business propositions. The previous state may comprise a predefined state (for example state A). The deficiencies and hurdles refer to factors that the organization faces/struggles with while undertaking any task/activity. The constraints refer to factors that impact the outcome of the business. The opportunities for improvement refers to factors that the organization should execute and/or overcome to achieve the goals. The BP target state refers to the state that the organization is planning to achieve in the current financial year.

The processor 104 then finally creates the project plans based on the assumptions and effort estimates. The processor 104 using the artificial intelligence engine analyzes the information received and creates the assumptions. The assumptions comprise at least tasks, activities, events etc. to be executed by the organization approximately. The processor 104 also segregates the tasks, activities, events etc. for each category (for example, department, geographic and market affiliations, etc.). The processor 104 using the artificial intelligence then determines the effort estimates. The effort estimates refer to the resources, and budget required for each of the tasks, activities, events etc. In an embodiment, the processor 104 may look for a relevant organization in one or more external databases based on the information. The processor 104 then extracts relevant documents from the one or more external databases. The documents may comprise resources, budget, profits, scope, tasks, etc. corresponding to the relevant organization. The processor 104 using the artificial intelligence learns efforts, resources, and budget required for particular activities, tasks, and events from the document. The processor 104 using the artificial intelligence engine further improves and updates the learning in upcoming iterations. The processor 104 using the artificial intelligence engine estimates the effort estimates based on the learning. The processor 104 uses the artificial intelligence engine to create the project plan. The project plan may comprise at least the task, activities, events tabulated against at least resources (e.g., amount of resources), resources type (e.g., labors, computers, skilled labors, robots, etc.), budgets, time period for execution, scheduled time of execution,

The processor 104 using the artificial intelligence engine creates the one or more initiatives from the one or more business propositions by executing the following technical steps. The processor 104 analyzes the one or more business propositions and identifies the one or more business propositions that are relevant (for example, in the same field, same industry, same technology, same interests, same line of business, same operations etc.). The processor 104 analyzes the one or more business propositions by interpreting the contents of the one or more business propositions using natural language processing. In one embodiment, the processor is operable to interpret written text using the artificial intelligence engine through natural language processing.

The processor 104 identifies the one or more business propositions that are relevant based on the analysis of the contents. The processor 104 using the artificial intelligence engine groups the one or more identified business propositions and creates one or more initiatives. In an embodiment, the processor 104 groups the one or more business propositions and creates the one or more initiatives based on at least one of the business objectives, scope, business outcomes, total budget, total resources incurred for those business propositions. The initiatives comprise more details than the business propositions. The initiatives comprise at least one of primary objectives, effort estimates (L1 estimate, L2 estimate, etc.), working hours range, target completion, and expertise gaps and conflicts. In an embodiment, the processor 104 automatically groups the one or more business propositions and creates the one or more initiatives (as shown in FIG. 6). In another embodiment, the processor 104 enables the users to manually select and group the one or more business propositions and create the one or more initiatives. The processor 104 enables the users to manually select and drop the one or more business propositions to create the one or more initiatives (as shown in FIG. 6). The processor 104 creates the one or more initiatives for one or more categories (for example, geographies, countries, departments, markets, etc.).

The processor 104 renders the one or more initiatives onto the dashboard of the one or more users. The processor 104 further enables the one or more users to collaborate in real-time. In one embodiment, the processor 104 is further operable to enable one or more users to analyze at least one of the one or more business propositions and the one or more initiatives, determine issues, and update at least one of the one or more business propositions and the one or more initiatives.

In one embodiment, the processor 104 is operable to determine an expected performance score based on analyzing the one or more initiatives. The processor 104 determines the expected performance score by executing the following technical steps. The processor 104 determines at least one of resources, budgets, priorities, and scopes, using one or more estimating models, for at least one of the one or more business propositions and the one or more initiatives. The processor 104 compares the resources, budgets, priorities, and scopes with information retrieved from similar organizations. The processor 104 then correlates the information respectively and determines an expected performance score. The expected performance score may vary from actual performance score. In an embodiment, the expected performance score may vary from actual performance score up to ±20%. The processor 104 determining the actual performance score is described below.

In one embodiment, the processor 104 is operable to implement the one or more initiatives on one or more target environments. The processor 104 is operable to monitor at least one of tasks, activities, and events executed by the one or more initiatives into the one or more target environments. The processor 104 determines an actual performance score based on monitoring at least one of the tasks, the activities, and the events executed by the one or more initiatives into the one or more target environments. The processor 104 is operable to compare the actual performance score and an expected performance score. The processor 104 is operable to determine a deficit score based on the comparison of the actual performance score and the expected performance score.

In one embodiment, the processor 104 is further operable to determine, using the artificial intelligence engine, one or more issues based on the comparison of the actual performance score and the expected performance score. The one or more issues comprise at least one of scope issues, priority issues, budget issues, and resource issues. In one embodiment, the one or more issues comprise one of scope deficits, scope surplus, budget deficit, budget surplus, resource deficit, resource surplus, and priority issues.

In one embodiment, the processor 104 is operable to communicate feedback information back to the processor based on the issues. The feedback information comprises at least one of a resource strategy, a scope strategy, a priority strategy, and a budget strategy. In one embodiment, the processor 104 is operable to update at least one of the one or more business propositions and the one or more initiatives based on the feedback information. In one embodiment, the processor 104 is operable to update at least one of scope, budget, resource, and priority in at least one of the one or more business propositions and the one or more initiatives based on the feedback information. In one embodiment, the processor is operable to generate a real-time report using at least one of historical trends, historical patterns, historical records, the analysis, the issues, the feedback information, and the update performed.

In one embodiment, the processor 104 is operable to communicate with one or more external applications through an application programming interface (API) and exchange the information. In one embodiment, the processor 104 is operable to at least one of manage execution of agendas, manage activities, manage events, manage tasks, trigger, and host online meetings, manage actions, take meeting notes, and record activities in a repository through the application programming interface. In one embodiment, the processor 104 is operable to analyze the execution of tasks and activities and to take decisions in real-time. In one embodiment, the processor 104 is operable to interpret written text using the artificial intelligence engine through natural language processing. In one embodiment, the processor 104 is operable to convert written text to one or more commands in a machine readable format and to communicate the one or more commands to one or more agents. The one or more agents comprise one or more automated robots. The one or more agents may be robotic process automation.

The one or more agents may execute one or more activities, one or more tasks, and one or more events at scheduled dates and times based on the one or more commands. In one embodiment, the processor 104 is operable to implement the one or more initiatives into one or more target environments through one or more agents.

In an embodiment, the system comprises following capabilities: Advanced analytics; GenAI algorithms; program management framework; and real-time integration with program execution phases of funded initiatives.

Advanced analytics refers to the use of sophisticated techniques and tools to analyze and interpret data, with the goal of extracting meaningful insights and making informed decisions. Advanced analytics techniques often go beyond traditional statistical methods and basic data analysis, leveraging technologies such as machine learning, artificial intelligence, predictive modeling, data mining, and optimization algorithms. Some common applications of advanced analytics include the following. Predictive analytics: The system performs predictive analytics using historical data to make predictions about future events or outcomes. The predictive analytics could include forecasting sales, predicting customer churn, or anticipating equipment failures. Prescriptive analytics: The system performs prescriptive analytics by recommending actions to optimize outcomes based on analysis of data and constraints. For example, determining the best pricing strategy to maximize profits or identifying the most efficient routes for delivery trucks. Machine learning: A subset of artificial intelligence that enables systems to learn from data and improve performance without being explicitly programmed. Machine learning algorithms can be used for tasks such as image recognition, natural language processing, and anomaly detection. Data mining: Data mining refers to the process of discovering patterns and relationships in large datasets. Data mining can involve techniques such as clustering, classification, association rule mining, and anomaly detection. Text analytics: Text analytics include analyzing unstructured text data, such as customer reviews, social media posts, or survey responses, to extract insights and sentiment. Big data analytics: Big data analytics include handling and analyzing large volumes of data that traditional analytics tools may struggle to process. Big data analytics often involves distributed computing frameworks like Hadoop or Spark.

“GenAI” algorithms refers to a variety of algorithms that are part of the field of generative artificial intelligence (AI) and machine learning (ML) aimed at generating content, models, or solutions automatically. Some common applications of GenAI algorithms include the following. Generative Adversarial Networks (GANs): GANs are a class of deep learning algorithms used for generating new data samples that resemble a training dataset. Generative Adversarial Networks (GANs) consist of two neural networks, the generator, and the discriminator, which are trained simultaneously in a competitive setting. Genetic Algorithms: Genetic algorithms are a type of optimization algorithm inspired by the principles of natural selection and genetics. Genetic Algorithms are used to evolve solutions to optimization and search problems by mimicking the process of natural selection. Evolutionary Algorithms: Similar to genetic algorithms, evolutionary algorithms are a family of optimization algorithms inspired by biological evolution. Evolutionary Algorithms include techniques such as genetic programming, evolution strategies, and differential evolution. Neuro evolution: Neuro evolution is a subset of evolutionary algorithms that uses evolutionary computation to train artificial neural networks. Instead of using traditional optimization techniques like gradient descent, neuro evolution evolves neural network architectures and parameters through genetic algorithms or other evolutionary strategies. Auto ML (Automated Machine Learning): Auto ML refers to techniques and algorithms that automate the process of applying machine learning to real-world problems. Auto ML (Automated Machine Learning) can include automated feature engineering, model selection, hyperparameter optimization, and even architecture search for neural networks. Natural Language Generation (NLG): NLG algorithms generate human-like text based on input data or instructions. Natural Language Generation (NLG) algorithms can be used for tasks such as summarization, translation, question answering, and content generation.

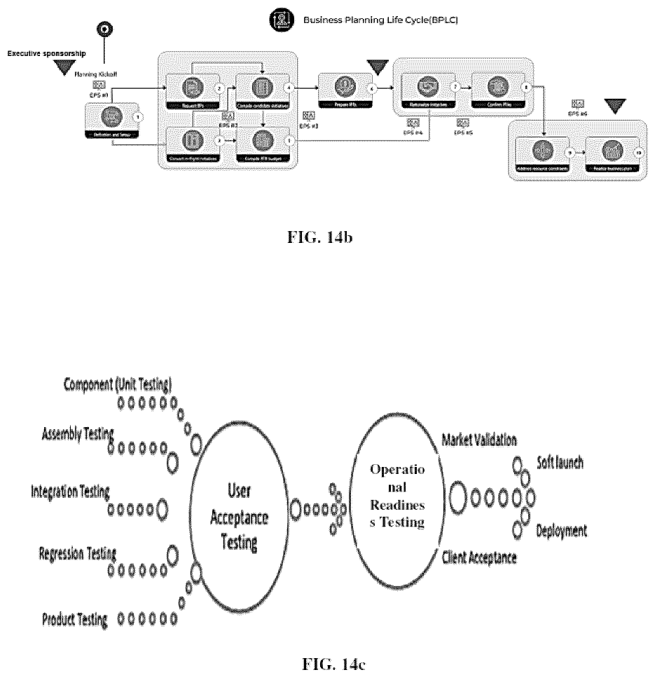

The program management framework provides a structured approach for managing and coordinating multiple related projects (often referred to as a program) to achieve specific strategic objectives or organizational goals. The program management framework typically includes a set of processes, methodologies, tools, and practices to ensure effective planning, execution, monitoring, and control of the program's activities. Funded Initiatives are executed as Programs. The Program Management Framework enables the creation of robust program plans that encompass all phases in the PLC, and ongoing monitoring for alignment with the program objectives. Below is a program management framework tailored for business planning, as depicted in FIG. 20 and FIG. 14a:

A project is a structured effort to accomplish a specific objective. The project includes developing a plan, defining and confirming the project goals and objectives, identifying tasks and an approach to how goals will be achieved, qualifying the resources needed, and determining budgets and timelines for completion.

Project Management entails managing teams, expectations and risks, while balancing time and resource constraints, in order for a company or individuals to improve operations or achieve a specific outcome as intended or defined by actionable set of goals. Program Management refers to managing a collection of Projects.

### Governance Model

The Governance Model defines the overall administration and conduct of projects within the organization. Composition and mandates of Committees and Working Groups are critically important for success.

### Program Methodology and Quality Standards

The system is based on a robust taxonomy for organizational functions, business objectives, initiative stages, and expertise.

The templates in the system enable alignment of the programs with objectives for respective revenue streams from the organization's products & services.

The resulting programs define the roles for every resource deployed to various activities in the project plan; thereby clarifying the concomitant roles and responsibilities.

### Project Plan

The project plan is the foundation on which a Project is based. The plan is supported by assumptions and estimates of effort.

Estimating tools in the system are designed to enable proficient Program Managers to visualize resource contention, expertise gaps, capacity requirements at the appropriate skill levels and conflicting assumptions.

### Scope, Time, Resources and Budget

The nodes of the triangle in FIG. 20 representing the three variables—Resources, Time, and Scope—are critically linked to each other. Lack of resources does not necessarily determine the end of a project. Lack of resources however could become the basis on which time (as in duration) can be re-estimated (more time is required to complete the same scope of work), or perhaps the Scope needs to be re-evaluated.

### Communication Strategy and Tactics

The system's communication protocol; i.e., structure, process and cadence, across all stakeholders, honed over four decades, increases probability of meeting program objectives and optimizes resource utilization.

### Infrastructure and Training

Organizationally, projects are supported by strong infrastructure and ongoing training. Infrastructure includes physical facilities and all its attended requirements, as well as robust technology infrastructure to support project teams globally. Training is an important facet of ensuring that teams are constantly enhancing and refreshing their base of knowledge to be able to apply the then current best practices, tools, techniques and methods to their on-going projects. It is also important to ensure that post-implementation training is integral to project plans.

### Strategic Alignment

The program management framework defines the organization's strategic objectives and goals; identifies key initiatives or programs required to achieve those objectives; and ensures that each program directly contributes to the organization's overall strategic plan.

### Program Identification and Prioritization

The program management framework identifies and prioritizes programs based on their potential impact on strategic objectives, resource requirements, and feasibility; assesses the interdependencies between programs and their alignment with organizational priorities.

### Program Charter and Governance

The program management framework develops a program charter that clearly defines the scope, objectives, deliverables, timelines, and success criteria for each program; establishes a governance structure with defined roles, responsibilities, and decision-making processes; and assigns an executive sponsor and program manager responsible for overseeing the program's execution.

### Business Case Development

The program management framework develops a business case for each program, outlining the rationale, expected benefits, resource requirements, risks, and investment justification. The program management framework conducts cost-benefit analysis and risk assessments to evaluate the viability and potential return on investment (ROI) of each program.

### Program Planning and Execution

The program management framework develops a comprehensive program plan that outlines the activities, milestones, dependencies, and resource allocations for each program. The program management framework implements project management methodologies (e.g., Agile, Waterfall) tailored to the specific needs of each program. The program management framework is configured to monitor progress, track key performance indicators (KPIs), and address issues or risks that may impact program outcomes.

### Stakeholder Engagement and Communication

The program management framework is configured to identify and engage stakeholders at various levels of the organization to ensure alignment, manage expectations, and solicit feedback. The program management framework is configured to develop a communication plan to keep stakeholders informed about program progress, milestones, and changes.

### Risk Management and Mitigation

The program management framework is configured to identify potential risks and uncertainties that may affect program delivery or outcomes. The program management framework is configured to develop risk mitigation strategies and contingency plans to address identified risks and minimize their impact on program objectives.

### Performance Monitoring and Evaluation

The program management framework is configured to establish performance metrics and key performance indicators (KPIs) to measure progress and outcomes against program objectives. The program management framework is configured to conduct regular reviews and evaluations to assess program performance, identify areas for improvement, and capture lessons learned.

### Benefits Realization

The program management framework is configured to define clear metrics and criteria for measuring the realization of benefits associated with each program. The program management framework is configured to monitor and track the achievement of expected benefits throughout the program lifecycle. The program management framework is configured to conduct post-implementation reviews to assess the actual value delivered by each program and identify opportunities for optimization or refinement.

Real-time integration with program execution phases of funded initiatives enables to significantly enhance transparency, responsiveness, and overall effectiveness. Real-time integration with program execution phases of funded initiatives can take place in following phases.

### Initiation Phase

The system at this phase uses real-time data analytics to assess the feasibility and potential impact of proposed initiatives. The system employs interactive dashboards or decision-support systems to facilitate real-time review and approval processes for funding allocation.

### Planning Phase

The system at this phase utilizes collaborative project management tools with real-time updates to develop detailed project plans, resource allocations, and timelines. The system, at this phase, implements real-time budget tracking and forecasting to monitor expenditure against allocated funds and identify potential budget overruns early.

### Execution Phase

The system at this phase enables real-time communication and collaboration among project teams, stakeholders, and decision-makers using chat platforms, video conferencing, and project management software. The system then implements real-time progress tracking and reporting mechanisms to provide stakeholders with up-to-date insights into project status, milestones achieved, and potential issues. The system then integrates real-time risk management tools to identify emerging risks promptly, assess their impact, and implement mitigation strategies as needed.

### Monitoring and Control Phase

The system implements real-time monitoring systems to track key performance indicators (KPIs) and project metrics, such as schedule adherence, resource utilization, and quality metrics. The system utilizes automated alerts and notifications to flag deviations from planned targets or thresholds, allowing for timely intervention and corrective actions. The system integrates real-time feedback mechanisms to capture stakeholder feedback, identify areas for improvement, and address issues promptly.

### Closure Phase

The system conducts real-time post-implementation reviews to evaluate the overall success of funded initiatives against predefined success criteria and performance metrics. The system captures lessons learned in real-time to inform future initiatives and improve program management practices. The system ensures real-time documentation and archiving of project deliverables, reports, and relevant communications for future reference and audit purposes.

The integration of real-time capabilities throughout the program execution phases of funded initiatives, enables organizations to enhance decision-making agility, responsiveness to change, and the ability to proactively address challenges as they arise. The integration of real-time capabilities throughout the program execution phases approach fosters a culture of continuous improvement and optimization, ultimately driving better outcomes and maximizing the value delivered by funded initiatives.

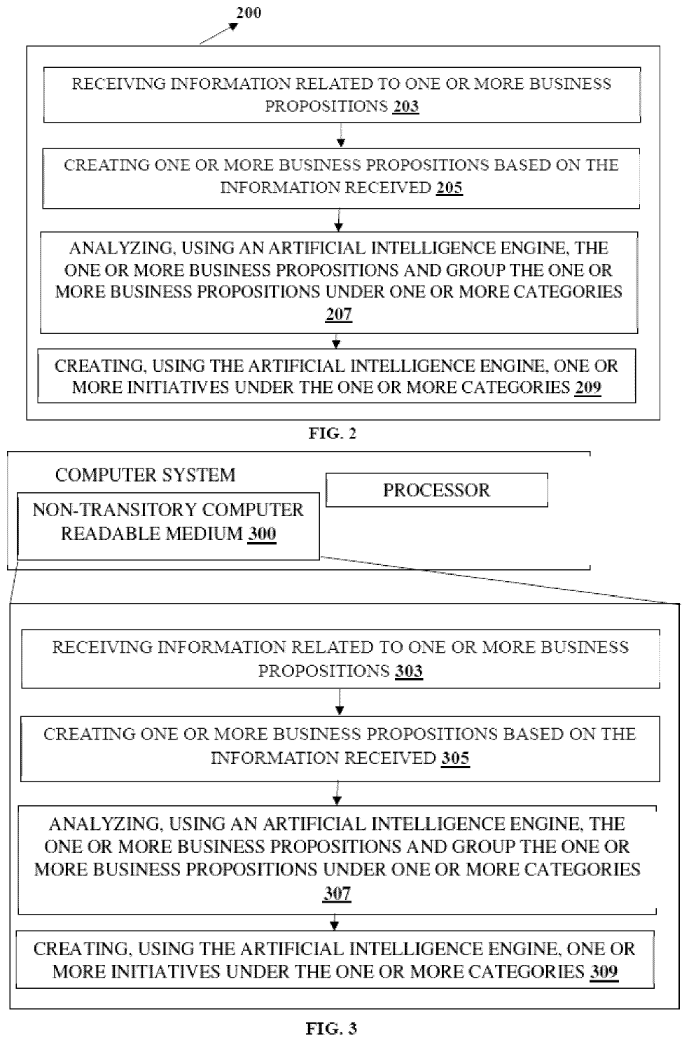

In an aspect, a method is described. As an example, FIG. 2 illustrates a method 200, according to one or more embodiments. The method 200 comprises the following technical steps: receiving information related to one or more business propositions (at step 203); creating one or more business propositions based on the information received (at step 205); analyzing, using an artificial intelligence engine, the one or more business propositions and group the one or more business propositions for one or more categories (at step 207); and creating, using the artificial intelligence engine, one or more initiatives for the one or more categories (at step 209). In one embodiment, the method further comprises: receiving the information from at least one of one or more users and one or more agents.

In one embodiment, the method 200 further comprises: implementing the one or more initiatives into one or more target environments. The method 200 further comprises: monitoring at least one of tasks, activities, and events executed by the one or more initiatives into the one or more target environments. The method 200 further comprises: determining an actual performance score based on monitoring at least one of the tasks, the activities, and the events executed by the one or more initiatives into the one or more target environments. The method 200 further comprises: determining an expected performance score based on analyzing the one or more initiatives.

The method 200 further comprises: comparing the actual performance score and an expected performance score; determining a deficit score based on the comparison of the actual performance score and the expected performance score. The method 200 further comprises: determining, using the artificial intelligence engine, one or more issues based on the comparison of the actual performance score and the expected performance score. In one embodiment, the one or more issues comprise at least one of scope issues, priority issues, budget issues, and resource issues. In another embodiment, the one or more issues comprise one of scope deficits, scope surplus, budget deficit, budget surplus, resource deficit, resource surplus, and priority issues.

The method 200 further comprises: communicating feedback information back to a processor based on the issues. The feedback information comprises at least one of a resource strategy, a scope strategy, a priority strategy, and a budget strategy. In one embodiment, the method 200 further comprises: updating at least one of the one or more business propositions and the one or more initiatives based on the feedback information. In one embodiment, the method 200 further comprises: updating at least one of scope, budget, resource, and priority in at least one of the one or more business propositions and the one or more initiatives based on the feedback information. In another embodiment, the method 200 further comprises: generating a real-time report using at least one of historical trends, historical patterns, historical records, the analysis, the issues, the feedback information, and the update performed. In one embodiment, the method 200 further comprises: determining at least one of resources, budgets, priorities, and scopes, using one or more estimating models, for at least one of the one or more business propositions and the one or more initiatives.

In one embodiment, the method 200 further comprises: communicating with one or more external applications through an application programming interface (API) and exchanging the information. In one embodiment, the method 200 further comprises: enabling one or more users to collaborate in real-time to analyze at least one of the one or more business propositions and the one or more initiatives, determine issues, and update at least one of the one or more business propositions and the one or more initiatives.

In one embodiment, the method 200 further comprises: performing at least one of manage execution of agendas, manage activities, manage events, manage tasks, trigger, and host online meetings, manage actions, take meeting notes, and record activities in a repository. In one embodiment, the method 200 further comprises: analyzing the execution of tasks and activities and taking decisions in real-time. The method 200 further comprises: interpreting written text using the artificial intelligence engine through natural language processing. In one embodiment, the method 200 further comprises: converting written text to one or more commands in a machine readable format and communicating the one or more commands to one or more agents. The one or more agents comprise one or more automated robots. In one embodiment, the one or more agents execute one or more activities, one or more tasks, and one or more events at scheduled dates and times based on the one or more commands. In one embodiment, the method 200 further comprises: implementing the one or more initiatives into one or more target environments through one or more agents.

In an aspect, a non-transitory computer readable storage medium is described. As an example, FIG. 3 illustrates a non-transitory computer readable storage medium 300, according to one or more embodiments. The non-transitory computer readable storage medium 300 comprising a sequence of instructions, which when executed by a processor causes: receiving information related to one or more business propositions (at step 303); creating one or more business propositions based on the information received (at step 305); analyzing, using an artificial intelligence engine, the one or more business propositions and group the one or more business propositions for one or more categories (at step 307); and creating, using the artificial intelligence engine, one or more initiatives for the one or more categories (at step 309). In one embodiment, the non-transitory computer readable storage medium, further causes: receiving the information from at least one of one or more users and one or more agents. In one embodiment, the non-transitory computer readable storage medium 300, further causes: implementing the one or more initiatives into one or more target environments. The non-transitory computer readable storage medium 300, further causes: monitoring at least one of tasks, activities, and events executed by the one or more initiatives into the one or more target environments. The non-transitory computer readable storage medium 300, further causes: determining an actual performance score based on monitoring at least one of the tasks, the activities, and the events executed by the one or more initiatives into the one or more target environments.

In one embodiment, the non-transitory computer readable storage medium 300, further causes: determining an expected performance score based on analyzing the one or more initiatives. The non-transitory computer readable storage medium 300, further causes: comparing the actual performance score and an expected performance score. The non-transitory computer readable storage medium 300, further causes: determining a deficit score based on the comparison of the actual performance score and the expected performance score.

In one embodiment, the non-transitory computer readable storage medium 300, further causes: determining, using the artificial intelligence engine, one or more issues based on the comparison of the actual performance score and the expected performance score. The one or more issues comprise at least one of scope issues, priority issues, budget issues, and resource issues. In one embodiment, the one or more issues comprise one of scope deficits, scope surplus, budget deficit, budget surplus, resource deficit, resource surplus, and priority issues. The non-transitory computer readable storage medium 300, further causes: communicating feedback information back to a processor based on the issues. The feedback information comprises at least one of a resource strategy, a scope strategy, a priority strategy, and a budget strategy. In one embodiment, the non-transitory computer readable storage medium 300, further causes: updating at least one of the one or more business propositions and the one or more initiatives based on the feedback information. In another embodiment, the non-transitory computer readable storage medium 300, further causes: updating at least one of scope, budget, resource, and priority in at least one of the one or more business propositions and the one or more initiatives based on the feedback information. In one embodiment, the non-transitory computer readable storage medium 300, further causes: generating a real-time report using at least one of historical trends, historical patterns, historical records, the analysis, the issues, the feedback information, and the update performed.

In one embodiment, the non-transitory computer readable storage medium 300, further causes: enabling one or more users to collaborate in real-time to analyze at least one of the one or more business propositions and the one or more initiatives, determine issues, and update at least one of the one or more business propositions and the one or more initiatives. The non-transitory computer readable storage medium 300, further causes: determining at least one of resources, budgets, priorities, and scopes, using one or more estimating models, for at least one of the one or more business propositions and the one or more initiatives.

In one embodiment, the non-transitory computer readable storage medium 300, further causes: communicating with one or more external applications through an application programming interface (API) and exchanging the information. In one embodiment, the non-transitory computer readable storage medium 300, further causes: performing at least one of manage execution of agendas, manage activities, manage events, manage tasks, trigger, and host online meetings, manage actions, take meeting notes, and record activities in a repository. In one embodiment, the non-transitory computer readable storage medium 300, further causes: analyzing the execution of tasks and activities and taking decisions in real-time.

In one embodiment, the non-transitory computer readable storage medium 300, further causes: interpreting written text using the artificial intelligence engine through natural language processing. In another embodiment, the non-transitory computer readable storage medium 300, further causes: converting written text to one or more commands in a machine readable format and communicating the one or more commands to one or more agents. In one embodiment, the one or more agents comprise one or more automated robots. The one or more agents execute one or more activities, one or more tasks, and one or more events at scheduled dates and times based on the one or more commands. In one embodiment, the non-transitory computer readable storage medium 300, further causes: implementing the one or more initiatives into one or more target environments through one or more agents.

In an embodiment, the estimating models are fundamental to the Program Management Framework and intended for use in conjunction with the proposed actions for the client's annual business planning life cycle. The estimating models are not mandatory for use across all client departments (and functions), nor for all initiatives. The estimating models are useful for organizations that create guesstimating spreadsheets for every new initiative or in advance of a business planning cycle. The estimating models comprise a few variations to the Top-down and Bottom-up estimating methodologies. The underlying premise is a functional decomposition of the capabilities that is delivered as part of funded initiatives. Every function is served by reusing existing capabilities or requiring changes to the underlying application, data, and infrastructure components, as well as to various supporting services. The estimating models need to be customized to accommodate initiatives or department functions that may not intuitively translate. As an example, a variation on the model is used to estimate effort for various “LOB—Deliverables”. Effort for LOB Operations and Business Operations functions required to meet the related initiative milestones would similarly be customized.

The following discuss how the models are to be used. The models are primarily meant for use by Initiative Sponsors and their PM delegates. The total effort for an Initiative (in workdays) is used to estimate total cost for the initiative. The “Teams & Roles” for respective solution components, are aligned with the Resource Strategy captured in the IFR. “Resource Histogram” depicts the resource allocation across various roles by month.

The following are the inferences made from the models:

The resource deficits are in terms of Expertise (Specialty+Proficiency) and Capacity. The realignment or potential third-party services are executed to meet resource deficits. The scope priorities (or potential inclusion of scope items from another initiative) are based on total cost of the effort. The implementation phases and release schedule are based on priority, complexity, and utility value (MVP vis-a-vis business impact). Each implementation may have milestones.

### Definitions:

### Top-Down Estimation (Effort—Hours; Cost—$$)

1) Initiative is a collection of business propositions that are defined to meet certain objectives and achieve certain business outcomes.
2) Scope: e.g., MVP capability, MVP Phases (boundaries), Release (consider products, scenarios, data sources, data quality issues, upstream and downstream integration dependencies). MVP refers to Minimum Viable Product, as a term of art used for agile methods of project execution. Phases and Releases pertain to breaking down the total scope of effort into manageable quantum of work by a team assigned to an initiative.
3) Desired Target State: includes assessment of solution maturity (STP, Future Proof). STP refers to straight through processing of data from input through output of an entire process or a workflow, without human intervention at any step in the process or workflow. Future Proof refers to a high degree of maturity of the solution design wherein most, if not all possible future scenarios of use of the system are included in the design of the solution. The estimates will vary significantly depending on the maturing of the solution in the desired target state for the intended business outcome.
4) Solution Guiding Principles are general principles defined in advance and agreed to by all stakeholders, and on the basis of which the solution is designed. The principles function as a checklist and validation of the eventual solution that would meet (or not) the broader principles.
5) Key Activities are the essential list of activities that are typically performed by team members as part of RTB, in the furtherance of supporting the organization's roster of clients and to meet their contractual service levels with such clients.
6) Potential solution (e.g., technology) options represent a potential list of ways in which the business outcome can be met by the solution. The options are intended to provide stakeholders an opportunity to select the optimum solution that would meet their intended business objectives within the constraints of budget, resources, and similar other business factors.
7) Time to Market (Duration—months): based on estimated time frame or Target launch date (Start date is a must). The estimating model uses the duration to compute the required FTEs. As such, the time to market represents the duration for the initiative to achieve its intended outcome from start to finish.
8) Program Role: e.g., Program Manager, Workstream Lead, Product Manager, Process Owner, Business Analysts, Data Analysts, Developers (Workflow, Data Modeling, API Integration), Testing, Release Management, Production Support. Every funded initiative becomes part of a Program in the execution mode. A Program can have multiple initiatives within its structure. Every team member assigned to work on a Program is designated a role that is determined by the individual's expertise.
9) Organizational affiliation: e.g., Segment, Product, Operations, Technology, Vendor. Team members for a Program may be sourced from within the organization or hired on a temporary basis from a third party consulting organization.

### Bottom-Up Estimation (Effort—Hours; Cost—$$)

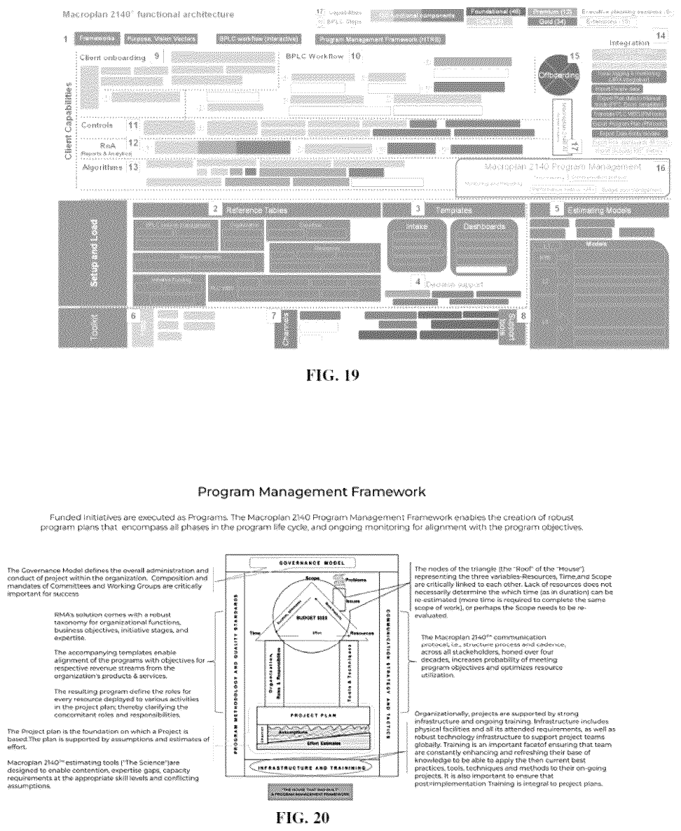

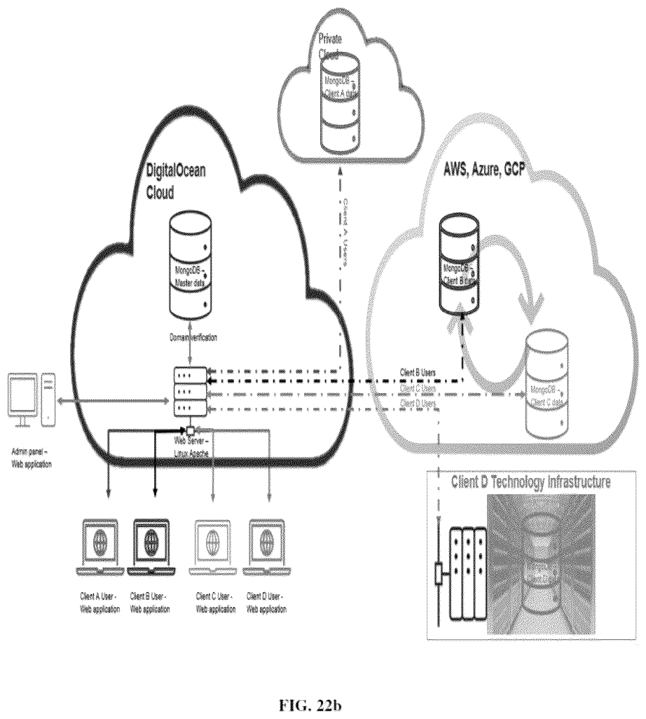

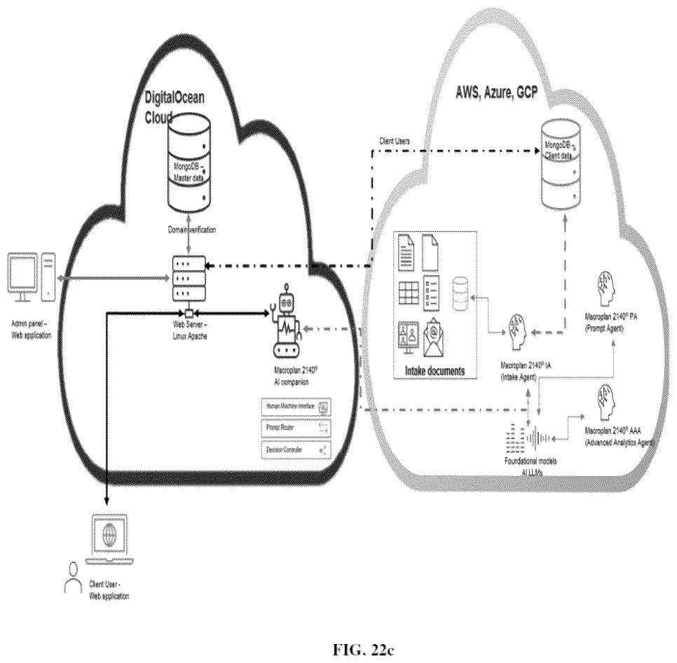

1) Initiative is a collection of business propositions that are defined to meet certain objectives and achieve certain business outcomes.
2) Scope e.g., MVP capability, MVP Phases (boundaries), Release (consider products, scenarios, data sources, data quality issues, upstream and downstream integration dependencies). MVP refers to Minimum Viable Product, as a term of art used for agile methods of project execution. Phases and Releases pertain to breaking down the total scope of effort into manageable quantum of work by a team assigned to an initiative.
3) Functional decomposition—including domain expertise needed during key implementation phases: analysis, proof of concept and user acceptance testing. FIG. 19 is an example of functional decomposition of a system or a method. It consists of a discrete set of components, each of which performs a specific function and interacts with other components for inputs or outputs. Implementation phases refer to the execution phases depicted in FIG. 14a.
4) Solution component architecture. FIG. 22a is an example of solution component architecture. It depicts the technological components that are required to perform the different system operations for every functional component.
5) Solution decomposition is an alternative term of art for solution component architecture.
6) Component level estimate of effort—including skills, technical expertise, vendor product integration, upstream and downstream integration, decommissioning, regression testing. Effort estimates for every component in the solution help refine the estimate to the next level of precision. The L3 estimating model enables team members to estimate such effort.

Top-down estimates complement Bottom-up estimates. Estimates are based on key lessons from implementing comparable initiatives within the company; viz.,
1) high burn rate during initial phases
2) under estimation of effort especially for component design and data profiling
3) dependent departmental engagement and competing priorities
4) key person bottlenecks, skills, and capacity

Estimating factors considers integration complexities, potential data quality issues and concomitant remediation efforts. Estimates need to be optimized for team ramp-up during critical phases as well as for individuals covering multiple roles during different phases of the PLC.

### Estimation Levels Used in the Estimating Model

| | Precision | Estimating method and use |
|---|---|---|
| Level 1 | Order of | T-Shirt sizing: Used for Round 1 of the client's |
| estimates | Magnitude | Initiative rationalization step in the BPLC |
| Level 2 | Conceptual | Based on functional components: Required for IFR |
| estimates | Design | approval |
| Level 3 | Baseline | Bottom-up estimates for end-to-end solution |
| estimates | | components: based on confirmed (post IFR approval) |
| | | Scope, Resources and Timing. Program Plan, |
| | | Progress Monitoring and Reporting will use this |
| | | baseline. |

### Effort Units

1 day=8 hours

$$duration 1 = [ ( End date - Start date ) / 30 ] months$$

workday (aka person day) estimates of effort=Number of days it would take One Person to complete a task or an activity. This is a first step to help determine overall staffing requirements.
FTE2=(workdays/(duration*20)) Example: A project estimated at 1,000 workdays that needs to be completed in 6 months will require 1000/(6 months*20 working days per month)=8.3 FTEs.

The high level program execution phase is shown in FIG. 14a. The testing phase is shown in FIG. 14b. At the testing phase, the system performs component (unit) testing, assembly testing, integration testing, regression testing, product testing. The above testing results are communicated for user acceptance testing. The operation readiness testing is performed by simulation. The market validation is tested and sent for client acceptance. The initiatives then finalized are deployed into a target environment by soft launch.

### Estimating Factors

1. Level 1: T-shirt sizing guidelines
   T-shirt sizing—estimation factors

| | Elapsed Time | | FTE |
|---|---|---|---|
| Size | Duration) | Effort³-hours (workdays) | count |
| Small (S) | 2-3 months | <=2,000 (250) | ~1-2 |
| Medium (M) | 3-6 months | 2,000-6,000 (250-750) | ~2-3 |
| Large (L) | 6-9 months | 6,000-10,000 (750-1,250) | ~5+ |
| Extra Large (XL) | >9 months | >10,000 (>1,250) | >5 |

2. Initiative complexity guidelines
Initiative that is either a candidate for funding, or is funded, is designated with High, Medium, or Low complexity, based on an assessment of the following factors:
   effort (hrs):>=Large T-shirt size
         $$ impact:>=+20% revenue potential (Exit <CY> ARR) and or >10% margin improvement
   inter-departmental contribution
   high value (unique) expertise
   differentiating skills (contention for the same resources)
   high barrier to entry: competitive landscape (white space, competitor density), client stickiness
   risk to sustain revenues in the local market, subject to the degree of regional or geopolitical uncertainty
3. Level 2: Conceptual Design—guidelines
The workday effort for an initiative can be estimated in multiple ways:
a. Using the Functional Component Inventory4 to estimate “Design-Build-Unit & Assembly testing” effort.
b. Using deliverables-based approach.
c. Conceptual design of technology components required to support respective functional components (could be many-to-many) and estimate effort to change or integrate those components. These estimates could help refine the workday estimate that is purely based on the Functional Component Inventory.
d. Using Testing Phases and number of test cycles to estimate the QA/Testing effort.

Estimating factors are based on:
Scope assumptions: capabilities, functions, and features for the initiative
Duration, milestone, and release assumptions
Staffing assumptions: skills & proficiency, capacity, allocation to RTB, resource contention, critical resource deficits.

The estimating models include all these options, with built-in flexibility for every team to adopt or customize any of these models using their preferred method to estimate effort and the related staffing requirements.

### Model Outputs Include

Total effort for the initiative in terms of workdays
Workday effort by department function i.e., LOB, Tech Solutions, Tech Infra, LOB Ops, BizOps, based on their respective contribution to the total effort for the Initiative
FTE count by Department, function, and functional component.

These effort estimates would be validated against
Level 1: T-shirt size estimates
Capacity-based guesstimates,

### Derivations

a. Initiative Cost

Using average resource costs by department function, the total resource cost for the Initiative can be derived.

The outputs would be inputted into the Cost section of the IFR.

b. Resource Requirements

Using the list of Expertise requirements that the Initiative Sponsor would enter in the staffing assumptions section of the model, for this Initiative:

The FTE count would be decomposed into Capacity (Resource count) by Expertise, for the duration. The count for IFR does not need to be exact.

For each Capability (i.e., group of functional components), resource requirements or assumptions are entered—both in terms of Expertise and Capacity. Teams then assess the following:
What Specialty and Proficiency do I need to fulfill the roles for that capability?
Using the capability workday estimate as a reference, how would I distribute the effort across these resource profiles?
Do I have the requisite capacity within my team to fulfill this effort?
How could I address potential resource gaps: Reassign (Right size), Hire full time resources with the requisite expertise (vis-a-vis talent strategy), Engage Third Party resources
Validate the bottom-up resource allocation estimates from the step above with the Model FTE output. Refine, as necessary.
4. IFR and Level 3 baseline
Upon concurrence with the Level 2 estimates by the Initiative Sponsor, the IFR Resource Strategy is completed as follows:
   Discrete list of Expertise required for the Initiative, with a focus on the high value expertise that are critical to success
   Count of resources within each expertise
   Color coded: Red (if gap), Amber (if contention or potential overload) or Green (if available and can be allocated)
Note: Even if Green for this Initiative, in aggregate across Initiatives (and RTB), resources may be in contention or overloaded.
Not all the systems models need to be adopted, so long as the IFR includes:
   Resource strategy: Expertise and capacity required vs gaps.
   Cost of effort, including in-house and third-party vendor resources.
For approved Initiatives, Level 3 baseline model will incorporate:
   Resource histogram, based on the duration, sequencing and resource allocations. The histogram depicts resource loads (over/under) at certain points in the Initiative.
   Capability priorities, capability release sequencing and deployment milestones
   Appropriate adjustments to scope, sequencing, or resource allocations.
The Level 3 model outputs are used to create a baseline program plan that would include WBS (workstreams, activities, tasks), timeline, deliverables7, milestones8, resources, and dependencies, by program execution phases for the capability scope.

### Run The Business (RTB)

### Definition

1. Effort and activities required to support current annual run rate plus anticipated organic growth (i.e., target Revenues and Margins) in the next year, i.e., business plan year
2. Resources that would be allocated (>=60%) for the duration or >=30 workdays per quarter, or otherwise committed to client contracts, to support current products, services, and clients, as well as Sales efforts to onboard net new clients as part of the anticipated organic growth.
3. Business continues to operate at current infrastructure performance and client service levels.

### Estimating Factors

The objective is to create a baseline inventory of resources and service levels committed to client contracts across geographic locations, as well as to estimate resources required to support anticipated organic growth. Factors used to estimate resource commitments:
Key activities by department
Resources required for the activities or to meet the service level
Units of effort per quarter—Projected performance target (% per quarter)
Utilization alerts (Over/Under utilization)—Mitigation options and lead time to mitigate Guidance
Roll-up the RTB activities within each Department to a vital few, say 5 Key Activities and the Resource Bands to 3, per department
By department, what do these activities contribute to vis-a-vis RTB goals?
Which activities consume the bulk of the resource capacity? Use this information to validate reasonableness, or
   assess which technology component or client related activity requires this concentrated effort and try to optimize the effort for the activities, where possible
What is the resource utilization by Band? Use this information to assess opportunities to
   free up high expertise resources to higher value outcomes,
   realign resources to appropriate activities or
   list resource deficits.

### Estimating Factors Used in the IFRs:

### Globally Configured Values

Print tables of <L2a estimating factors> and <L2a estimating guidelines> from the BPC
Print tables of <L2b estimating factors> and <L2b estimating guidelines> from the BPC Note: Sponsors can customize estimating factors for specific IFRs, available online.

### Program Plans

Through various rounds of rationalizing CTB initiatives, clarification of business objectives and funding priorities during the BPLC, some of the initiatives will emerge with high probability of being funded. RTB and CTB initiatives would be structured as Programs.
Level 3 estimates for CTB initiatives and RTB resource commitments provide the basis to develop a strawman program plan.
Upon confirmation of the RTB budget, initiative funding and approval for the resource strategy, the strawman plans will evolve into a baseline program plans
Multiple related initiatives can be governed under the structure of one Program.

### WBS Translation

The system comprises robust methods that enable seamless transition from estimation to program planning. The system also provides for translation of work breakdown structure to bespoke methodologies or nomenclature used in vendor project management solutions.

### EXAMPLE

| monday.com | Present system |
|---|---|
| Workspace | Program Manager |
| Board Group | Program |
| Board | Initiative |
| Task Group | Workstreams or Phases |
| Task | Activities |
| Sub-Item | Tasks |

In an embodiment, the processor estimates resource strategy using an estimating model in IFR screen as follows:
1. Top header
   a. Model Estimates
      i. FTE count=FTE from table F of L1a OR sum of FTE counts of L2b OR sum of FTE counts of custom model (Show tooltip—“FTE count”)
      ii. Effort=Workdays from table F of L1a OR sum of efforts of L2b OR sum of efforts of custom model (Show tooltip—“Effort workdays”)
   b. Redistribution
      i. FTE count=Sum of required resource count in table below (Show tooltip—“FTE count”). To clarify, the FTE count for each Department is either a) loaded from the Model, or b) calculated as Total effort for the Department/workdays per work year)]
      ii. Effort=Sum of effort in table below (Show tooltip—“Effort workdays”)
   c. Variance
      i. FTE count=Redistribution FTE−Model FTE (Show tooltip—“FTE count”)
      ii. Effort=Redistribution Effort−Model Effort (Show tooltip—“Effort workdays”)
      iii. Show in Red if negative, Green if matches, Amber if positive.
   d. Staffing Assumptions
      i. Opens popup Staffing Assumptions
   e. Resource Deficit
      i. Opens popup Resource Deficit
   f. Recalculate
      i. Recalculate Gap values across all IFRs.
      ii. Tooltip=“Recalculate resource deficit”
   g. Estimating Models
      i. L2a: Tooltip—“Open L2a estimating model”. (Opens L2a Estimating Model)
      ii. L2b: Tooltip—“Open L2b estimating model”. (Opens L2b Estimating Model)
      iii. CM: Tooltip—“Upload custom model”. (Opens Custom Model)
      iv. Show finalized model in highlighted color (Gold letters bolded; Dark blue background) and add tooltip “Redistribute FTEs and effort for <Version #> of <L2a, L2b, Custom> model.”
      v. Triangulation: Tooltip—“Triangulation: Compare effort estimates across models and versions”. (Opens popup Triangulation)
2. Department accordion row (default—collapsed view)
   a. Effort=Department Effort from table C of L1a OR sum of efforts of L2b OR sum of efforts of user model
   b. FTE count=
      i. From L2a, Sum of FTEs for the Department
      ii. From L2b, Sum of FTEs for the Department
      iii. From Custom model, FTE count for the Department
   c. Duration (months)=Max (duration for that department)

$$Gap = [ Available staff count for the Department from \\ People table ] - [ Sum of Redistributed Required FTE count for \\ that Department ] - [ Required FTE count for that Department \\ in all other IFRs ] - [ Department resources allocted to RTB ]$$

$$d .$$

Tooltip—“Gap calculated across all IFRs and RTB allocation.”
3. Function data row
   a. Effort=Required*duration*workdays per month
   b. Gap (system); Tooltip—“Gap calculated by the system, across all IFRs.”
      i. [Available staff count for the (Department, Function, Specialty, and Proficiency) from People table]−[Required FTE count entered on that row]−[Required FTE count for that combination in all other IFRs]
      ii. If either Function or Proficiency or both are not entered, aggregate available count from the People table for that grouping.
      iii. Use the same grouping when pulling the sum of Required FTEs across all other IFRs.
   c. When a new row is added: Pre-populate remaining effort and FTE count for that Department.
   If the user entered values results in excess department effort beyond the BPC tolerance, show the recalculated value in red color with tooltip ‘Effort distribution exceeds model value estimated for the department. Suggest adjusting model estimates or redistribution with other functions, if possible”.
   If the user entered values results in reduced effort by the BPC tolerance, show the recalculated value in yellow color with tooltip ‘Effort distribution is less than model value estimated for the department. Suggest adjusting model estimates or redistribution with other functions, if possible”.
   Accept user input, even if value is not changed after the alert.
   e.g., Model effort estimate for Business Operations=160 workdays. >BPC>Tolerance=10%. This means, alert is generated when there is a variance in the department level effort from the model calculation by 10% (i.e., 16 workdays). So, an alert will be generated if the calculated department level effort is <144 or >176. >Row 1>Function #1>Pre-populate Effort=160 workdays. >Row 1>Function #1>User enters Required resource count and duration>Calculated effort=120 workdays. This is below the tolerance, so generate a Yellow alert. >Row 2>Function #2>Pre-populate Effort=40 workdays (remaining effort=160−140) Scenario A>Row 2>Function #2>User enters Required resource count and duration>Calculated effort=50 workdays. The total effort for the Department=120+50=170 workdays. This is within the tolerance set. So, no alert. Scenario B>Row 2>Function #2>User enters Required resource count and duration>Calculated effort=60 workdays. The total effort for the Department=120+60=180 workdays. This exceeds the tolerance, so generate a Red alert.

### Staffing Assumptions

1. Text area for each field and save

### Resource Deficit

1. Display IFR Id and Name. Display FTE count required for this IFR, in the header.
2. as confirmed with client on 31 March 2023 have to use this for FTE count required=[(gap*duration)+(gap*duration)+ . . . ]*(FTE: workdays/month from BPC))/(workdays/work year from BPC)>>>Required FTE count=Use the exact same component (and calculation method) that is used to compute the Required FTE count in EPS #5
3. Display all Department, function, specialty, proficiency available in people data+used in all IFRs
   >>> Display Department wise resource allocation across IFRs and highlight resource deficits by Department, Function and Proficiency
   >>> Resource is connected to band. >>> Specialty and Proficiency values (up to 5) are also imported from People data. Ref. Columns O-X in the “People (test data)” tab
   >>> There is no mapping of resources to function and specialties >>> Every resource also has Specialty as noted in above. Map the Specialties to the Functions in the Department.
   >>> Depending on the row data entered, anchor the search in the People table on one of the following: (a) Specialty+Proficiency, if both entered; (b) Proficiency only, if Specialty is blank (c) All Specialties associated with the Function in the Organization Reference Table, if both Specialty and Proficiency are blank.
4. Table Values
   a. Available=Available staff count from People data
      >>> Available staff count from People data=Sum of staff count for the Specialty and or Proficiency in that Department.
b. Required for IFR Id=Total FTE count for that row from this IFR. =>as confirmed with client on 31-march-2023 have to use this formula for this Required for IFR Id=([(required*duration)+(required*duration)+ . . . ]*(FTE: workdays/month from BPC))/(workdays/work year from BPC)
   c. Required for all other IFRs=Sum of IFR row data for given parameters (all IFRs, except this current IFR)=>using this formula=([(required*duration)+(required*duration)+ . . . ]*(FTE: workdays/month from BPC))/(workdays/work year from BPC)
   d. Allocated to RTB=RTB count for given parameters
      >>> If Proficiency is selected as a filter, shade the row counts gray (or hide those cells, if possible), for “Allocated to RTB”. Display the ‘Total’ RTB allocation and include in the aggregate calculation in the row for ‘Total’.
e. Deficit=Available−Required for IFR Id−Required for all other IFRs−Allocated to RTB
5. Table working
   a. When the table is loaded.
      i. No. of rows are the same as no. of rows in IFR.
      ii. there are no buttons on the top. Proficiency column has x mark.
   b. When the user clicks on x mark of Proficiency, the column disappears. Button ‘Proficiency +’ gets added on the top. Add tooltip “Aggregate by Proficiencies” Column Specialty has x mark. Data is aggregated on Specialty.
   c. When the user clicks on x mark of Specialty, the column disappears. Button ‘Specialty +’ replaces the previous button added on the top. Add tooltip “Aggregate by Specialties”. Column Function has x mark. Data is shown aggregated on Function.
   d. When the user clicks on x mark of Function, the column disappears. Button ‘Function +’ replaces the previous button on the top. Add tooltip “Aggregate by Department functions” Data is shown aggregated by Department.
   e. When the user clicks on ‘Function+’, column Function gets added in the table after department. Column Function has x mark. Button ‘Specialty +’ replaces the previous button added on the top. Data is shown aggregated on Function.

### Cost Panel

### L2a Estimating Model

1. Versions
   a. On page load show button “Version 1” as clicked. Show an empty table below.
   b. On saving the first row of the table, show the button “Version 2+”. Show total efforts as the sum of efforts added as we add the rows. Show the same efforts below “Version 1”.
   c. On clicking the arrow on the right side of the screen, a panel opens showing a detailed calculation screen. Tooltips: a) for the arrow>“Open detail worksheets b) a) for the arrow<“Hide detail worksheets. For each version, a separate panel will open for the calculation of a specific version.
   d. On clicking the button “Version 2+”, change Label from “Version 2+” to “Version 2” and copy the entire table of “Version 1” to “Version 2” including a detailed calculation screen. Display the efforts below “Version 1”. Enable “Version 3+”. Show “Version 2” as clicked.
   e. On clicking the “Finalize” button, it will mark the open version as finalized. It will overwrite the finalized flag of any other version from L2a, L2b, Custom Model; which was earlier marked as finalized. At any given time, there will be a maximum of one finalized version across all estimating models. Finalized version will be highlighted.
   f. Until the user clicks on the “Finalize” button, following estimates will be treated as deemed finalized.
      i. If a Custom Model is present, it is treated as finalized.
      ii. If the Custom Model is absent, the highest version of L2b will be treated as finalized.
      iii. If L2b is absent, the highest version of L2a will be treated as finalized.
2. Estimating factors
   a. Show data from BPC in editable mode.
   b. Users can only change values of workdays and save.
   c. Saved data will be used for computation in the selected initiative.
3. Table
   a. Show BP names associated with initiative in BP dropdown. On selection of BP name in the drop down, populate BP#.
   b. Priority, Complexity and Proposed Release dropdown values will be populated from respective masters.
   c. Estimate field will be populated on selection of complexity, based on set up in the header multiplied by factor multiplier.
   d. If the estimated value falls below min of L2a estimating guidelines defined in BPC, show the value in yellow color with tooltip ‘Effort for this component is low. Suggest combining this effort with another component, if possible”. Accept user input, even if value is not changed after the alert.
   e. If the estimated value falls above max of L2a estimating guidelines defined in BPC, show the value in red color with tooltip ‘Effort for this component is high. Suggest splitting this effort into multiple components, if possible.” Accept user input, even if value is not changed after the alert.

### L2a Estimating Model—Detailed Screen

1. Table A—Development milestones
   a. Show Sponsoring department and efforts from functional decomposition model (E.g., 650)
   b. Table will have an auto populated list of all departments except the sponsoring department.
   c. Efforts=% * Efforts of sponsoring department (650*10%=65) Add tooltip>‘Enter the contribution from other departments to the development milestones, as a percentage of the effort from the Sponsoring department. The system will compute the estimated workday Effort. A department's contribution can be more than 100% of the Sponsoring department's effort.’
   d. Development milestone efforts=Efforts of sponsoring department+Sum of efforts of other departments (650+130=780) Add tooltip>‘Effort in workdays’
2. Table B—Testing and Deployment milestones
   a. Effort =Sum of efforts of all testing phases (300)
   b. Test phase dropdown has values from Testing phase master where ‘Phase Type=Testing’ Do not allow duplicates for Phase. Hide the selected Phase if that row exists, from the drop down selection.
   c. Total efforts=Count*FTE*Duration (1*2*30=60) Add tooltip for Count>‘Enter the number of test cycles in this phase, or the number of iterations of this phase’.
3. Total Efforts—Dev, testing deployment=Development milestone efforts+testing efforts (780+300=1080)
4. Table C—Distribution Provide guidance button next to table header label
   a. Pre-populated list of departments and phases from master.
   b. Pre-populate the duration for Testing phase, from Table B=sum(duration) of all phases, where Phase type=‘Testing’. Value cannot be edited in Table C. (Values can only be edited in Table B).
   c. Pre-populate the duration for Deploy phase, from Table B=sum(duration) of all phases, where Phase type=‘Deploy’. Value cannot be edited in Table C. (Values can only be edited in Table B).
   d. Effort=%*Total Efforts
   e. Sum of values at the right bottom of table—Show green if 100%, yellow less than 100%, red above 100%. Hard stop if not=100%. Error message . . . “Distribute the total effort to equal 100%.
5. Table D—release schedule
   a. Release and Priority from respective master releases and release priorities.
   > Use sentence case for the section label>‘Release schedule, staffing and effort.’
   > Pre-populate the Effort, Duration and FTE count for aggregate of Release and Priority from L2a estimating model (main) worksheet.
   >> For each Release and Priority group across departments,
      Start Date=min(Start date) from BPs in that group.
      Use the first day of the quarter (from field ‘Preferred start date’) as the start date.
      Target Date=max (Target date) from BPs in that group.
      Use the last day of the quarter (from field ‘Target completion of viable capability’) and the target date.
      Effort=sum total the effort (workdays)
   >> From Table A of the detailed worksheet,
      Distribute the effort from ‘Other Departments’ in the same proportions as for the Release and Priority.
      e.g., For INIT020, the total effort for Business Operations=210 workdays, of which
      Release 1 P1 effort=160 workdays, which is=76.2% and
      Release 1 P2 effort=23.8%.
      The total effort for ‘Other Departments’=315 workdays. Therefore, distribute the effort from other departments as follows:
      Release 1 P1 effort=0.762*315=240 workdays
      Release 1 P2 effort=315−240=75 workdays
   Add these efforts to the respective Release and Priority rows in Table D.
   From the above example, for INIT020, the total effort (Development milestones) of 525 workdays will be distributed as follows:

$$Release 1 P 1 = 160 + 240 = 400 workdays$$

$$Release 1 P 2 = 50 + 75 = 125 workdays$$

>> From Table B of the detailed worksheet,
   Distribute the effort from Testing and Deployment phases in the same proportions as for the Release and Priority.
   e.g., For INIT020, the total effort for Business Operations=210 workdays, of which
   Release 1 P1 effort=160 workdays, which is=76.2% and
   Release 1 P2 effort=23.8%.
   The total effort for ‘Testing and Deployment milestones’=1,008 workdays. Therefore, distribute the effort from other departments as follows:

$$Release 1 P 1 effort = 0.762 * 1008 = 768 workdays$$

$$Release 1 P 2 effort = 1008 - 768 = 240 workdays$$

Add these efforts to the respective Release and Priority rows in Table D.
   From the above example, for INIT020, the total Development effort of 525 workdays AND total Testing and Deployment effort of 1,008 days will be distributed as follows:

$$Release 1 P 1 = 160 + 240 + 768 = 1 , 168 workdays$$

$$Release 1 P 2 = 50 + 75 + 240 = 365 workdays$$

>> The above values should be recalculated every time a row is edited or added in the L2a estimating model (main) worksheet, or in Table A and Table B of the detailed worksheet.
   b. Duration=(target date−start date)/(days per month from BPC) (precision=2 decimal places) . . . Note: (target date−start date) will return value in “number of days” between the two dates; therefore, divide that result by the BPC parameter.
   c. Effort=sum of efforts from functional decomposition model for given release and given priority . . . . As calculated in 5a above

$$FTE = Effort / ( Duration * workdays per month )$$

$$d .$$

6. Table E—Target Deployment
   a. Release and Priority are multi-select. Only the values added in table D should be available in drop down.
   b. Pre-populated list of deployment milestones from testing phases where ‘Phase type=Deploy
7. Table F—output
   a. Hardcoded row names . . . Add new row ‘Deployment milestones’.
   b. Development FTE=(Sum of FTE of table D) Total FTEs from Table C—Total FTEs from Table B.
   c. Testing FTE=Sum of FTE in table B, where Phase type=‘Testing’
   d. Deployment FTE=Sum of FTE in Table B, where Phase type=‘Deploy’
   e. Development workdays=Development milestone efforts in table A
   f. Testing workdays=Sum of efforts in table B, where Phase type=‘Testing’
   g. Deployment workdays=Sum of Total effort in Table B, where Phase type=‘Deploy’

### L2b Estimating Model

1. Versions—Same concept as L2a
2. Estimation factor—Same concept as L2a
3. Table header
   a. Add target date/ planned start date editable.

$$Calculate Duration = target date - planned start date ( in months )$$

$$b .$$

c. Total efforts is the sum of efforts in the table.
   d. Validate: Tooltip—“Model values checked against guidelines configured in BPC”. (Opens L2b Estimating Model—Compare with estimating guidelines)
   e. Refresh: Tooltip—“Switch grouping dimensions”. Swap the view from Phase→Department to Department→Phase. Change all the values accordingly.
4. Table
   a. Pre-populate rows from the Deliverable grid.
   b. Effort field will be populated on selection of effort size, based on set up in the header multiplied by factor multiplier.

$$FTE = Effort / [ ( ( target date - planned start date ) / ( days per month ) ) * workdays per month ]$$

$$c .$$

d. Add button to be used for adding new deliverable in table and in Deliverable master.
   e. Target date>=Planned Start date
   f. All dates should be between two dates entered at header level.

### L2b Estimating Model—Compare with Estimating Guidelines

1. Pre-populate phases
2. Guidelines values from L2b estimating guidelines defined in BPC

$$Estimated duration \% = ( Estimated duration for a phase / overall duration ) * 100.$$

$$3.$$

Highlight Amber if estimated values are less than the guidelines. Highlight Red if estimated values are more than the guidelines. Let us discuss adding Tolerance to each estimating model. These color codes will be useful only when the variances are materially different (up or down).

$$Estimated effort \% = ( Estimated efforts for a phase / overall effort ) * 100.$$

$$4.$$

Highlight Amber if estimated values are less than the guidelines. Highlight Red if estimated values are more than the guidelines. Let us discuss adding Tolerance to each estimating model. These color codes will be useful only when the variances are materially different (up or down).

### Custom Model

1. Upload button—Will upload data from excel file and will display in the table
2. Finalize button will make this model as final
3. Excel template—Department will be a dropdown with all values

### Triangulation

1. Show values from respective models. Default view is Summary data; Department values collapsed.
2. % Tolerance copied from BPC and editable.
3. Highlight finalized model.
4. Highlight material variance where “value>finalized value*(1+% tolerance)” OR “value<finalized value*(1−% tolerance)”
5. L1 model
   a. Calculate L1 effort for each BP, as mean of (L1−Min and L1−Max) effort hours for the respective T-shirt size, and convert into workday effort as: [(L1 Min+Sum of L1 Max)/2]/(hours per day from BPC)
   b. Calculate L1 FTE for each BP, as mean of FTE count for the respective T-shirt size: (L1 Min FTE+L1 Max FTE)/2*
   c. Display L1 Effort=Sum of L1 effort as computed in a. above, across all BPs in the IFR
   d. Display :L1 FTE=Sum of L1 FTEs as computed in b. above, across all BPs in the IFR.
   e. It will not have department level data.

### RTB Changes

1. Table header
   a. Tooltip: “Effort by Quarter”=Sum of hours in table/(BPC parameter Hours/Day)
   b. Tooltip: “Annual workday effort”=Effort by Quarter*4
   c. Tooltip: “FTE count”=Annual workday effort/BPC parameter workdays per work year)
   d. Refresh: Tooltip—“Switch grouping dimensions”. Swap the view from Department→Key activities to Key activities→Department to. Change all the values accordingly.
2. Table
   a. Add Functions before Specialties (it would be optional field)
   b. Tooltip for Time: “Lead time (in weeks) to mitigate the utilization issue.”
   c. Accordion layout for Department and Key activity (depending on refresh view)
   d. Department tooltip: “Allocate Department resources to Key Activities across Functions and Specialties.”
   e. Key activity tooltip: “Key Activity to support RTB.”
   f. Department and Key activity level header (depending on refresh view)
      i. Tooltip: “Effort by Quarter”=Sum of hours for department/(BPC parameter Hours/Day)
      ii. Tooltip: “Annual workday effort”=Effort by Quarter*4
      iii. Tooltip: “FTE count”=Annual workday effort/BPC parameter workdays per work year)
   g. Remove existing Department dropdown.
   h. Move Workstream lead to department level header (Change dropdown list to executive management+initiative sponsor).
   i. Move resource deficit button to department level
   1. BPC:
      a. Add L2a Estimating Guidelines
      b. Add field Tolerance %
   2. Testing Phases: Add a column ‘Phase type’ to select values from (Build, Testing, Deployment)
   3. Releases: Add another table on the same screen as ‘Release Priorities’ (It will have only column ‘Priority’—alphanumeric)
   4. RTB changes as defined in section RTB changes
   5. IFR Resource Strategy tab as defined in the section IFR Screen—Resource Strategy
   6. IFR Version management:
      a. When a new version of IFR is created, it will copy all the L2a, L2b, Custom Model created for earlier versions to the new version.
      b. While creating the new version show the differences of six fields with the previous version—Model FTE, Model estimates, Redistribution FTE, Redistribution estimates, Variance FTE, Variance estimates.

As an example, FIG. 4 illustrates a user interface view rendering business propositions and initiatives, according to one or more embodiments. The processor renders the business propositions on the dashboard of the users. The processor further lists the business propositions by departments and by status. The processor also renders the initiatives on the dashboard of the users. The processor further lists the initiatives by departments and by status. The processor through the user interface enables the users to list the business propositions and the initiatives through different filters (e.g., departments, geographics, market affiliations, etc.). The processor through the user interface further renders approval actions that are pending, rejected, or approved. The processor may receive the approval from the stakeholders and the sponsors for validating the business propositions (BPs) and initiatives. The user interface view further renders issues with the BPs and initiatives and the associated description. The user interface view further renders decisions that are undertaken by the system. The user interface view further renders ratings associated with the BPs and the initiatives such as BP socialization, IFR socialization, BP realignment, RTB allocation, etc.

As an example, FIG. 5 illustrates business propositions, according to one or more embodiments. In one embodiment, the processor is operable to receive the information from at least one of one or more users and one or more agents. The information comprises at least one of resource information, budget information, and scope information. The information may comprise at least previous state, deficiencies and hurdles, constraints, opportunities for improvement, business propositions (BP) target state, major business impact, vision alignment, objectives, etc. as shown in FIG. 5. The processor creates the business propositions based on the information. The business propositions comprise project plans, assumptions, and effort estimates, etc. The previous state may comprise a predefined state (for example state A).

The deficiencies and hurdles refer to the gaps in current capabilities that would be addressed through the BP. The constraints refers to factors that cause the capability gaps or otherwise prevent the stated issues to be conclusively resolved. The opportunities for improvement refers to factors that the organization should execute and/or overcome to achieve or exceed the goals (e.g., align cross functional initiatives and priorities across lines of business and departments). The BP target state refers to the state that the organization is planning to achieve in the current financial year. The information may also comprise vision alignment and business objectives. The processor creates the business propositions based on the information.

As an example, FIG. 6 illustrates grouping business propositions and creating initiatives, according to one or more embodiments. The processor renders the one or more business propositions on the dashboard of the users. The processor identifies the one or more business propositions that are similar in interests, industry, field, budget, etc. The processor groups the business propositions identified and creates the initiatives. The initiatives refers to the next stage of the business propositions that has been shortlisted and sent for seeking funding. The processor creates the one or more initiatives for one or more categories (e.g., demographics, market affiliations, departments, etc.).

In an embodiment, the processor enables the users to view and analyze the business propositions through the user interface. The processor, through the user interface, further enables the users to identify the similar ones and group them to create the one or more initiatives. The initiatives may be created based on the objectives. The processor, through the user interface, further enables the users to select and drag the identified business propositions to group and create the one or more initiatives. In one embodiment, the processor identifies the business propositions and recommends to the users by highlighting the identified business propositions and further enables the users to select and/or deselect the business propositions as per his/her objectives.

As an example, FIG. 7 illustrates user interface view rendering initiatives, according to one or more embodiments. The processor renders the initiatives on the dashboard of the users through the user interface. The processor enables the one or more users to view and analyze the one or more business propositions of each initiative (example as shown in FIG. 7). For example, the initiative “enhance client experience” comprises the one or more business propositions (for example, client self-service, and enhance client capabilities) as shown. The initiative “enhance client experience” is assigned with an ID (for example, INIT010). The initiative “enhance client experience” is created with the business propositions “client self-service,” and “enhance client capabilities.” The processor, through the user interface, depicts the business propositions grouped under the initiative upon clicking the respective initiative. The user interface further depicts details of the business propositions associated with the respective initiative. The details comprise at least one of primary objectives, effort estimates (L1 estimate, L2 estimate, etc.), working hours range (referred to as T-shirt size), target completion, and expertise gaps and conflicts. The processor computes the effort estimates through the one or more estimating models.

As an example, FIG. 8 illustrates initiative funding request (IFR) inbox, according to one or more embodiments. The processor communicates the initiatives for funding once the initiatives are created and finalized. The processor upon creating the initiatives communicates to the users (stakeholders, sponsors) for validation. The processor may receive feedback from the users. The processor then may update the initiatives based on the feedback. The processor may also receive approval or rejection from the users. The processor then communicates the initiatives for funding when the initiatives are validated (i.e., approved).

The processor may depict the initiatives (that are validated) under the “IFR inbox” tab through the user interface. The processor, through the user interface, depicts the initiatives when the users click on the “IFR inbox”. The processor then depicts the initiatives and their associated details. The details comprise department, function, specialty, proficiency, and required proficiency, duration, and expertise gaps. The details may also comprise information such as approval or rejection information as provided by the users. The details may enable the sponsors to decide on the funding of the initiatives. The processor may also render the cost information for the initiatives. The processor further enables the users to view the cost for a particular time period (e.g., quarter, full financial year, etc.)

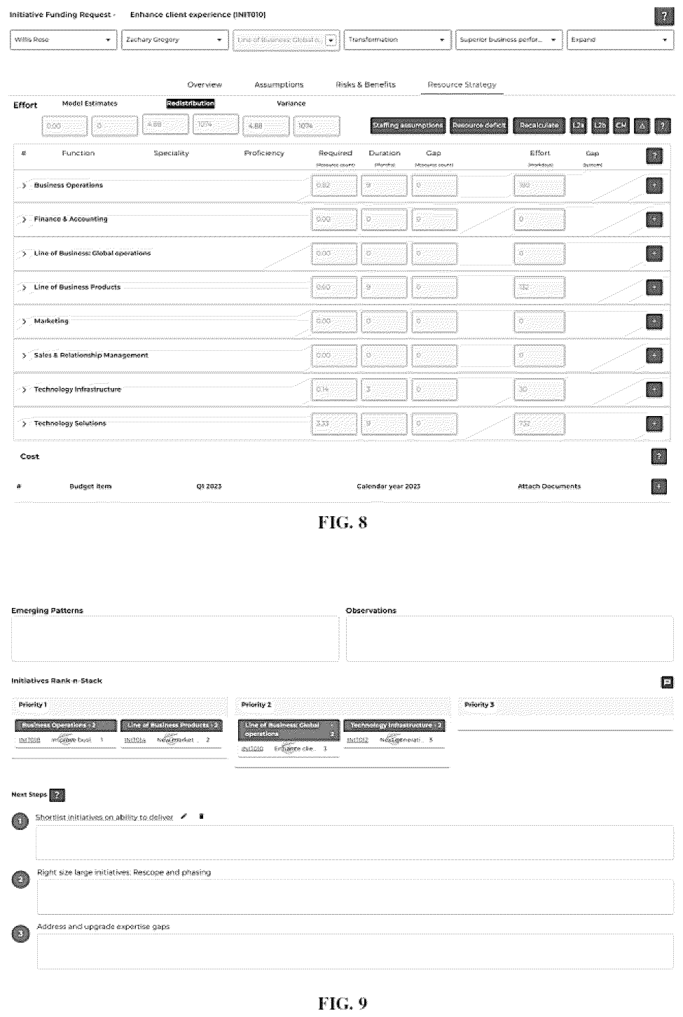

As an example, FIG. 9 illustrates priorities for initiatives, according to one or more embodiments. The processor using the artificial intelligence engine analyzes the one or more initiatives and assigns the priority for the initiatives. In an embodiment, the processor may assign the priority and recommend the initiatives based on priority. The processor may assign the priority based on at least one of budget, resource, and scope of the initiatives. The processor may enable the user to provide funding based on the priority assigned.

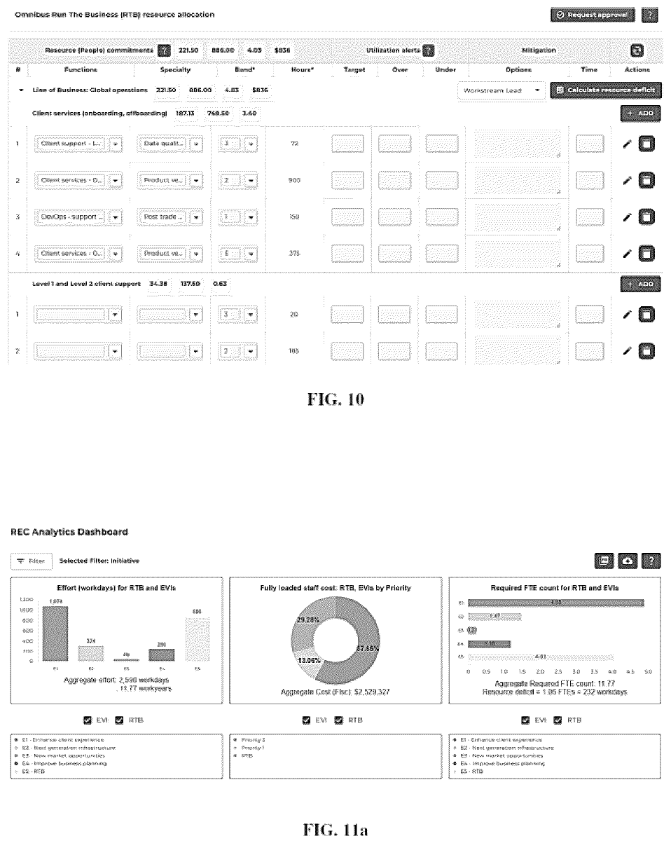

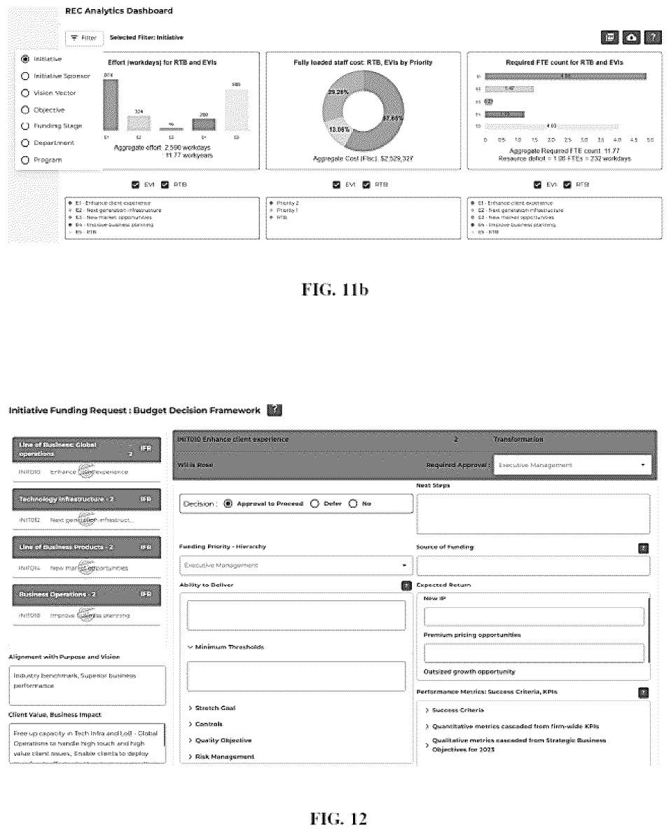

As an example, FIG. 10 illustrates user interface view for Run The Business (RTB) resource allocation, according to one or more embodiments. The term “RTB” refers to Run the Business comprising key activities required to provide support to the existing roster of clients. The processor enables the users for resource allocation through the user interface. The processor depicts the details associated with the key activities by people from respective departments within the organization. For example, for the department titled “Line of Business: Global Operations”, the processor, through the user interface, depicts the details such as Key activities, Specialty, Band, Hours, Target, Over, Under, Options, Load, Actions, etc.

The processor enables the user to select the appropriate fields and perform the resource allocation. The resource allocation may be adapted for deployment of the department resources into the target environment. The processor may also depict the details regarding the configuration of the target environment. The RTB resource allocation enables the users to allocate resources and efficiently achieve the goals.

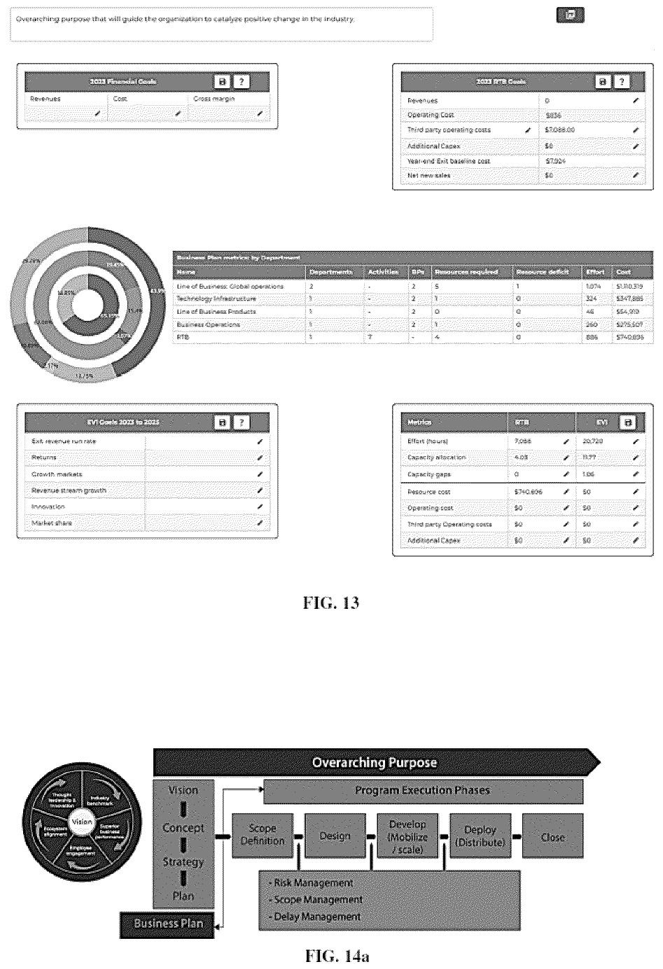

As an example, FIG. 11a and FIG. 11b illustrate Resource, Effort, Cost (REC) analytics dashboard, according to one or more embodiments. The term “REC analytics dashboard” refers to Resource, Effort and Cost analytics dashboard. The term “Resource” refers to Full Time Equivalent (FTE) resource hours committed to an activity, which is annualized using workdays per work-year (configured) for the organization. The term “Resource” does not necessarily (but it could) represent the staffing required for each expertise at the expected proficiency, for the duration of an Initiative. The term “Effort” refers to workdays. The term “Effort” further refers to aggregate hours, converted into workday units, committed to various activities to run the business and initiatives for the plan year. The term “cost” refers to Full loaded staff costs (FLSC). The term “cost” further refers to cost per employee, aggregated for the respective dimension, consisting of gross compensation, benefits, and incentives. Other costs such as third-party vendor costs, and infrastructure costs are not included in this calculation. The term “EVI” refers to Enterprise Value Initiatives (EVI) comprising all the initiatives, not including RTB, requiring commitment of resources.

The user interface view shown in FIG. 11a and FIG. 11b comprises three panels on this dashboard. The three panels comprise: Effort (workdays) for RTB and EVI, Fully loaded staff cost, and Required FTE count for RTB and EVIs. The three panels comprise graphical representation of the respective data.

The user interface view displays the number of departments and BPs within an Initiative; or displays the number of departments and key activities for RTB upon hovering the first panel “Effort (workdays) for RTB and EVI”. The user interface view navigates to the Initiative or to the RTB screen upon clicking through the first panel. The user interface view renders Option to view either RTB or EVI or company aggregate values upon choosing the “filter” icon.

Similarly, the user interface view displays the number of departments and BPs within an Initiative; or displays the number of departments and key activities for RTB upon hovering the second panel “Fully loaded staff cost”. The user interface view navigates to the Initiative or to the RTB screen upon clicking through the second panel. The user interface view renders Option to view either RTB or EVI or company aggregate values upon choosing the “filter” icon.

The user interface view displays resource deficit by proficiency for EVIs; and displays resource deficit by band for RTB upon hovering the third panel “Required FTE count for RTB and EVIs”. The user interface view navigates to the Initiative or to the RTB screen upon clicking through the third panel. The user interface view renders Option to view either RTB or EVI or company aggregate values upon choosing the “filter” icon.

The processor computes the REC values by department, function, specialty. The processor computes the REC values by proficiency, for IFRs and by band for RTBs. The processor computes the effort (workdays).

Effort (workdays)=IFR effort from the model that is tagged as Final.

$$Redistribution > Sum of ( Resource count * Duration ) * workdays per month ( from BPC )$$

$$Sum of ( Quarterly hours * 4 ) / hours per day ( from BPC ) \qquad 2 )$$

The cost referred to herein may be the fully loaded staff cost. The processor may compute the resources as one of available, required, and deficit.

As an example, FIG. 12 illustrates a budget decision framework, according to one or more embodiments. The user interface view shown in FIG. 12 depicts the budget decision framework that enables the users to decide on the initiatives that meet their business objectives. The user interface view depicts the initiatives that are validated and sent for initiative funding requests. The user interface view further depicts details regarding alignment with purpose and vision. The user interface view further depicts details regarding client value and business impact. The user interface view further depicts funding priority-hierarchy. The user interface view further enables users to either provide “approval to proceed” or “defer” or provide “no” approval. The user interface view further enables users to select the source of funding upon providing his/her decision to the funding request.

As an example, FIG. 13 illustrates a business plan rendered on a dashboard upon finalizing the initiatives funding requests, according to one or more embodiments. The user interface view depicts the business plan metrics based on the fund request approved and budget decision. The user interface view lists out the initiative funding requests (IFRs) approved. The user interface view tabulates the IFRs against benefits, KPI, resources required, resources deficit, effort, and cost. The processor, through the user interface view, lists out the metrics against RTB and EVIs. The processor, through the user interface view, further enables the users to adjust the goals for EVIs for the upcoming financial years.

As an example, FIGS. 14a and 14b illustrate a structure and classification of components of the business planning method and workflow, according to one or more embodiments. The system comprises a business plan creation phase and program execution phase. The system comprises a processor and a memory. The processor receives information from the users and/or the agents. The processor creates the business plan based on the information. The information may comprise contents related to vision, concept, strategy, and plan. The processor creates the business plan based on the information at the program execution phase.

The processor generates the scope based on the information received. The processor then designs or creates the business propositions and business initiatives. The processor also scales the business propositions and the initiatives based on the feedback from the users. The processor also validates the business propositions and the initiatives once approved by the users. The processor further deploys the initiatives into the target environment. The processor then monitors the tasks and activities of the initiatives deployed and determines a deficit score. The processor may perform risk management, scope management and delay management based on the deficit score at appropriate stages. The processor monitors the program execution and communicates the feedback information. The processor updates the business proposition and the initiatives based on the feedback information at the program execution phase.

FIG. 14b depicts the 10 steps in the business planning life cycle. Stakeholders have the option to follow all the steps or skip some of the steps in order to accelerate the planning time frame. The ten steps are identified by the numbered boxes in FIG. 14b.

The first is Definition and Setup. In this step, the organization enhances their business planning taxonomy, process, and methods. The decision to adopt the new planning paradigm is accomplished in the first executive planning session (EPS #1), during which the new paradigm is introduced to all the stakeholders by the decision maker. Upon agreement, the planning cycle moves to Step 2, Request BPs, during which stakeholders canvass for business propositions from senior executives, business line leaders and operation leaders across geographies. These business propositions are then defined and set up concurrently by all approved users of the system. As part of the third step, Convert In-flight Initiatives, the processor may create BPs from in-flight initiatives based on the definition and set up (e.g., information received). In the fourth step, Compile Candidate Initiatives, the processor then may compile candidate initiatives from one or many BPs. In step five, Compile RTB budget, stakeholders are requested to enter RTB estimates, based on which the processor then may compile the RTB budget. The system allows steps two, three, four and five to be conducted concurrently. During this time, the second execution planning session (EPS #2) is conducted; its main objective is to facilitate cross functional collaboration across the organization, in order to rationalize BPs between various initiatives. The output of this session is to confirm a list of viable initiatives for the plan year. Upon completing all the action items from EPS #2, the third executive planning session (EPS #3) is conducted, as a cross functional collaboration to rationalize initiatives. A key action item and outcome of EPS #3 is for stakeholders to agree to a short list of initiatives that would be sent for initiative funding requests (IFRs), where the users may be able to estimate, view, analyze, and assign funding requirements. In step six, Prepare IFRs, stakeholders use the estimating models and the processor to prepare additional information required for the IFR to be completed. During the fourth executive planning session (EPS #4), decision makers and senior executives may collaborate to review the inventory of initiatives and RTB commitments in aggregate. The outcome of this session is to confirm the aggregate list of initiatives and RTB for alignment with the business objectives for the plan year and to discuss execution viability with available resources. Concurrently, in step seven, the processor may rationalize the initiatives. During the fifth executive planning session (EPS #5), executives review the aggregate funding plan across EVIs and RTB. In this session, the processor may model various funding scenarios and recommend a short list of high probability initiatives that would be included in the business plan. In step eight decision makers validate the aggregate funding and resource estimates across EVIs and RTB as well as the decision factors, using the budget decision framework (FIG. 12) as a guide. At steps nine and ten , the processor may address resource constraints and finalize the business plan respectively. Decision makers and senior executives will iterate through steps nine and ten, through the sixth executive planning session (EPS #6) during which the processor may model what-if scenarios to concur on a viable business plan and prepare an outline of a business plan document for final approval and team communication.

Executive planning sessions (EPS #1 to EPS #6) are interspersed within the ten steps of the planning cycle, as depicted in FIG. 14b.

As an example, FIG. 14c illustrates testing phases, according to one or more embodiments. The testing phases are shown in FIG. 14c. The testing phases define the scope of testing during program execution and are utilized in the estimating models. The different types of testing include component (unit testing), assembly testing, integration testing, regression testing, product testing, user acceptance testing, operation readiness testing, market validation and client acceptance. The initiatives may then be finalized and are deployed into the target environment for a soft launch.

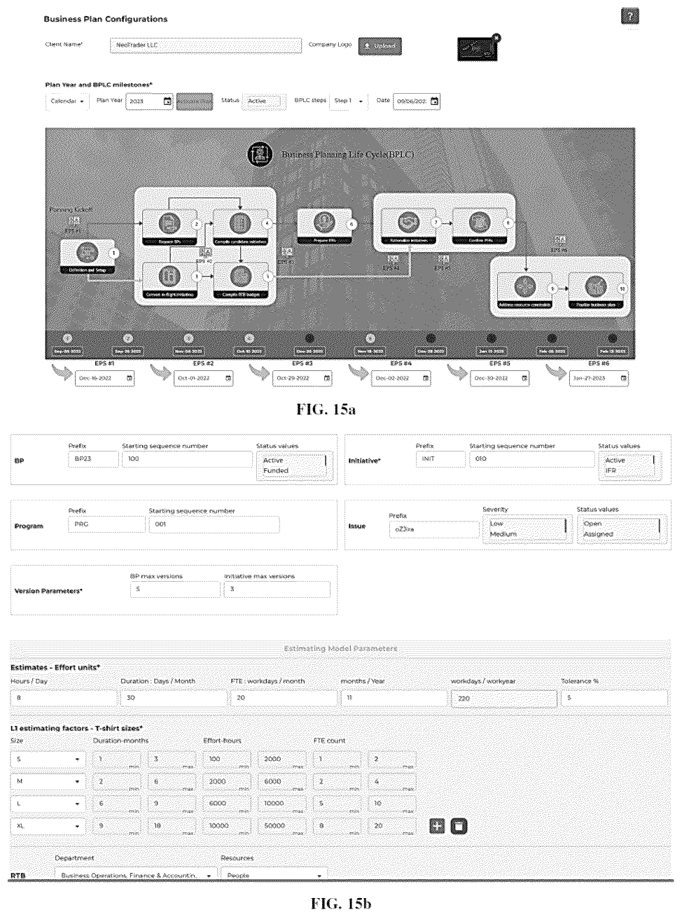

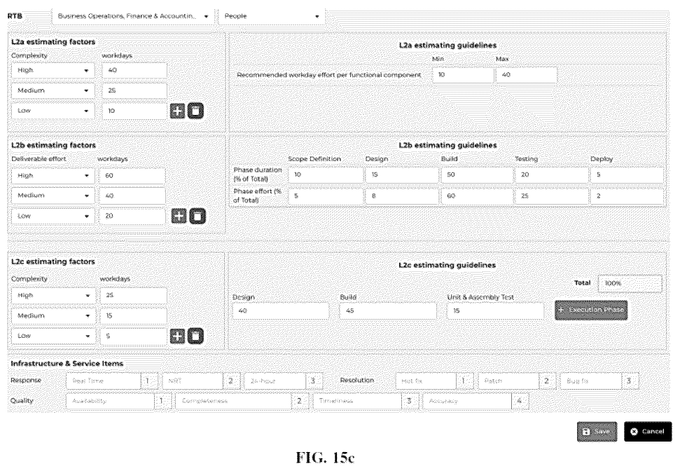

As an example, FIG. 15a, FIG. 15b and FIG. 15c illustrate business plan configurations, according to one or more embodiments. FIG. 15a illustrates a processor rendering a user interface view for receiving information from the one or more users. The user interface view further enables the user to configure various planning parameters that are applicable across the organization. The user interface view enables the users to provide/upload information such as client name, company logo. Every upload to the company logo replaces the existing logo. The user interface view further enables to set up calendar, plan year, BPLC status, and date. The user interface view enables the users to configure the plan year on a calendar or fiscal basis. When the upcoming plan year is set/activated, the processor enables only to access data from prior years in View mode and to export the data.

The user interface view enables the users to structure the business planning lifecycle (BPLC) in 10 steps. The processor through the user interface view enables the users to skip steps. In preparation for the planning cycle, the intended completion date for each BPLC step is entered.

The user interface view further depicts the BPLC status. The BPLC steps are interspersed with up to six executive planning sessions (EPS #1-EPS #6). The zoomed in view of BPLC executive planning sessions is shown in FIG. 14b. Every EPS is a collaborative session with peer executives, executive management, and decision makers. The user interface view also enables the users to configure target dates for EPS. The processor through the user interface updates the status of the BPLC as progress is made. Red indicates that the step is past the intended date. Amber indicates that the step is in progress and pending Approvals to proceed. Green indicates that the step is completed. Grey indicates that the step has not started. The user interface view further depicts Nomenclatures. BPs and initiatives are adapted to identify and enable cross-reference and translation with prevailing planning tools. Issues are adapted to identify and enable cross-reference and translation with issue management tools (e.g., JIRA).

FIG. 15b illustrates a processor rendering a user interface view for configuring BPs and initiatives. The user interface view enables the users to provide prefix and starting sequence number for naming at least one of initiative, BPs, program to be executed and issues. The user interface view enables the users to configure version parameters. The user interface view enables the users to configure estimating model parameters such as hours/day, duration (days/month), FTE (workdays/month), months/year, workdays/year, and the default tolerance % . All these parameters are used as base values to estimate the effort workdays and FTE count in the L2 and L3 estimating models for IFRs. Tolerance % is used to highlight variances in the resulting estimated values across all models and versions, using the finalized model version as the baseline to measure the variances. The processor, through the user interface view, enables the users to configure L1 estimating factors, L2a, L2b, L2c as shown in FIG. 15b and FIG. 15c.

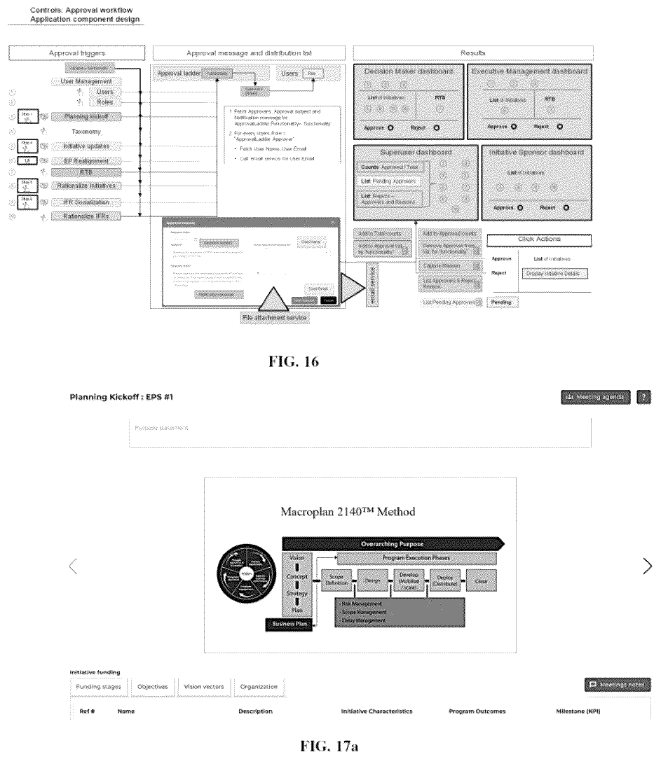

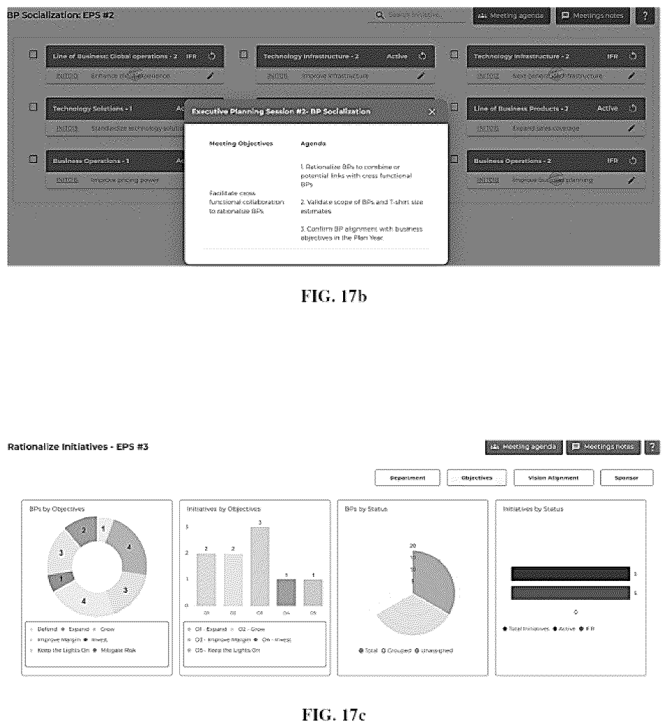

As an example, FIG. 16 illustrates process approval workflow, according to one or more embodiments. FIG. 16 depicts three sections such as approval triggers, approval message and distribution list, and results. The approval triggers may be triggered from user management, user's roles, planning kickoff (EPS#1), taxonomy, initiative updates, BP realignment, RTB, rationalize initiatives, IFR socialization, rationalize IFRs, etc.

The processor may communicate an approval request to the next section. The approval ladder receives the approval request. The approval triggers communicate the request to approvers upon checking the functionality. The processor may also check the roles to ensure whether the approver is authorized to do so. The approval request may comprise a request date, subject, request note, user name. The subject tab may enable users to define approval subjects. The request note tab may enable users to receive notification messages. The user name tab may enable users to select the approval to which the approval request is to be sent. The approval request may also comprise “upload attachment” that enables users to upload an attachment while sending an approval request. The approval request may be sent via an email message.

The results section comprises dashboards such as decision maker dashboard, executive management dashboard, superuser dashboard, initiative sponsor dashboard. The decision maker dashboard and executive management dashboard depicts the list of initiatives and RTB. The decision maker dashboard and executive management dashboard enables users to either reject or approve. The superuser dashboard depicts the initiatives count that are approved. The superuser dashboard depicts the total initiatives count. The superuser dashboard also lists pending approvers those who are yet to act on an action item. The superuser dashboard also lists the rejected initiatives—their approvers and reasons for rejections. The initiative sponsor dashboard depicts the list of initiatives. The decision maker dashboard and executive management dashboard enables the users to either reject or approve the initiatives.

The processor upon receiving the approval request may add the approval request to total counts and the approver name to an approver list by “functionality” (at result section). Once the action is performed (i.e., approved, rejected, etc.), the approval request is added to either approved count or rejected count. The approver name is removed from the approver list from “functionality”. The processor also captures the reason for approval or rejection. The processor may also list approvers and reject reasons. The processor may also list pending approvers and pending action items. The click actions (action items) may comprise “reject,” “approve,” “pending,” and “display initiative details.”

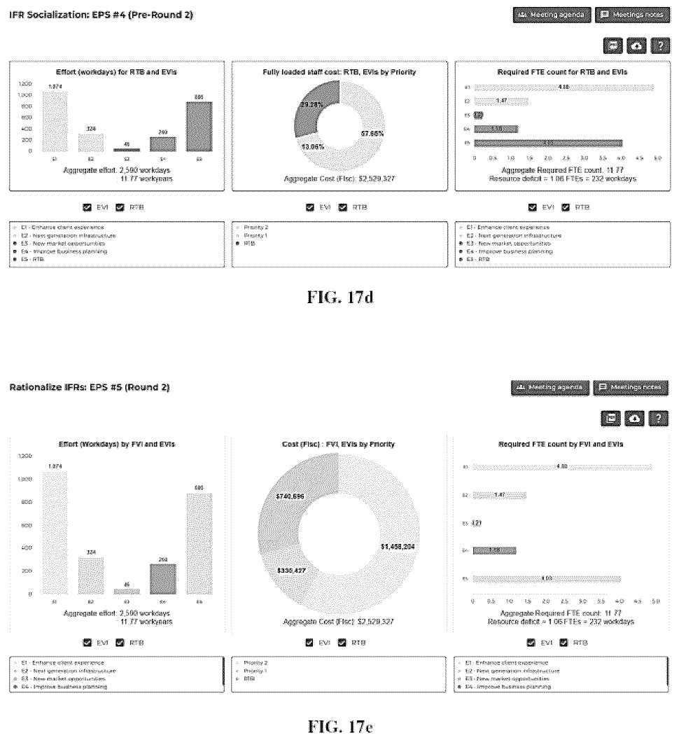

As an example, FIG. 17a-17e illustrates executive planning sessions, according to one or more embodiments. FIG. 17a illustrates executive planning session EPS#1. EPS#1 illustrate planning kickoff. EPS#1 is adapted to introduce the new planning paradigm to all stakeholders. The user interface depicts the objectives and agenda. The objective may be to introduce the new paradigm and alignment to the purpose to start planning. At EPS#1, the system, comprising a processor, is operable to enable users to review organizational purposes, vision, and objectives. The processor is operable to discuss the business planning life cycle (BPLC). The processor is operable to enable users to discuss planning roles, tools, and expected outcomes.

At EPS#2, the processor is operable to perform BP socialization. The processor enables users to collaborate in real-time and rationalize BPs. The objective is to facilitate cross functional collaboration to rationalize BPs. At EPS#2, the processor is operable to rationalize BPs to combine or potential links with cross functional BPs. The processor is operable to validate scope of BPs and T-shirt size estimates. The processor is operable to confirm BP alignment with business objectives in the plan year.

At EPS#3, the processor is operable to rationalize initiatives. The objective is to facilitate cross functional collaboration to rationalize initiatives. At EPS#3, the processor is operable to concur on scope of critical minimum and aspirational capabilities within each initiative. The processor is operable to realign BPs across initiatives, manage scope and outcomes. The processor is operable to discuss expertise gaps and conflicts. The processor is operable to discuss priorities against previous business objectives. The processor is operable to rationalize BPs into relevant initiatives. The processor is operable to shortlist initiatives. The processor is operable to designate IFR authors.

At EPS#4, the processor is operable to perform IFR socialization. The objective is to enable decision makers and senior executives to overcome hurdles to review inventory of initiatives, and potential RTB commitments in aggregate. At EPS#4, the processor is operable to enable users to review aggregate funding requests. The processor is operable to confirm alignment of initiatives and RTB with objectives for the plan year. The processor is operable to enable users to collaborate and discuss execution viability with available resources, expertise, estimated deficits, deficiencies, and constraints.

At EPS#5, the processor is operable to perform IFR rationalization. The objective is to enable executives to review aggregate funding plan for RTBs and EVIs. At EPS#5, the processor is operable to enable users to review preliminary funding allocations. The processor is operable to model various funding scenarios. The processor is operable to shortlist high probability initiatives and confirm sponsors.

The table below lists out the algorithm used at different stages.

| Algorithm | Pattern(s) | Computation | Result |
|---|---|---|---|
| Draft BPs | Prompt gen AI tool to | | up to three drafts |
| | provide three drafts of BPs | | of BPs and L1 |
| | based on-BP Hypothesis or | | estimates and |
| | problem statement, | | expertise required |
| | constraints, hurdles, and | | potential source of |
| | opportunities for | | expertise deficits |
| | improvement | | |
| | Primary objective | | |
| | Vision Statements | | |
| BP themes | Identify thematic patterns in | Apply “Probabilistic | Create preliminary |
| | the BPs, by | Algorithm” to create | list of initiatives |
| | Opportunities for | a proprietary pattern | by grouping |
| | improvement . . . 25 | recognition logic? | related BPs into |
| | percentage of keywords are | Group related BPs, | respective |
| | common | Update BP links, | initiatives |
| | Major business impact | update Co-sponsors | Shortlist viable |
| | 25 percentage of keywords | Order Orphan BPs | initiatives that are |
| | are common | by department and | aligned to the |
| | Reference to related BPs | objectives (Default: | vision |
| | in the form (incl. with | Order by and allow | |
| | description) | manual grouping) | |
| | Products (Revenue | | |
| | streams) . . . Hierarchy of | | |
| | matching criteria = Same, | | |
| | majority | | |
| | For fortune consideration: | | |
| | 1) BP Themes Bag of words | | |
| | (BOW)-or “Training | | |
| | Data”?2) | | |
| | Resource pools (shared | | |
| | Capacity), technology | | |
| | infrastructure | | |
| Data conversion | Set up and load | Alias for every | Alias Reference |
| routines | | dimension in the | Tables (Database |
| | | Reference Tables | for each client) |
| | | Pre-loaded default | |
| | | values (“Reference | |
| | | Tables”) | |
| | | From (Default | |
| | | values) To client | |
| | | nomenclature | |
| Loaded cost | Sourced from People | Base comp + | “Loaded Cost” tab |
| calculator | reference table | Benefits (Individual, | in the “Estimating |
| | Source brand | Band, Function | Models L1-L3” |
| | Geographic location | Average for the | workbook |
| | Department and function | Department by | |
| | | geographic location | |
| | | (region) | |
| | | Aggregate (sum) by | |
| | | resource Band within | |
| | | each department | |
| Initiative Rank-n- | | Executive inputs to | Effort sizing |
| stack | | reorder using | Resource, |
| | | inferences from | Expertise, & |
| | | systematic patterns | Capacity-gaps |
| | | | Program structure |
| Expertise and | Expertise by department | Aggregate | Inventory of |
| resource gaps | Resource count by band | (RTB + IFR) | expertise and |
| | within each department | Expertise gap = | capacity gaps by |
| | Required expertise and | Required-Current | department (in |
| | count will be sourced from | Aggregate | aggregate across |
| | RTB and IFR models | (RTB + IFR) Capacity | initiatives) |
| | Sponsors or super users will | gap = L2 Estimated | |
| | input current values | workdays- | |
| | | Available capacity | |
| | | by department and | |
| | | band | |
| Resource | Individual names | Qualitative inputs by | |
| contention | Resource banned by | sponsors | |
| | department | | |
| Scenario planning | Change scope | Recalculate L2 | Expertise, |
| | | estimate of effort | Resource, Cost |
| | Change duration of the | Recalculate L2 | Resource, |
| | initiatives | estimate of resource | Capacity, Cost |
| | | loading | |
| | Change resource (Capacity) | Recalibrate duration, | Expertise, |
| | availability by department | expertise | Resource, Cost |
| | or realignment across | | |
| | Initiatives | | |
| | Change Initiative budget | Recalibrate scope, | Scope, Duration, |
| | | duration, resource | Resource |
| | | loading | |
| | | Recalculate L2 | |
| | | estimate of effort | |
| | Change, revenue, margin, | Recalibrate scope, | Scope, Duration, |
| | and cost efficiency targets, | duration, resource | Resource |
| | and by percentage | loading | |
| | allocation by objectives | Recalculate L2 | |
| | | estimate of effort | |
| Materiality | IFR: change to hypothesis | Decision maker and | |
| | | sponsor review | |
| | IFR: change scope-add or | Recalculate L2 | |
| | remove Bp or capability | estimate of effort | |
| | IFR: change benefits-add | Decision maker and | |
| | or remove benefits | sponsor review | |
| | IFR: change risks-add or | Decision maker and | |
| | remove risks | sponsor review | |
| | IFR: change assumptions | Decision maker and | |
| | | sponsor review | |
| | IFR: changes to Resource | | |
| | strategy (Color code, | | |
| | expertise addition or | | |
| | removal) | | |
| | IFR: change to cost (>2% | | |
| | change) | | |
| | BDF: change to “Source of | | |
| | Funding” | | |
| | BDF: change to “Ability to | | |
| | deliver” | | |
| | BDF: change to | | |
| | “Performance Metrics” | | |
| Benefits KPI | Discrete list of benefits | Inventory of unique | Performance |
| converter | across initiatives | benefits by sponsor, | metrics assigned |
| | | department, | to sponsor, by |
| | | objective and by | initiative and by |
| | | Vision vector | vision vector |
| | | Translate benefits to | |
| | | performance metrics | |
| | | (define benchmark- | |
| | | reference tables?) | |

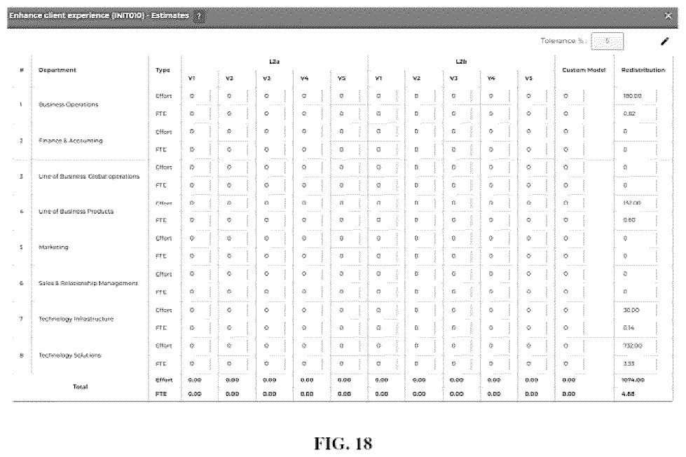

As an example, FIG. 18 illustrates triangulation of effort estimates and full time equivalent (FTE) estimates across estimating models and versions, according to one or more embodiments. The user interface view shown in FIG. 18 depicts efforts and FTE estimates of different IFRs sponsored by each department across different estimating models such as L1, L2a , L2b , L3, etc. and their different versions. For each estimating model the different versions may be V1, V2, V3, V4, V5, etc. The processor is operable to highlight every value in the user interface, based on the variances of their respective values within or outside the configurable tolerance % in reference to the values for the finalized model for the IFR. The user interface view enables the user to customize the tolerance value. The user interface depicts the total efforts and FTE estimates at the bottom enabling the users to improve the planning strategy.

As an example, FIG. 19 illustrates functional architecture, according to one or more embodiments. The functional architecture comprises set up and load, reference tables, templates, decision support, estimating models, help, channels, support tools, client onboarding, BPLC workflow, controls, RnA (Reports and Analytics), Algorithms, Integration, offboarding, program management, and AI. The set up and load comprises frameworks, purpose vectors, BPLC workflow (interactive), Program Management Framework (named the “House that Rao Built”—HTRB). The set up and load is described as an example in FIG. 14a.

The reference table is adapted to execute BPLC session management. The BPLC session management includes defining client roles, BPLC steps, and executive planning sessions. The reference table is adapted to manage tasks of organization by department and functions. The reference table is adapted to manage expertise by specialties and proficiencies. The reference table is adapted to manage revenue streams by products and services and revenue sources. The reference table is adapted to manage resources by people, infrastructure, service items, resources bands and loaded costs. The reference table is adapted to manage initiative funding at different stages, risk ratings, vision vectors and objectives. The reference table is adapted to manage PLC WBS for different roles, program phases, workstreams, releases, testing phases, deliverables, and key activities, etc. The templates may be used for intakes and dashboards. The template for intake comprises BP intake, EPS round 1 pitch, Omnibus RTB budget, IFR. The template for dashboards comprise BP aggregation, initiative analytics, REC analytics, initiative rationalization, and performance metrics.

The decision support may be configured for scenario planning, budget decision, program structure, business plan, and baseline program plan. The estimating models may estimate effort units at different complexity based on factors and guidelines upon validation by the users. The functional architecture provides help in terms of tooltips, FAQs, User manual, information, and glossary. The functional architecture also comprises channels such as client broadcast, expert network, Rao Niti. The support tools may be configured to perform data integrity checks, data restore, enhancement backlog, event monitoring, issue logging, client version management, and solution component entitlements. The issue logging is described already. The event monitoring is configured to monitor critical events in the BPLC workflow. The event monitoring is configured to provide issue notification to client executives when workflow steps advance or retract. The event monitoring is configured to provide issue notification alerts on material changes to REC dimensions. The support tool client version management is configured to manage client packages contracted. The client version management is configured to monitor package version for each client contract and verify functional components entitled for respective client packages. The data restore tool is configured to recover client data in the event of data corruption. The data restore tool has the ability to restore a recent version of the dataset (complete load) upon admin request and enable full download of manual backup documents.

The data integrity checks tool is configured to maintain reference table integrity across the platform. The data integrity checks tool is configured to run End of Day checks to cross validate data in reference tables between related reference tables and between reference tables, RnA dashboards and decision support tools.

The enhancement backlog tool is configured to maintain reference table integrity across the platform. The enhancement backlog tool is configured to maintain backlog of solution enhancements and Id, description, package, capability and function, benefits, priority, effort estimate, additional cost, status. The solution component entitlements is configured to monitor technology component level entitlements. The system uses the application architecture schematic, and monitors client level and user level entitlements for every technology component mapped to each functional component.

The client onboarding enables the users to perform client and user administration. The client onboarding enables to perform activation, client credentials, contract terms, role assignments, component entitlements. The client onboarding enables management of profiles and entitlements. The BPLC workflow enables to set up client taxonomy, planning kickoff (BP request inbox), manage BP grouping (BP socialization), allocate RTB resources (initiative rationalization—round 1), IFR inbox (IFR socialization), rationalize initiative priorities (IFR rationalization—round 2), model funding allocations , executive approval preparation, finalize business plan.

The BP request inbox is configured to Request Business Propositions (BPs) from Sponsors. The BP request inbox is configured to compile a backlog of open BPs from current and prior years, across all departments. The BP request inbox is configured to enable users to select from the list and create or update BP for the current year. For prior year's open BP, the system copies all the information and creates a new BP entry for the current year. For BPs in process, the system enables the user to update information. The system also enables the user to create BP from a blank template. The form fields consist of: Selections from Reference Tables, Free text with sub-sections, character limits and word limits, contextual validation (e.g., Month, Quarter values), mandatory and optional fields, and locked section controlled by super user. The system also enables the users to import T-shirt size estimates from Estimating model L1. The Estimating model L1 provides a link to Estimating model L1 and stores calculations with the BP. The Estimating model L1 provides a link to estimating guidance and factors.

The system also enables the users to manage grouping. The system enables super users to convert in-flight initiatives, having milestones for the Plan-Year into the new taxonomy and templates. The system provides schemas and sub-schemas to enable Super user to import BPs for in-flight initiatives. This upload capability is a data conversion maintenance tool. The system further applies algorithms, e.g. themes to group related BPs. The system enables the users to create unique initiative IDs and then sponsor or super user assigns cryptic, yet intuitive Initiative names. The system displays Business Proposition Aggregation (BPA) form. The Business Proposition Aggregation (BPA) form provides pre-filled information. The processor through the Business Proposition Aggregation (BPA) form enables user to enter additional information in EPS Round 1 Pitch Form. The processor also enables the users to update original BP information and check for materiality. The processor enables the user to re-group BPs, and assign “related” BPs from other Initiatives and Drop BPs from their own Initiatives. The form fields comprise selections from Reference Tables, Free text with sub-sections, character limits and word limits, Contextual validation (e.g., Month, Quarter values), Mandatory and Optional fields, and Locked section controlled by Super User.

The step, BP socialization is to facilitate cross functional collaboration to rationalize BPs. The BP socialization step is configured to Group BPs into Initiatives: 1-1 working sessions with each Sponsor. The BP socialization step is further configured to capture notes from meetings which comprises potential links to other BPs, rationale to combine BPs, L1 estimates, expertise and assumptions.

The step, allocating RTB resources is adapted to estimate resource requirements to support RTB activities through the following technical steps. The system enables super users to populate key activities that are performed by resources allocated or assigned to support ongoing business (RTB). The system enables super users to pre-load templates with key RTB activities by department. The system provides schemas and sub-schemas to enable super user to import activities by phase for in-flight initiatives, as well as for RTB. This upload capability is a data conversion maintenance tool. The system enables super user and client executives to enter estimated quarterly hours for every resource band that would be allocated to perform corresponding RTB activities. Utilization alerts are entered as an aggregate for each resource band within the department. The system also enables super users to compile resource deficits by department. The form fields consist of: selections from reference tables; computation of hours per quarter; and mandatory and optional fields.

The system also provides following guidance for RTB resource allocation. The system lists up to 10 key activities per department. The system pre-populates an indicative list of key activities by department and allows additions. Regarding resources, the system provides following guidance. The system enables to distribute activities by Resource Specialty (optional) and Band across People—Bands Senior (1), Mid (2), Junior (3); Infrastructure—Server (3), Security (1), Network (2), Cloud (1); Service item—Response: Real-time (1), NRT (2), 24-hr (3); Resolution: Hot fix (1), Patch (2), Bug fix (3); Quality: Availability (1), Completeness (2), Timeliness (3), Accuracy (4). Regarding resource deficit, the system enables opening of requests—backfill and expertise and/or capacity gaps to meet RTB goals.

The step, Initiative Rationalization Round 1 is adapted to facilitate cross functional collaboration to rationalize Initiatives. The step, Initiative Rationalization Round 1 is configured to produce inventory and aggregation analytics; enable BP realignment, BP status; edit BP details (keep version); and Capture Notes from meetings (such as Assumptions, Actions, and Emerging themes).

The step, IFR inbox is adapted to prepare Initiative Funding Requests. The IFR inbox propagates Initiative level information collected. The form fields consist of: Selections from Reference Tables; Frec text with sub-sections, character limits and word limits; Mandatory and Optional fields. The system enables importing of resource strategy from a) Estimating model L2; b) Loaded cost calculator; and c) User defined model. The system enables importing of resource strategy by providing a link to Estimating model L2 and store calculations with the Initiative. The system enables importing of resource strategy by providing a link to estimating guidance and factors. The user defined model comprises source as Custom estimating model attributes and target as IFR REC data.

The step, IFR inbox is adapted to enable decision makers and senior executives to huddle to review inventory of initiatives and potential RTB commitments in aggregate. The step is further adapted to aggregate RTB+IFR data; generate RnA dashboards using REC analytics and display resource deficits from IFRs and RTB.

The step, rationalize initiative priorities is adapted to enable executives to negotiate and prioritize initiatives in 1-1 meetings, in advance of executive planning sessions. The step, rationalize initiative priorities is configured to display inventory of initiative and key attributes; compute Initiative Rank-n-Stack using Algorithm and enable executives to reprioritize, reduce scope (i.e., move BPs), adjust resource allocations and refine effort estimates.

The step, IFR rationalization is adapted to enable executives to review aggregate funding plan for Initiatives and RTB. The step, IFR rationalization is configured to generate core RnA Dashboards using REC Analytics and Resource deficits from IFRs and RTB

The step, model funding allocations is adapted to enable decision makers and senior executives to huddle to review and confirm preliminary initiative funding allocation. The step, model funding allocations is configured to aggregate resource contention, expertise, and capacity gaps; enable executives with scenario planning toolkit to generate RnA REC analytics dashboards for premium dimensions and generate What-if scenarios for changes to: scope, duration, RTB resource alignment, revenue, and margin goals.

The step, executive approval prep is adapted to enable decision makers and senior executives to address critical resource constraints; incl. infrastructure, skills, capacity. The step, executive approval prep enables executives with decision support toolkit to generate RnA REC analytics dashboards for all dimensions and generate what-if scenarios for changes to: scope, duration, resource alignment, revenue, and margin goals.

The step, finalize business plan is adapted to enable decision makers and senior executives to finalize the business plan for the following year. The step, finalize business plan enables to convert “Benefits” to KPIs based on user input; create a business plan and enable decision makers and senior executives to update metrics. The step, finalize business plan is configured to enable decision makers and senior executives to update metrics. The step, finalize business plan is configured to enable super user and sponsors to complete L3 estimates for (“high probability”) funded initiatives and generate baseline program plans.

The controls is configured to maintain unique IDs: BP, initiative, plan year, maintain taxonomy translations, start BPLC step, look BPLC step, manage approvals, active dashboards, log issues, manage intake versions, maintain BP initiatives, backlogs, maintain decision and action logs. The RnA comprises dashboards across REC analytics dimensions, RTB+IFR aggregation, business plan, and baseline program plans. The algorithms may be configured to create BP themes, estimating models, data conversion routines, resource contention, scenario planning, materiality, loaded cost calculator, initiative rank-n-stack. The functional architecture enables integration with existing applications to download REC analytics, import IFR, issue logging & monitoring, import people data, export plan data to manual mode, translate PLC WBS, export program plan, export data-entity models. The functional architecture enables the users to export RnA dashboards, import REC metrics, and import client contracts. The functional architecture may also enable offboarding. The program management is configured to perform monitoring and reporting, time tracking, communication protocol, budget pool management and manage performance metrics: KPIs.

In one embodiment, the controls may be used to provide one-click ability to archive pre-defined datasets for the client, based on the contracted package such as reference tables, using corresponding schemas and sub-schemas; intake forms, REC analytics; and Estimating models. The step, maintaining BPs is configured to control or maintain status of BPs and initiatives such as active; funded; deferred; and retired (logically deleted—not visible on any dashboard; data retained).

The controls are configured to maintain intake versions. The system locks rolling 5 versions of Intake forms based on material changes. The system also comprises controls to manage backup plan artifacts by locking rolling 5 versions of RnA dashboards, REC analytics and plans. The system also manages log issues by tracking bugs, and hot-fixes in platform such as client reported, uncovered during client operation and Id, description, impact, user credentials, date, severity, status. The system also enables client users to provide input of platform issues. The system also enables exporting of all client issues to an issue management tool like Jira.

The system also comprises controls to maintain decision and action logs. The system provides a panel for the super user, program manager and program champions to create and maintain a backlog of decisions and actions from EPS as well as from 1-1 collaboration working sessions. The system as an extension, provides an import capability from collaboration tools such as slack.

As an example, FIG. 20 illustrates program management framework, according to one or more embodiments. The funded initiatives may be executed as programs. The program management framework enables the creation of robust program plans that encompasses all phases in program life cycle, and ongoing monitoring for alignment with the program objectives. The program management framework comprises a governance model that transforms the variables (resources, time, and scope) into project plan.

The governance model defines the overall administration and conduct of projects within the organization. Composition and mandates of committees and working groups are critically important for success. The governance model comprises a triangle which comprises three nodes representing three variables—resources, time, and scope. The three variables are critically linked to each other. The program management framework operates in a way such that when there is a lack of resources, the program management framework does not necessarily determine it as the end of the project. It becomes the basis on which time (as in duration) can be re-estimated (more time is required to complete the same scope of work), or perhaps the scope needs to be re-evaluated. The program management, designed as shown in FIG. 20 comprising communication protocol, structure, process, cadence and across all stakeholders, increases probability of meeting business objectives and optimizes resource utilization.

The project plan comprises assumptions and effort estimates. The project plan is a foundation on which the project is based. The plan is supported by assumptions and effort estimates. The program management framework comprises estimating tools that are designed to enable proficient program managers to visualize resource contention, expertise gaps, capacity requirements at the appropriate skills and conflicting assumptions.

The program management framework further supports infrastructure and training. Organizationally, projects are supported by strong infrastructure and ongoing training. Infrastructure includes physical facilities and all its attended requirements, as well as robust technology infrastructure to support project teams globally. Training is an important facet of ensuring that teams are constantly enhancing and expressing their base of knowledge to be able to apply the current best practices, tools, techniques, and methods to their ongoing projects. It is also important to ensure that post-implementation training is integral to project plans.

The Program management framework comes with robust taxonomy for organizational functions, objectives, initiative stages, and expertise. The accompanying templates enable alignment of the programs with objectives for respective revenue streams from the organization's products and services. The resulting programs define the roles for every resource deployed to various activities in the project plan; thereby clarifying the concomitant roles and responsibilities.

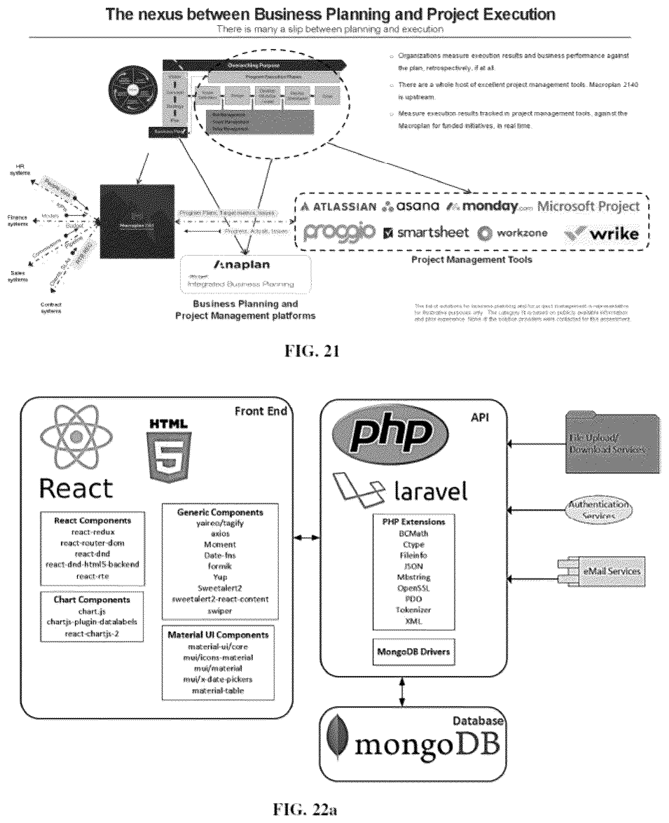

As an example, FIG. 21 illustrates a connection between planning and execution, according to one or more embodiments. The planning phase is illustrated in FIG. 14a. The program execution is described. The system having the processor is operable to seamlessly communicate with existing applications such as HR, Finance, Sales systems, contract systems, etc. The processor is operable to receive information. The processor then creates the business propositions based on the information. The processor then creates the initiatives from the business propositions. The scope definition, design of business plan, development of initiatives, updating initiatives, etc. takes place at this stage. The business planning and project management executes at this stage. The integrated business planning and program management platform (e.g., Anaplan®) may be adapted to execute the above actions. The initiatives once finalized are finalized into the target environment for further analyzing the performance and for determining whether the objectives are achieved. The program management and execution tools adapted to execute the deployment and analysis of performance and the objectives are shown in FIG. 21. The correlation between the planning and executions is shown in FIG. 21.

As an example, FIG. 22a, FIG. 22b, and FIG. 22c illustrate deployment architecture, according to one or more embodiments. The illustration in FIG. 22a comprises front end application and an application programming interface (API). Application Programming Interface (API) functions like a bridge that allows different software applications to communicate and interact with each other. API sets the rules and protocols for how different software components should interact, enabling developers to access certain features or data from a service (file upload/download services, email services, authentication services) or platform without needing to understand the underlying code. The illustration in FIG. 22b and FIG. 22c comprises the technology infrastructure (“environment”) on which the application code resides. It consists of front end web user interfaces (laptop screen, desktop screen) from which either the administrator or end user application functions can be accessed. The application code and the database (MongoDB) reside on the cloud infrastructure (provisioned with Digital Ocean, a third-party cloud service provider). The databases are partitioned separately for each client to ensure security and privacy of every client's data. The master data consisting of the reference tables, default values, system level documents, etc. are stored in a separate partition of the database, to which only the system administrator has access.

APIs define the methods and data structures for requests that can be made, specifying how software components should interact. APIs are crucial in modern software development, facilitating the integration of different systems, services, and functionalities. For example, social media platforms often provide APIs that allow developers to access their users' data or perform actions like posting updates through their own applications.

Laravel simplifies common tasks like routing, authentication, caching, and sessions, offering a wide range of built-in functionalities through its expressive syntax. Some key features include Eloquent ORM (Object-Relational Mapping) for database interaction, Blade templating engine for efficient UI rendering, Artisan command-line interface for automating tasks, and a robust ecosystem of packages called Composer.

Hypertext Preprocessor (PHP) extensions are modules that provide additional functionality to the PHP programming language. PHP extensions extend the core capabilities of PHP by offering specific features or interfaces to interact with external resources, services, or technologies. BCmath stands for “Binary Calculator math,” and it's a PHP extension that provides arbitrary-precision arithmetic. BCmath allows you to perform mathematical operations on numbers with arbitrary precision, without losing accuracy due to the limitations of standard floating-point arithmetic. The “ctype” extension in PHP stands for “Character Type Functions.” Ctype provides a set of functions that are used to check and manipulate various character types within strings. The functions allow to perform checks on individual characters or entire strings to determine their character types. The “fileinfo” extension in PHP is used for determining the type of a given file by examining its binary data rather than relying solely on the file extension or MIME type provided by the client or file system. It's a part of PHP's file handling capabilities and provides functions to identify the type and properties of files. JSON (JavaScript Object Notation) is a lightweight data-interchange format that is easy for humans to read and write and easy for machines to parse and generate. JSON is a text-based format commonly used to transmit data between a server and a web application as an alternative to XML. The “mbstring” extension in PHP stands for “multibyte string functions.” It's a crucial extension used to handle multibyte encodings, allowing PHP to work effectively with different character encodings, particularly those beyond the ASCII character set.

OpenSSL is a widely-used open-source library that provides cryptographic functions and protocols, enabling secure communication over computer networks. OpenSSL offers various tools and libraries for secure communication, encryption, and certificate management. PDO stands for “PHP Data Objects,” and it's a PHP extension that provides a consistent interface for accessing databases. PDO serves as a database access layer, offering a set of functions and methods to interact with various database management systems, such as MySQL, PostgreSQL, SQLite, and others, using a unified approach. In PHP, the Tokenizer extension is used to break source code into tokens-individual elements such as keywords, operators, strings, and variables. These tokens represent the building blocks of a programming language's syntax. XML (extensible Markup Language) is a markup language designed to store and transport data. It's a flexible, human-readable format used for structuring and organizing data in a hierarchical format. MongoDB drivers are software components that enable applications to interact with MongoDB databases. MongoDB drivers act as interfaces between the application code and the MongoDB database, allowing developers to perform operations such as querying, inserting, updating, and deleting data in MongoDB. MongoDB is a popular NoSQL database that uses a flexible, document-based data model. MongoDB differs from traditional relational databases by storing data in JSON-like documents rather than tables and rows.

The front end application comprises React components. React components are the building blocks of a user interface. React components are reusable, independent, and encapsulate both the UI and the logic required to render that UI. Generic components refer to reusable UI elements or patterns that can be used across different parts of an application. Generic components are designed to be versatile, adaptable, and easily integrated into various parts of the user interface. Chart components in front-end development are used to visually represent data in various graphical formats. Material-UI is a popular React UI framework that provides a set of pre-built, customizable components following Google's Material Design principles. Material-UI components allow developers to create visually appealing and consistent user interfaces in React applications.

Authentication services are crucial components in web and app development, providing the mechanisms to verify and confirm the identity of users or systems accessing a platform. Email Services are essential for sending, receiving, and managing electronic messages over the internet. Various email service providers offer platforms and APIs for managing emails in applications. Some commonly used email services are SMTP (Simple Mail Transfer Protocol), Gmail API, SendGrid, etc. The upload and download services are essential for transferring files between clients and servers in web applications. Some commonly used services are FTP (File Transfer Protocol), SFTP (Secure Shell (SSH) File Transfer Protocol), etc.

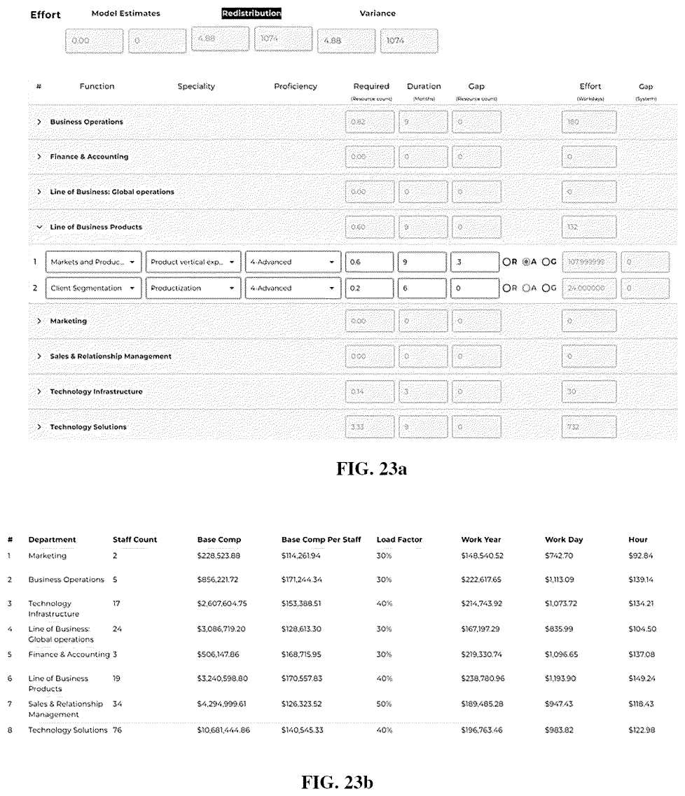

As an example, FIG. 23a and FIG. 23b illustrate model outputs, according to one or more embodiments. FIG. 23a depicts Initiative funding requests (IFRs) by departments. The processor through the user interface view shown in FIG. 23a enables the sponsors to customize the estimating factors for specific IFRs. The estimating factors may be customized as per the objective. The user interface view further depicts proficiency, specialty, required resource, duration, resource gap, effort, and system gap. FIG. 23b illustrates loaded cost by departments, according to one or more embodiments. The user interface view shown in FIG. 23b lists initiatives by department. The user interface view further depicts staff count, base compensation, base compensation per staff, load factor, total cost for the work year, total cost for a work day, total cost by hour. The user interface depicts the cost loaded for each column. The processor using the loaded cost calculator estimates the above cost for each initiative.

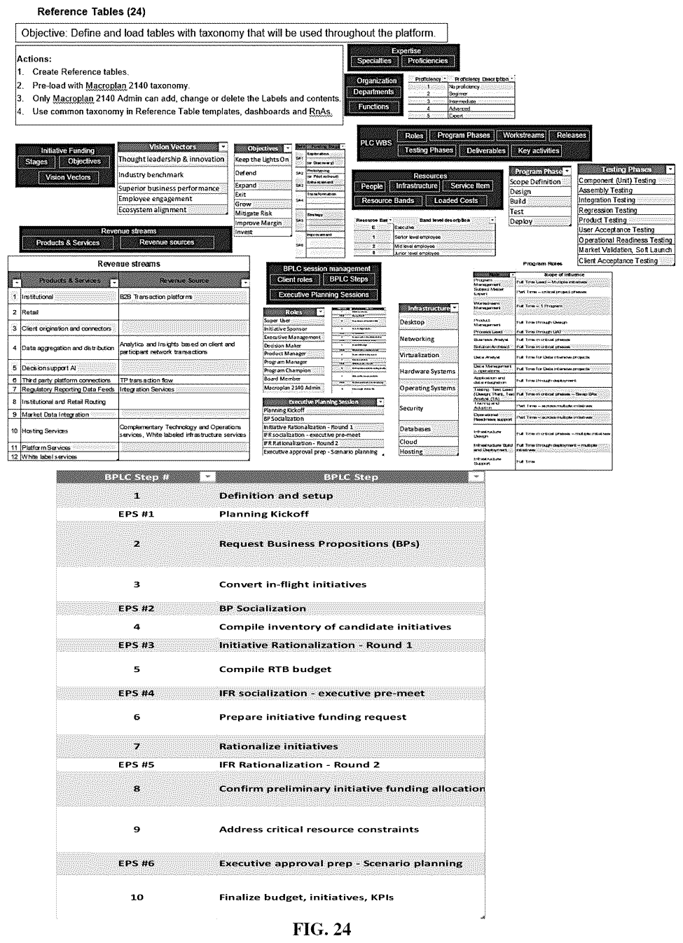

As an example, FIG. 24 illustrates reference tables, according to one or more embodiments. The system defines and loads tables with taxonomy that is used throughout the platform. The system is configured to create reference tables. The system preloads with taxonomy. The system enables a user with an admin role to add, change or delete the labels and contents. The system uses reference table templates, dashboards and RnAs. The initiative funding reference tables comprise stages, objective vision vectors. The vision vectors tables comprise a list of thought leadership and innovation, industry benchmark, superior business performance, employee engagement, ecosystem alignment, all of which can be adapted for a client. The objectives tables may comprise at least one of defend, expand, grow, exit, keep the lights on, mitigate risk, improve margin, and invest, all of which can be adapted for a client.

The revenue streams table comprises products and services and revenue sources. As an example of its embodiment, the institutional services comprise B2B platforms. The data aggregation and distribution services comprise TP transaction flow as revenue source. The regulatory reporting data feeds comprise revenue sources as Integration services. The Hosting Services comprise revenue source as complementary technology and operation services, white labelled infrastructure services. The BPLC session management tables comprise client roles, BPLC steps, and executive planning sessions. The roles comprise super user, initiative sponsor, executive management, decision maker, product manager, program manager, program champion, board member, and admin. The executive planning sessions comprise planning kickoff, BP socialization, initiative rationalization—round 1, IFR socialization, IFR rationalization—round 2, executive approval preparation—scenario planning. The BPLC reference table, Program phase, proficiency, testing phase are shown below:

| BPLC step # | BPLC step |
|---|---|
| 1 | Definition and set up |
| EPS#1 | Planning Kickoff |
| 2 | Request Business propositions (BPs) |
| 3 | Convert-in-flight initiatives |
| EPS#2 | BP socialization |
| 4 | Compile inventory of candidate initiatives |
| EPS#3 | Initiative Rationalization-Round 1 |
| 5 | Compile RTB budget |
| EPS#4 | IFR socialization-executive pre-meet |
| 6 | Prepare initiative funding request |
| 7 | Rationalize initiatives |
| EPS#5 | IFR Rationalization-Round 2 |
| 8 | Confirm preliminary initiative funding allocator |
| 9 | Address critical resource constraints |
| EPS#6 | Executive approval preparation-scenario planning |
| 10 | Finalize budget, initiatives, KPIs |

Program phase
Scope Definition
Design
Build
Test
Deploy

Testing phase
Component (Unit) Testing
Assembly Testing
Integration Testing
Regression Testing
Product Testing
User acceptance Testing
Operational Readiness Testing
Market Validation, Soft launch
Client acceptance Testing

| Proficiency | Proficiency Description |
|---|---|
| 1 | No Proficiency |
| 2 | Beginner |
| 3 | Intermediate |
| 4 | Advanced |
| 5 | Expert |

| Resource Band | Band level Description |
|---|---|
| E | Executive |
| 1 | Senior Level employee |
| 2 | Mid-Level employee |
| 3 | Junior Level employee |

Infrastructure
Desktop
Networking
Virtualization
Hardware systems
Operating Systems
Security
Databases
Cloud
Hosting

| Ref# | Funding stage |
|---|---|
| S#1 | Exploration |
| | (or Discovery) |
| S#2 | Prototyping |
| | (or Pilot roll-out) |
| S#3 | Enhancement |
| S#4 | Transformation |
| S#5 | Strategy |
| S#6 | Improvement |

In one embodiment, the expertise table comprises specialties and proficiencies. The organization comprises departments and functions. The PLC WBS comprises roles, program phases, workstreams, releases, testing phases, deliverables, key activities. The resources table comprises people, infrastructure, service item, resource bands, loaded costs.

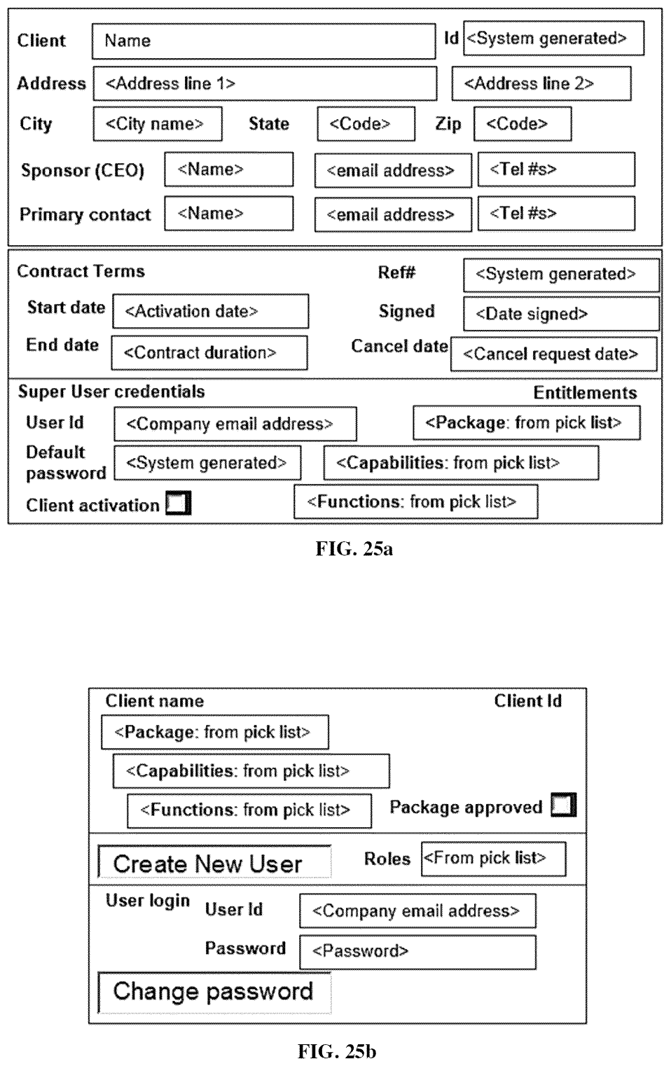

As an example, FIG. 25a and FIG. 25b illustrate client onboarding, according to one or more embodiments. The client onboarding comprises set up client credentials, load contract terms, set up component entitlements, client activation. The objective of client onboarding is to create and activate a new client with contracted functional entitlements. The features of client onboarding includes: Add client and contract terms, assign client Id, set max. entitlement hierarchy number, by Role for every function, create super user credentials, set up super user entitlements, activate client login (email login). The client onboarding further comprises user set up, and role assignments. The objective is further to enable super user to approve the contract package and create client users with appropriate roles. The features comprise: Super User creates new users, one user can have multiple roles, super user confirms the solution package, user login: reset default password; change password. The client onboarding further comprises steps such as set up client taxonomy. The objective is to enable Super User to translate current taxonomy to the new paradigm. The features include: Pre-load with system taxonomy; Provide schemas and sub-schemas to enable Super user to define client specific aliases for Labels; Allow additions to pre-existing primary Labels; Unused default Labels will be unavailable for the Client; Update all Reference Table templates and RnAs with client defined Labels.

FIG. 25a depicts a user interface view for adding client and contract terms, creating super user credentials, setting super user credentials, and activating client login (email domain). FIG. 25b depicts a user interface view that enables super user creating new users, super user confirming solution package, and User login (reset default password; changing password).

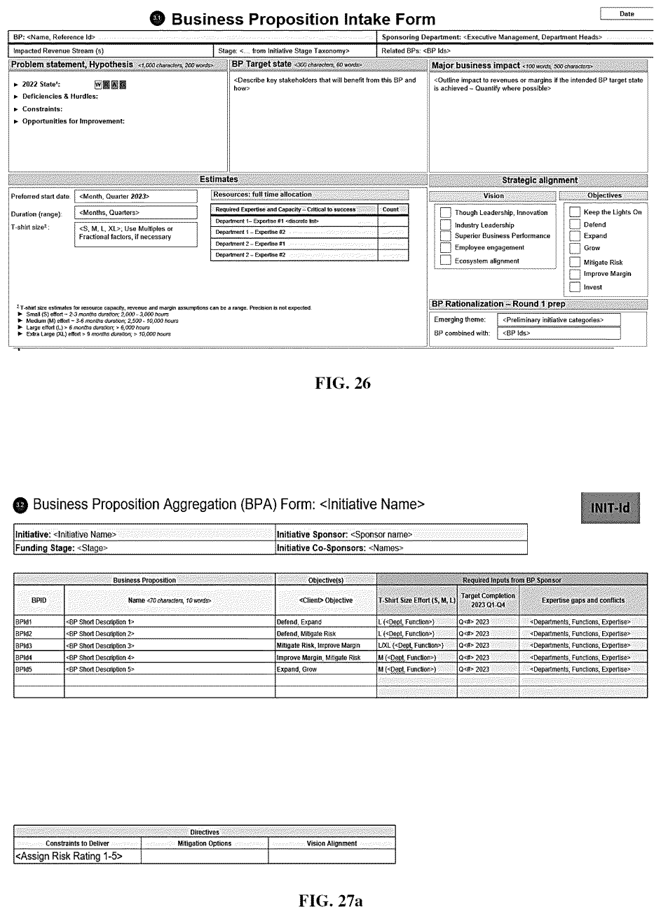

As an example, FIG. 26 illustrates user interface view rendering business proposition (BP) intake form, according to one or more embodiments. The BP intake form is rendered via the user interface to receive inputs. The inputs may be received from the users. The BP intake form comprises fields input BP name, reference Id. The BP intake form depicts the sponsoring department at the top right corner. The BP intake form also enables users to provide relevant BP IDs. The BP intake form also enables users to describe BP target state. The BP intake form also enables users to describe major business impact. The BP intake form also enables users to provide problem statements, hypotheses, etc. The BP intake form also provides stage information. The BP intake form also enables users to configure estimating efforts, estimating models. The BP intake form enables to provide preferred start date; duration (range), (T-shirt) size. The BP intake form also enables users to tick appropriate vision and objective listed under the section strategic alignment. The BP intake form also enables users to Rationalize BP.

The user interface view then enables users to request business propositions from sponsors through BP intake form. The system enables users to compile a backlog of open BPs from current and prior years, across all departments. The system enables users to select from a list and create or update the BP for the current year. For prior year's open BP, the system copies all the information and creates a new BP entry for the current year. For BPs in process, the system enables users to update information. The system enables users to create the BP from a blank template. The form fields of BP intake form comprises selections from Reference Tables, Free text with sub-sections, character limits and word limits, Contextual validation (e.g., Month, Quarter values), Mandatory and Optional fields, and Locked section controlled by Super User. The system further enables users to import T-shirt size estimates from Estimating model L1. The system further provides link to Estimating model LI, stores calculations with the BP, and provides link to estimating guidance and factors.

### Menu Navigation

>BPLC Workflow
   >>Business Propositions
      >>>BP Inbox
      Add
      Upload
      Edit

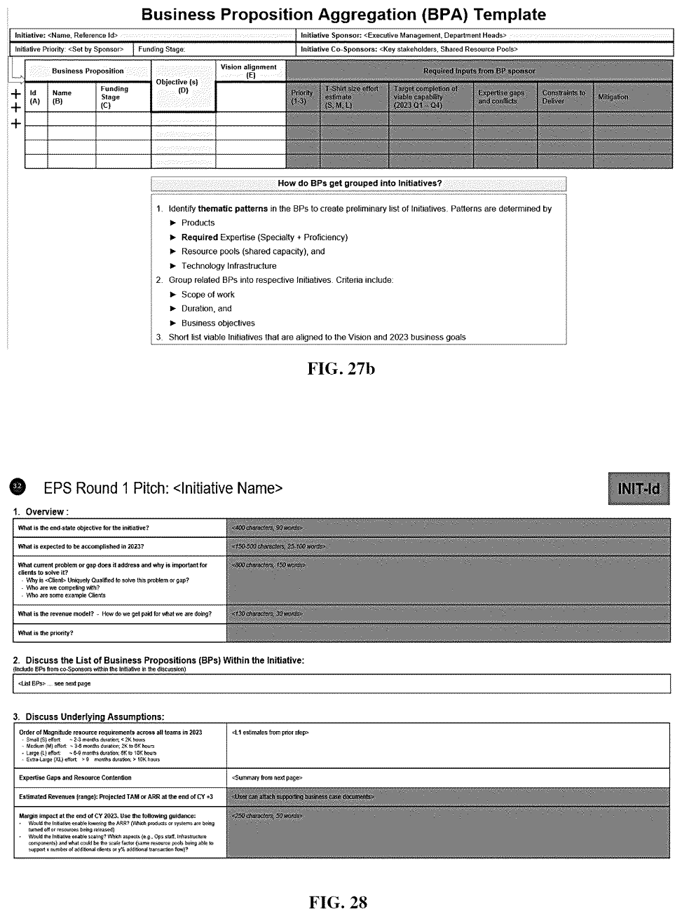

As an example, FIG. 27a illustrates user interface view rendering business proposition (BP) aggregate form, according to one or more embodiments. The BP aggregate form is rendered via the user interface to receive inputs. The inputs may be received from the users. The BP aggregate form comprises fields initiative name, initiative sponsor, funding stage, initiative co-sponsors and enables users to provide appropriate inputs. The BP aggregate form also enables users to aggregate relevant BPs under an initiative. The BP aggregate form lists out BP ID, BP name, objective and enables users to provide inputs such as T-shirt size, target completion, and expertise gap and conflicts. The BP aggregate form also enables users to constraints to deliver, mitigation options and vision alignment.

The BP aggregate form shown in FIG. 27a depicts pre-filled information. The system enables users to enter additional information in EPS Round 1 Pitch Form. The system enables users to update original BP information—check for materiality. The system enables users to re-group BPs, assign “related” BPs from other Initiatives and Drop BPs from their own initiatives. In an embodiment, BP grouping is performed. In an embodiment, business proposition aggregate template is shown in FIG. 27b.

In an embodiment, the BPs are grouped into initiatives by identifying thematic patterns in the BPs. The system determines the patterns by products, required expertise, resource pools, and technology infrastructure. In an embodiment, the required expertise is a sum of speciality and proficiency. The system also groups related BPs into respective initiatives. The criteria include scope of work, duration, and business objectives. The system shortlists viable initiatives that are aligned to vision and goals.

As an example, FIG. 28 illustrates user interface view rendering EPS round 1 pitch, according to one or more embodiments. The system enables users to convert in-flight initiatives, having milestones for the Plan-Year into the new taxonomy and templates. The system provides schemas and sub-schemas to enable super user to import BPs for in-flight initiatives. This upload capability is a data conversion maintenance tool. The system enables application of algorithms to group related BPs. The system enables users to create unique Initiative IDs. The system enables sponsor or super User to assign cryptic, yet intuitive Initiative Name. The form fields of BP intake form comprises selections from Reference Tables, Free text with sub-sections, character limits and word limits, Contextual validation (e.g., Month, Quarter values), Mandatory and Optional fields, and Locked section controlled by Super User.

The user interface view enables users to enter the end-state objective, target plan for upcoming year, current problems, gaps addressed, revenue model, priority for initiative, etc. The user interface view enables users to list the BPs to be grouped and created as an initiative. The user interface view enables users to enter resource requirements, expertise gaps and resource contention, estimated revenues, margin impact, etc.

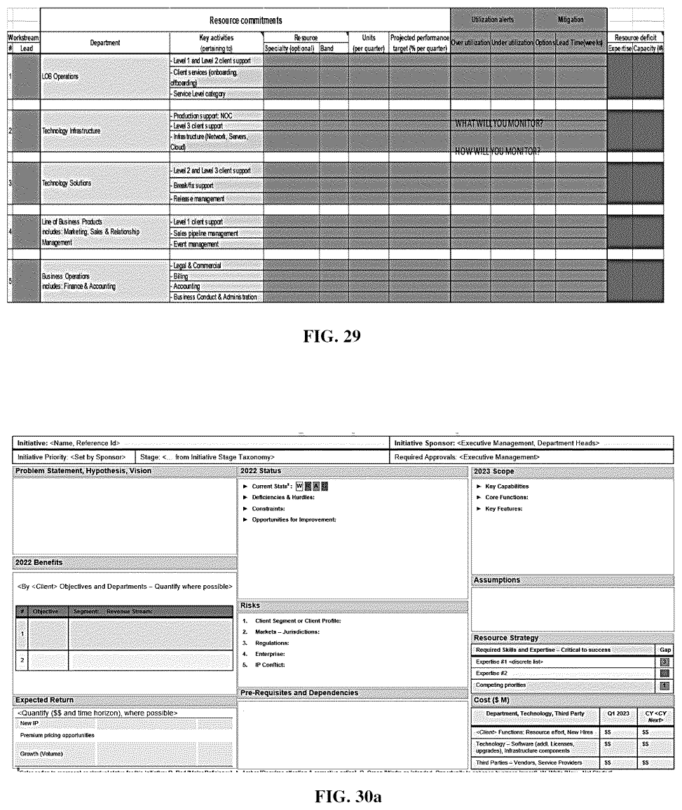

As an example, FIG. 29 illustrates user interface view rendering Run the Business (RTB), according to one or more embodiments. The user interface view shown in FIG. 29 renders the resource commitments tied up to initiatives/BPs by departments. The corresponding key activities with respect to the department are also listed. The user interface view enables the user to input resource specialty and resource band. The user interface view enables the user to input units per quarter. The user interface view also enables input of projected performance targets. The user interface view also enables input of utilization alerts and mitigation. The user interface view also enables input of resource deficit. The above parameters are essential to sustain and run the business successfully. The utilization alerts comprise overutilization alert, and underutilization alert. The input for mitigation may be options to mitigate and/or time to lead.

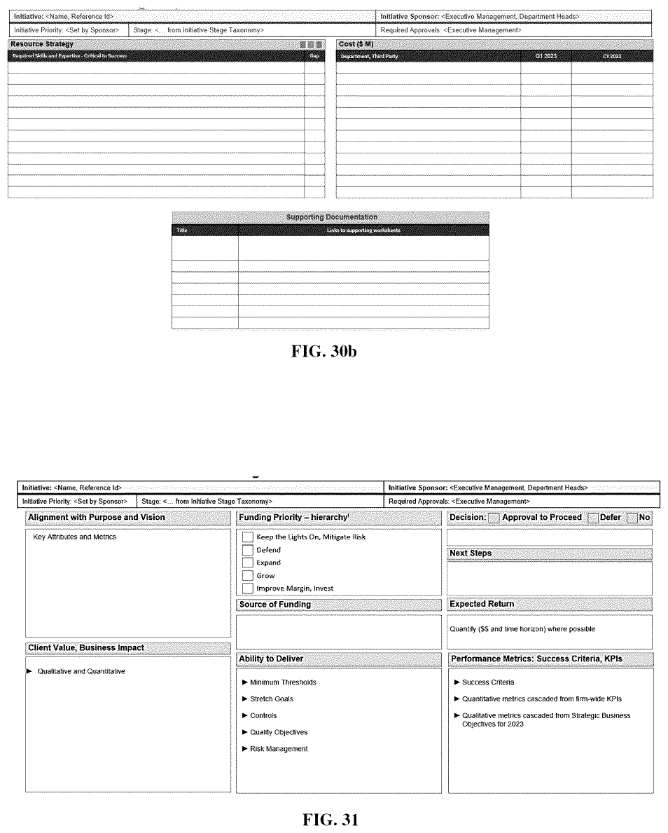

As an example, FIG. 30a and FIG. 30b illustrate user interface view rendering initiative funding request template, according to one or more embodiments. The initiative funding request template shown in FIG. 30a comprises fields such as initiative name, initiative priority, stage, initiative sponsor, and required approvals. The initiative name field enables the user to input the relevant initiative name. The initiative name field enables the user (sponsor) to set the initiative priority. The stage field enables the user to set the stage from initiative stage taxonomy. The initiative sponsor field enables the user to input the executive management, department heads who are going to sponsor the initiative. The required approval field enables the user to input the user name (e.g., approver name) from whom the approval is needed. The field may tag the appropriate user and notify the user that there is an action item. The processor may also notify the user that there is a pending action item after a predefined period of time when the user has not executed the action at an appropriate time.

The initiative funding request template further comprises problem statement, hypothesis, vision field that enables the user to input the problem to be addressed, hypothesis, and primary objectives for which the initiative is created. The processor receives this field as input in creating the initiative and/or further processing. The previous status (2022 status) enables the user to input the status of the initiative in the previous year. The scope (2023 scope) enables the user to input the key capabilities, core functions, and key features. The initiative funding request template further comprises assumptions field and resources strategy field that enables the users to provide the assumptions and the resource strategy based on the user's preference. The assumptions and the effort estimates together forms the project plan. The cost field also enables the users to input expected cost for each category. The risk field enables the users to input the anticipated risks for the initiatives. The pre-requisites and dependencies enable the users to list the factors that may impact the execution or outcomes of the initiatives. The expected return field enables the users to input the new IP, premium pricing opportunities and growth (value). FIG. 30b illustrates particularly the resource strategy field and the cost field as described above. The user interface view uploads supporting documentation and links to supporting worksheets.

As an example, FIG. 31 illustrates a budget decision framework, according to one or more embodiments. The user interface view shown in FIG. 31 assists the user in undertaking the budget decisions. The budget decision framework shown in FIG. 31 comprises fields such as initiative name, initiative priority, stage, initiative sponsor, and required approvals. The initiative name field enables the user to input the relevant initiative name. The initiative name field enables the user (sponsor) to set the initiative priority. The stage field enables the user to set the stage from initiative stage taxonomy. The initiative sponsor field enables the user to input the executive management, department heads who are going to sponsor the initiative. The required approval field enables the user to input the user name (e.g., approver name) from whom the approval is needed. The field may tag the appropriate user and notify the user that there is an action item. The processor may also notify the user that there is a pending action item after a predefined period of time when the user has not executed the action at appropriate time.

The user interface view depicts alignment with purpose and vision, funding priority—hierarchy, client value, business impact, ability to deliver, source of funding, expected return, performance metrics: success criteria, KPIs. The user interface view shown further depicts a decision: “approval to proceed,” “defer,” “no,” that enables users to choose one among them based on the above info.

In an embodiment, the system further comprises a cyber security module wherein the cyber security module comprises an information security management module providing isolation between the communication module and servers.

In an embodiment, the information security management module is operable to, receive data from the communication module, exchange a security key at a start of the communication between the communication module and the server, receive the security key from the server, authenticate an identity of the server by verifying the security key, analyze the security key for a potential cyber security threat, negotiate an encryption key between the communication module and the server, encrypt the data, and transmit the encrypted data to the server when no cyber security threat is detected.

In an embodiment, the information security management module is operable to exchange a security key at a start of the communication between the communication module and the server, receive the security key from the server, authenticate an identity of the server by verifying the security key, analyze the security key for a potential cyber security threat, negotiate an encryption key between the system and the server, receive encrypted data from the server, decrypt the encrypted data, perform an integrity check of the decrypted data and transmit the decrypted data to the communication module when no cyber security threat is detected.

In an embodiment, the system may comprise a cyber security module.

In one aspect, a secure communication management (SCM) computer device for providing secure data connections is provided. The SCM computer device includes a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle environment and transmit the converted first data message to the vehicle system using a first communication protocol associated with the vehicle system.

According to an embodiment, secure authentication for data transmissions comprises, provisioning a hardware-based security engine (HSE) located in communications system, said HSE having been manufactured in a secure environment and certified in said secure environment as part of an approved network; performing asynchronous authentication, validation and encryption of data using said HSE, storing user permissions data and connection status data in an access control list used to define allowable data communications paths of said approved network, enabling communications of the communications system with other computing system subjects to said access control list, performing asynchronous validation and encryption of data using security engine including identifying a user device (UD) that incorporates credentials embodied in hardware using a hardware-based module provisioned with one or more security aspects for securing the system, wherein security aspects comprising said hardware-based module communicating with a user of said user device and said HSE.

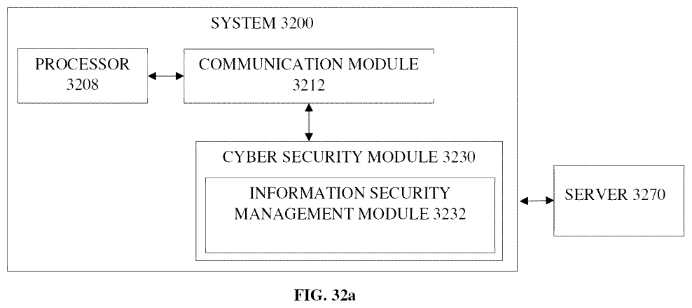

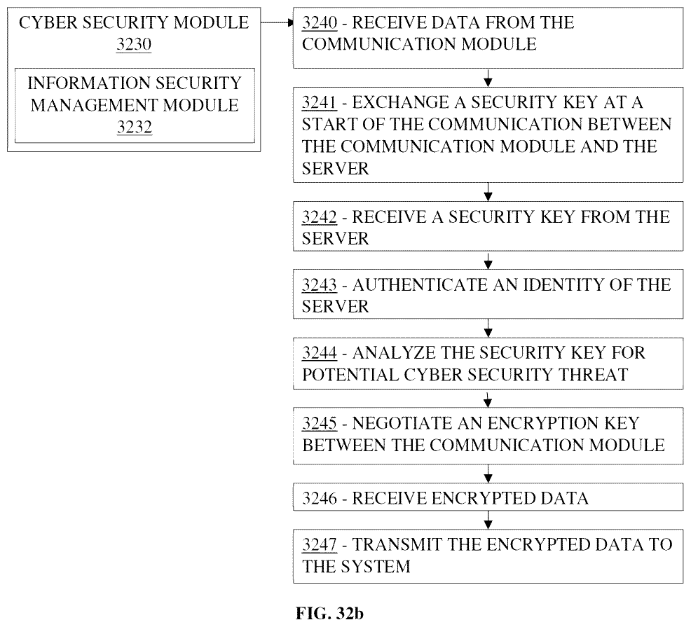

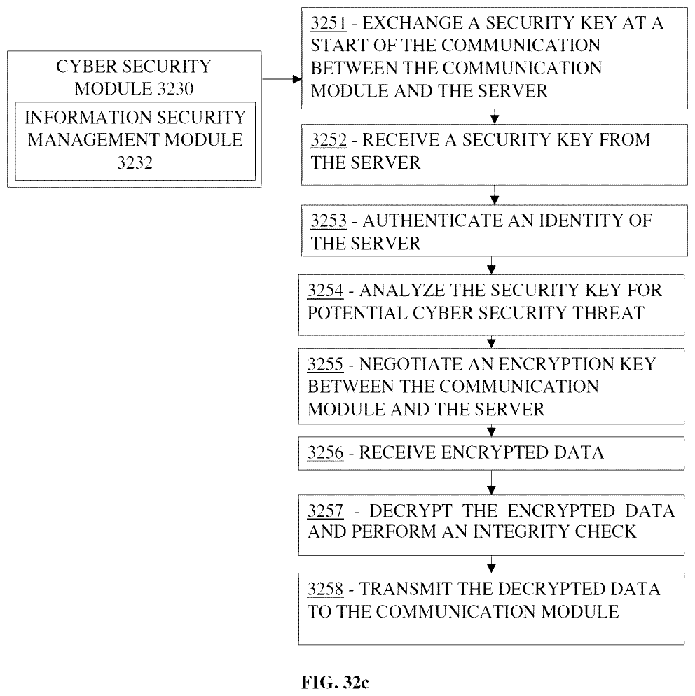

In an embodiment, FIG. 32a shows the block diagram of the cyber security module. The communication of data between the system 3200 and the server 3270 through the communication module 3212 is first verified by the information security management module 3232 before being transmitted from the system to the server or from the server to the system. The information security management module 3232 is operable to analyze the data for potential cyber security threats, to encrypt the data when no cyber security threat is detected, and to transmit the data encrypted to the system or the server. The system 3200 comprises a processor 3208.

In an embodiment, the cyber security module 3230 further comprises an information security management module providing isolation between the system and the server. FIG. 32b shows the flowchart of securing the data through the cyber security module 3230. At step 3240, the information security management module is operable to receive data from the communication module. At step 3241, the information security management module exchanges a security key at a start of the communication between the communication module and the server. At step 3242, the information security management module receives a security key from the server. At step 3243, the information security management module authenticates an identity of the server by verifying the security key. At step 3244, the information security management module analyzes the security key for potential cyber security threats. At step 3245, the information security management module negotiates an encryption key between the communication module and the server. At step 3246, the information security management module receives the encrypted data. At step 3247, the information security management module transmits the encrypted data to the server when no cyber security threat is detected.

In an embodiment, FIG. 32c shows the flowchart of securing the data through the cyber security module 3230. At step 3251, the information security management module is operable to: exchange a security key at a start of the communication between the communication module and the server. At step 3252, the information security management module receives a security key from the server. At step 3253, the information security management module authenticates an identity of the server by verifying the security key. At step 3254, the information security management module analyzes the security key for potential cyber security threats. At step 3255, the information security management module negotiates an encryption key between the communication module and the server. At step 3256, the information security management module receives encrypted data. At step 3257, the information security management module decrypts the encrypted data, and performs an integrity check of the decrypted data. At step 3258, the information security management module transmits the decrypted data to the communication module when no cyber security threat is detected.

In an embodiment, the integrity check is a hash-signature verification using a Secure Hash Algorithm 256 (SHA256) or a similar method.

In an embodiment, the information security management module is configured to perform asynchronous authentication and validation of the communication between the communication module and the server.

In an embodiment, the information security management module is configured to raise an alarm if a cyber security threat is detected. In an embodiment, the information security management module is configured to discard the encrypted data received if the integrity check of the encrypted data fails.

In an embodiment, the information security management module is configured to check the integrity of the decrypted data by checking accuracy, consistency, and any possible data loss during the communication through the communication module.

In an embodiment, the server is physically isolated from the system through the information security management module. When the system communicates with the server as shown in FIG. 32a, identity authentication is first carried out on the system and the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server carry out identity authentication on the information security management module. After the identity authentication is passed on to the information security management module, the two communication parties, the system and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module. When the information security management module receives data through the communication module, the data is decrypted first, integrity verification is carried out on the data after decryption, and if verification is passed, the data is sent out through the communication module; otherwise, the data is discarded.

In an embodiment, the identity authentication is realized by adopting an asymmetric key with a signature.

In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. In other words, signing identity is referred to as the common name of the certificates which are installed in the user's machine.

In an embodiment, both communication parties need to authenticate their own identities through a pair of asymmetric keys, and a task in charge of communication with the information security management module of the system is identified by a unique pair of asymmetric keys.

In an embodiment, the dynamic negotiation key is encrypted by adopting an Rivest-Shamir-Adleman (RSA) encryption algorithm. RSA is a public-key cryptosystem that is widely used for secure data transmission. The negotiated keys include a data encryption key and a data integrity check key.

In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model.

The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and can ensure that the safety of the data on the server cannot be compromised by a hacker attack under the condition of the Internet by ensuring the safety and reliability of the communication between the system and the server.

In an embodiment of the system, the machine learning model is configured to learn using labelled data using a supervised learning method, wherein the supervised learning method comprises logic using at least one of a decision tree, a logistic regression, a support vector machine, a k-nearest neighbors, a Naïve Bayes, a random forest, a linear regression, a polynomial regression, and a support vector machine for regression.

In an embodiment of the system, the machine learning model is configured to learn from the real-time data using an unsupervised learning method, wherein the unsupervised learning method comprises logic using at least one of a k-means clustering, a hierarchical clustering, a hidden Markov model, and an apriori algorithm.

In an embodiment of the system, the machine learning model has a feedback loop, wherein the output from a precious step is fed back to the model in real-time to improve the performance and accuracy of the output of a next step.

In an embodiment of the system, the machine learning model comprises a recurrent neural network model.

In an embodiment of the system, the machine learning model has a feedback loop, wherein the learning is further reinforced with a reward for each true positive of the output of the system.

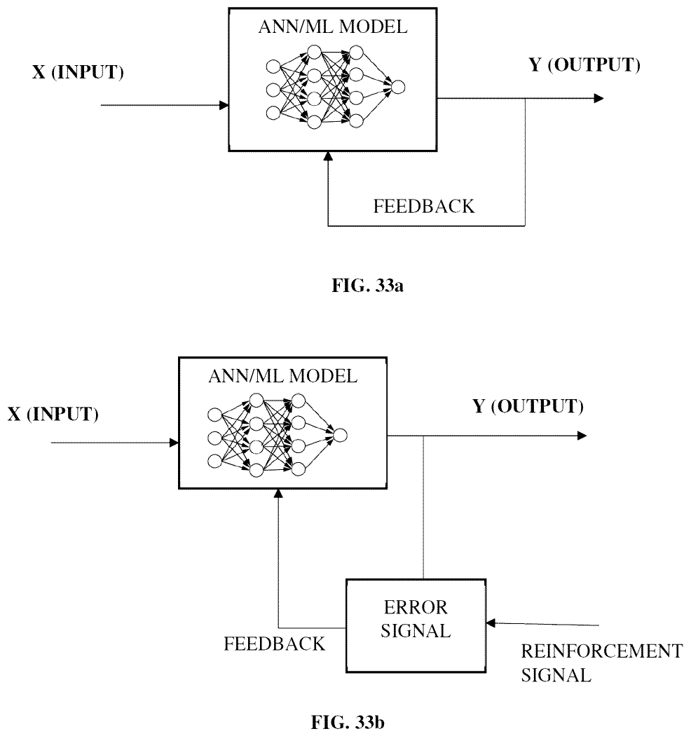

FIG. 33a shows a structure of the neural network/machine learning model with a feedback loop. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. The model may learn from the data. Learning can be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an apriori algorithm. The output layer may create BPs and initiatives and assist in budget decisions based on the input data.

In an embodiment, ANN's may be a Deep-Neural Network (DNN), which is a multilayer tandem neural network comprising Artificial Neural Networks (ANN), Convolution Neural Networks (CNN) and Recurrent Neural Networks (RNN) that can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, and image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback. The variations of weights in the hidden layer(s) will be adjusted to fit the expected outputs better while training the model. This will allow the model to provide results with far fewer mistakes.

The neural network is featured with the feedback loop to adjust the system output dynamically as it learns from the new data. In machine learning, backpropagation and feedback loops are used to train an AI model and continuously improve it upon usage. As the incoming data that the model receives increases, there are more opportunities for the model to learn from the data. The feedback loops, or backpropagation algorithms, identify inconsistencies and feed the corrected information back into the model as an input.

Even though the AI/ML model is trained well, with large sets of labelled data and concepts, after a while, the models' performance may decline while adding new, unlabelled input due to many reasons which include, but not limited to, concept drift, recall precision degradation due to drifting away from true positives, and data drift over time. A feedback loop to the model keeps the AI results accurate and ensures that the model maintains its performance and improvement, even when new unlabelled data is assimilated. A feedback loop refers to the process by which an AI model's predicted output is reused to train new versions of the model.

Initially, when the AI/ML model is trained, a few labelled samples comprising both positive and negative examples of the concepts (for e.g., create BPs and initiatives) are used that are meant for the model to learn. Afterward, the model is tested using unlabelled data. By using, for example, deep learning and neural networks, the model can then make predictions on whether the desired concept/s (for e.g., create BPs and initiatives) are in unlabelled images. Each image is given a probability score where higher scores represent a higher level of confidence in the models' predictions. Where a model gives an image a high probability score, it is auto labelled with the predicted concept. However, in the cases where the model returns a low probability score, this input may be sent to a controller (may be a human moderator) which verifies and, as necessary, corrects the result. The human moderator may be used only in exception cases. The feedback loop feeds labelled data, auto-labelled or controller-verified, back to the model dynamically and is used as training data so that the system can improve its predictions in real-time and dynamically.

FIG. 33b shows a structure of the neural network/machine learning model with reinforcement learning. The network receives feedback from authorized networked environments. Though the system is similar to supervised learning, the feedback obtained in this case is evaluative not instructive, which means there is no teacher as in supervised learning. After receiving the feedback, the network performs adjustments of the weights to get better predictions in the future. Machine learning techniques, like deep learning, allow models to take labelled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

In an embodiment, icons on a graphical user interface (GUI) or display of a computer system are re-arranged based on a priority score of the content of the message. The processor tracks the messages that need to be displayed at a given time and generates a priority score, wherein the priority score is determined based on the action that needs to be taken by the user, the time available before the user input is needed, content of the message to be displayed, criticality of the user's input/action that needs to be taken, the sequence of the message or messages that need to be displayed and executed, and the safety of the overall scenario. The priority of the messages are evaluated dynamically as the situation is evolving and thus the display icons, positions, and sizes of the text or icon on the display are changed in real-time and dynamically. In an embodiment, more than one message is displayed and highlighted as per the situation and the user's actions.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

Other specific forms may embody the present invention without departing from its spirit or characteristics. The described embodiments are in all respects illustrative and not restrictive. Therefore, the appended claims rather than the description herein indicate the scope of the invention. All variations which come within the meaning and range of equivalency of the claims are within their scope.

### INCORPORATION BY REFERENCE

All publications, patents, and patent applications cited in this Specification are hereby incorporated by reference in their entirety, including:
US20230011954A1 titled “Device, method, and system for business plan management;”
U.S. Pat. No. 11,023,831B2 titled “Optimizing a business model of an enterprise;”
US20130124244A1 titled “System and method for managing a proposal lifecycle;”
US20080162267A1 titled “Apparatus and Method of Collaborative Funding of New Products and/or Services;”
CA2301412A1 titled “A web based method of forming a business through collaborative on-line efforts;”
CN113256171A titled “Service plan generation method and system;”
US20090177510A1 titled “System and method of generating a business plan;”
US20130124243A1 titled “System and method for creating documents to manage a proposal lifecycle;” and
KR102509501B1 titled “Apparatus and method for automatically generating business plan document.”

1-78. (canceled)

79. A system comprising:
a memory; and
a processor that is communicatively coupled to the memory storing a sequence of instructions that when executed causes the processor to:
receive information related to one or more business propositions;
create one or more business propositions based on the information received;
analyze, using an artificial intelligence engine, the one or more business propositions and group the one or more business propositions for one or more categories; and
create, using the artificial intelligence engine, one or more initiatives for the one or more categories.

80. The system of claim 79, wherein the processor is operable to:
implement the one or more initiatives on one or more target environments;
monitor at least one of tasks, activities, and events executed by the one or more initiatives into the one or more target environments; and
determine an actual performance score based on monitoring at least one of the tasks, the activities, and the events executed by the one or more initiatives into the one or more target environments.

81. The system of claim 80, wherein the processor is operable to determine an expected performance score based on analyzing the one or more initiatives.

82. The system of claim 81, wherein the processor is operable to determine a deficit score based on comparison of the actual performance score and the expected performance score.

83. The system of claim 82, wherein the processor is operable to determine, using the artificial intelligence engine, one or more issues based on the comparison of the actual performance score and the expected performance score.

84. The system of claim 83, wherein the processor is operable to communicate feedback information back to the processor based on the issues, wherein the feedback information comprises at least one of a resource strategy, a scope strategy, a priority strategy, and a budget strategy.

85. The system of claim 84, wherein the processor is operable to update at least one of the one or more business propositions and the one or more initiatives based on the feedback information.

86. The system of claim 85, wherein the processor is operable to update at least one of scope, budget, resource, and priority in at least one of the one or more business propositions and the one or more initiatives based on the feedback information.

87. The system of claim 86, wherein the processor is operable to generate a real-time report using at least one of analysis, historical trends, historical patterns, historical records, the issues, the feedback information, and the update performed.

88. The system of claim 79, where the processor is operable to communicate with one or more external applications through an application programming interface (API) and exchange the information.

89. The system of claim 79, wherein the processor is operable to enable one or more users to collaborate in real-time and analyze at least one of the one or more business propositions and the one or more initiatives, determine issues, and update at least one of the one or more business propositions and the one or more initiatives.

90. The system of claim 79, wherein the processor is operable to determine at least one of resources, budgets, priorities, and scopes, using one or more estimation models, for at least one of the one or more business propositions and the one or more initiatives.

91. The system of claim 80, wherein the processor is operable to at least one of manage execution of agendas, manage the activities, manage the events, manage tasks, trigger, and host online meetings, manage actions, take meeting notes, and record activities in a repository.

92. The system of claim 80, wherein one or more agents execute the activities, the tasks, and the events at scheduled dates and times based on one or more commands.

93. A method comprising:
receiving information related to one or more business propositions;
creating one or more business propositions based on the information received;
analyzing, using an artificial intelligence engine, the one or more business propositions and group the one or more business propositions for one or more categories; and
creating, using the artificial intelligence engine, one or more initiatives for the one or more categories.

94. The method of claim 93, further comprising: implementing the one or more initiatives into one or more target environments.

95. The method of claim 94, further comprising: implementing the one or more initiatives into the one or more target environments through one or more agents.

96. A non-transitory computer readable storage medium, comprising a sequence of instructions, that when executed by a processor causes:
receiving information related to one or more business propositions;
creating one or more business propositions based on the information received;
analyzing, using an artificial intelligence engine, the one or more business propositions and group the one or more business propositions for one or more categories; and
creating, using the artificial intelligence engine, one or more initiatives for the one or more categories.

97. The non-transitory computer readable storage medium of claim 96, further causes: enabling one or more users to collaborate in real-time to analyze at least one of the one or more business propositions and the one or more initiatives, determine issues, and update at least one of the one or more business propositions and the one or more initiatives.

98. The non-transitory computer readable storage medium of claim 96, further causes: receiving the information from at least one of one or more users and one or more agents.
